(19) United States
(12) Patent Application Publication
(10) Pub. No.: US 2013/0226674 A1
(43) Pub. Date: Aug. 29, 2013

(54) Integrated Educational Stakeholder Evaluation and Educational Research System

(71) Applicant: Cognita Systems Incorporated, (US)

(72) Inventors: Benjamin K. Field, South Setauket, NY (US); Michael L. Lebron, Dix Hills, NY (US); James W. Lauckhardt, Holbrook, NY (US); Tatsuya Kameda, Shinagawa-Ward (JP)

(21) Appl. No.: 13/686,660

(22) Filed: Nov. 27, 2012

Related U.S. Application Data
(60) Provisional application No. 61/604,059, filed on Feb. 28, 2012.

(51) Int. Cl. G06Q 10/06

(52) U.S. Cl. CPC G06Q 10/0639
USPC 705/7.38

(57) ABSTRACT

The present invention is a method, process, and system to (1) collect data, (2) compile the data, create new data, and analyze the data, and (3) provide an output based upon the data. The process is novel in the manner in which each of the aforementioned steps are performed as well as in its entirety due to the overall process/manner of operation. The invention uses engines with differing functions that fully integrate performance and behavioral/effort data pertaining to educational stakeholders, whereby data, statistics, and educationally related behaviors are used to capture and derive more accurate measures and/or measures of impacts influenced by and between any educational stakeholder.

### CROSS-REFERENCE TO RELATED APPLICATION

This application claims the benefit of U.S. Provisional Patent Application Ser. No. 61/604,059 filed on Feb. 28, 2012 which is expressly incorporated herein in its entirety by reference thereto.

### FIELD OF THE INVENTION

The invention relates to the collection of data using a computer program and a computer interface such as a keyboard and a computer monitor. The invention relates to methods, processes, and systems used to evaluate individual performance. The invention, furthermore, relates to statistical evaluations of the performance of individuals using data collected relating to the individuals and others, calculated measures, and comparisons. The invention also relates to devices, processes, methods, and systems that collect and categorize numerical data and behavioral data used in evaluations.

### BACKGROUND OF THE INVENTION

Evaluations are an important part of our society. They are performed each and every day on a micro and a macro scale, with regard to many facets of life. Evaluations are performed on a wide variety of items and things (e.g., purchases in a grocery store), when making choices in life (e.g., which school to apply to and attend), as well as with regard to people both in a personal and professional environment (e.g., who to marry or how someone is performing at work or at a particular job).

For example, children evaluate each other all the time when playing together to determine if the child likes who he/she is interacting with and/or if he/she is willing to interact with other children. Parents evaluate their children in multiple situations and provide children with guidance and parenting advice based upon their observations and evaluations. In a work environment, individual evaluations and comparative evaluations are constantly performed to determine if someone is not performing to expectations, is meeting expectations, is exceeding expectations, is doing better or worse in comparison to co-workers, etc., oftentimes to determine how to compensate the individual(s).

There are many different types of methods used to analyze an individual's performance at the workplace. Each performance evaluation will vary depending upon the type of performance at issue, the time spent on the evaluation, the methodology used, etc. Some performance evaluations are based upon outcomes, the quality of an end result, and/or the time taken to complete tasks such as, for example, a contractor's performance for a construction job or a sales person's success at selling cars. Other performance evaluations are based less on the appearance of the end product and more on the quality of the services, a person's work ethic and/or behaviors, the manner in which service(s) were performed, etc. such as, for example, an administrative employee in a business or corporate environment. No matter the methodology used, performance evaluations are typically performed on an individual by one or more person(s) (e.g., supervisors), typically someone who has a close relationship with the person being evaluated (i.e., the evaluatee) and/or who supervised, oversaw, or witnessed the evaluatee during the work. When multiple evaluations are obtained for more than one evaluatee, they could be used separately to evaluate an individual or they can be combined together into a single evaluation.

In many corporate environments, as is commonly done in surveys (e.g., customer satisfaction surveys), evaluations use a rating scale to create a numerical value/rating based on responses to several questions. Differing levels of performance measurement, e.g., exceeds expectations, meets expectations, fails to meet expectations, routinely fails to meet expectations, are assigned numbers (1-5) and the evaluator is asked to assign an evaluation number to different performance evaluation criteria, e.g., performs work in a professional manner, cooperates well with others to complete specific tasks, is a team player, is creative in solving problems, etc. A final number or rating based on a total or average of the assigned ratings is the end result based upon simple arithmetic. An individual's rating can be compared to other evaluatee's ratings and/or can be compared to the ratings of other individuals performing the same or a similar job for a comparison.

A major problem with these evaluations is that they are almost entirely subjective which can result in substantial disparity in results. One evaluator's opinion about what “meets expectations” may be very different than another. In some instances, evaluators intentionally give lower ratings than the evaluatee deserves for specific criteria because the evaluator dislikes or does not have a personal affinity for the evaluatee while others may give higher ratings just because the evaluatee is a friend and/or they want the person to get a higher yearend bonus. While it is true that theoretically the results are supposed to become less biased as the sample set increases in size, that is by combining multiple evaluations together into a single evaluation result, the results are largely flawed because they originate entirely from subjective opinions and evaluations.

Another major problem with these evaluations is that they largely fail to include or properly consider outside influences and factors, such as, for example for a salesperson job, the overall market for the product or more directly related, the amount of effort and/or support from a supervisor or the employer. Even though the performance of one individual is almost always a function of and/or dependent upon the effort and performance of at least one other individual, the currently known evaluation methods view that individual in isolation and do not account for or consider the efforts or performance of others who had an impact on their performance. None of the known evaluation methods determine the evaluatee's perceived ability and use that measure in determining the evaluation results.

In more recent years, with increasing pressures for job performance due to difficult financial markets, performance evaluation, comparative performance, and net results from performance, are becoming much more important, particularly in jobs and professions that previously did not require as much critiquing or criticism or in jobs that only required approval from one's immediate supervisors or peer(s). In response, some of those professions and employers have implemented and now rely upon the aforementioned traditional evaluation methods. Others are struggling to determine how to implement fair and effective systems that are not biased due to a small quantity of knowingly subjective evaluations and/or how to create an effective evaluation system across a wide array of locations, environments, systems, etc. Such an evaluation system is particularly important when the evaluatees are located in significantly varied environments and cultures, and differ in their compositions, geographical locations, and/or are affected by inside and outside influences and pressures.

Teachers, for example, traditionally have been evaluated subjectively by one or more peers within a school or school district in which they work. Since each school and/or school district is segmented and operated independently from others, evaluation of the teacher's performance comparatively outside the school, the school district, the state, etc. is largely irrelevant. So long as the teacher's immediate supervisors are subjectively pleased with the teacher's performance, for the most part, the teacher's evaluation will be positive even if that teacher is underperforming based on a variety of indicators compared to teachers in districts with similar demographics. Accordingly, while one teacher's evaluation may be compared to another in the same school or even in some instances teachers within another school in the same school district, there has been little need thus far to compare a teacher's rating or performance to others on a broader basis (e.g., outside the school district or compared to teachers in other counties or states), due, at least in part, to many factors that complicate the evaluation of a teacher's job. For example, the quality and abilities of the teacher's students, the amount/degree of parent participation, the amount of school assistance for the teacher, factors relating to the teaching environments, etc. remain unaccounted for. Nonetheless, there has been, and now there is an even more pressing need, to accurately evaluate teachers comparatively as well as based upon their performance measured by the quality of the education received by their students and the preparedness of the students for the next grade/school.

In education, there does exist some indirect results based/data driven methodologies for evaluation. Standardized test results for students are used to evaluate student performance and the levels of education they receive. If an entire grade of students at a school receives poor standardized test scores, the cause(s) may be the curriculum, the teacher(s), administrators, the school, the district, etc. Due to so many variables that come into play, it is extremely difficult to determine accurate interpretations of performance results and even more difficult, if not impossible, to identify causes associated with performance results. Some believe student performance is a fair measure of teacher performance. Others believe a teacher should not be evaluated based upon the test results of his/her students because student performance is influenced too much by factors outside the control of the teacher, such as, for example, which students are in the teacher's class, prior years learning, the curriculum, the testing environment, the overall intelligence and ability of each student, etc.

Perhaps as a result of the current economic recession and/or politically based motivations (i.e., elections), in more recent years, student test scores, student performance, teacher performance, and school performance, have gained increased attention and scrutiny. It has been broadly and intensely debated as to whether or not our educational system has been able to accomplish “improvement” in the generation and assessment of educationally related measures as well as in comparison to our global competitors. There has also been fierce debate as to what exactly constitutes accurate and relevant performance measurement. The complete role and influences that each individual plays in the educational system outcome has, up until this point in time, remained an unsolved area of study. The relevant data is extremely difficult to capture, measure, and even more difficult to analyze and understand objectively and deeply.

There is a need for an effective process, method, and system to evaluate performance of the educational system as a whole by evaluating a great number of its components and influences collectively, including students, teachers, administrators, parents, etc. There is a need for an effective process, method, and system to evaluate performance based not only upon the performance and effort of the evaluatee at brief and isolated periods of time, but also based on more frequent measures, as well as the ability of the evaluatee. Further, there is a need for an effective process, method, and system to evaluate performance based not only upon the performance, effort and ability of the evaluatee, but also performance, effort and abilities of others.

There is a need for a fair and unbiased process, method, and system that considers advantages and disadvantages resulting from factors and influences not presently considered in current performance evaluations.

“Data driven instruction,” statistical modeling and analysis, instructional delivery methods, and curriculum construction, seek to guide instruction by using available data such as grades and standardized test scores, rather than the subjective opinion(s) of an educator, administrator and/or district. Though theoretically sound in principle, there is much lacking in terms of data collection and in the processing of data which holds the greatest relevance. A significant amount of critical data is not collected at all and remains unassessed without consideration. If an understanding of the role and impact each person involved in the educational process truly is sought, data concerning those individuals must be captured and processed.

To date, there are currently no accepted or effective methods or systems for collecting/deriving relevant data in an unbiased and economical manner and processing it for effective evaluation. To the contrary, most educational data has remained elusive and almost exclusively focused on summative assessment in relation to student demographics. Test scores have remained the primary metric of evaluating a student's or educator's performance. But test scores alone fail to collect data on and/or effectively evaluate data related to the assessment of effort, behaviors, attitudes, abilities, and interactions between individuals involved in the education process (e.g., students, teachers, parents).

Interactions between parents and teachers, and interactions between peers and teachers, have been shown to impact a student's academic development. Researchers have also shown that influences such as society, ethnicity, regulations, divorce, homestead stability, parents' support for education, and changes in financial situations of the parents/student, impact academic outcomes. While research is being conducted at each level of the educational ecological system, the interaction between levels, objective measurement of activity at each level, and the capture in real-time and measurement of the impact of the factors associated with each level on academic outcomes is currently non-existent. This type of information may actually hold the most critical keys to understanding how and why learning occurs and provide a context to performance oriented data. An objective system of measurement which fairly assesses as many variables involved in the educational process as possible is needed.

Although there have been advances in educational technology and educational record keeping methods, such as, for example, grade-book websites, blogs, sites which facilitate networking-based communications, and tutoring websites, there does not yet exist a method or system that effectively unifies these processes in a way that intuitively works in order to improve the educational experience of all individuals involved based not only on final results or measures in isolation, but also the intermediary and contributing factors, for example effort, ability, involvement, etc. There is a need for a method and system that can leverage and interpret the vast quantities of seemingly immeasurable data that usually escapes a quantitative capture, such as behaviors and effort and ability, in a way that can produce interpretations and determine the meaning the educational data has in relation to more than one individual involved. There is a need for a method and system that captures and evaluates data relating to multiple influences (spheres of influence, educational ecological systems, parent behavior, sibling behavior, teacher behavior, etc.) that impact an individual's development, including contexts in which an individual finds oneself and related interactions.

In the teaching environment, measurement of effort is assessed via self-report surveys or from teacher or administrator feedback surveys regarding a particular student. As a result of asking students or teachers to monitor and report a particular student's effort, the measurement of effort is inherently subjective and clouded by the bias of the assessor/evaluator.

Another strategy used to measure effort in educational research is through observational data conducted by third party observers who, in the most methodologically rigorous cases, go through extensive training in order to learn how to obtain the most objective ratings of effort possible, as defined by the researcher. While observational methods tend to yield more accurate results of academic effort than self-report surveys/teacher or administrator feedback surveys, they are time consuming, expensive, lack a continual and longitudinal capture of data, and contain an elements of human error. In addition, having observers in an academic setting changes the dynamic of the interactions of stakeholders, and alters the behaviors of the individuals being observed.

There is a great need in education and in educational research for non-intrusive, objective, and real-time capture of behavior information for use in performance evaluation. An accurate measure and analysis of effort and performance and the relationship between them will unlock new levels of interpretation and analysis never done before.

There exists a need for the following in an educational system or setting: the detection, capture, conversion, and utilization of educationally related behavioral information in both electronic and real-life educational settings, the derivation of measures and sub-measures of performance, effort, and ability as well as associated sub-measures based on behavioral information, the evaluation of an individual based upon his/her calculated ability, the evaluation of an individual based upon the effort, performance, and/or ability of others, and the provision of longitudinal analysis and real-time objective research on the entire educational process.

There is a need for a system that can truly detect, capture, describe, measure, and assess the difference between mere scores and/or record keeping, and the behaviors and abilities which influence these measures so that evaluation of the quality and contribution of educational stakeholders can be truly data driven and be expressed within the context of meaningful interpretation. This will allow vehicles and methods of optimization to be realized, and for the true assessment of the best methods of successful outcomes, thereby maximizing stakeholder potentials.

There is a need for a system that can objectively measure performance, effort, ability, and real behaviors and interactions, both inside and outside of the classroom, and which can derive true measures of stakeholders in order to provide an interpretation of the meaning behind such data, as well as guidance on what educational stakeholders can do with such information to enhance their educational and vocational experiences.

### SUMMARY OF THE INVENTION

The present invention is a process, system, and method for data collection, analysis, interpretation, and evaluation. While the invention will be described in connection with certain embodiments, it will be understood that the invention is not limited to those embodiments. To the contrary, the invention includes all alternatives, modifications and equivalents as may be included within the spirit and scope of the present invention.

The present invention is a method, process, and system to (1) collect data, (2) compile the data, create new data, and analyze the data, and (3) provide an output based upon the data. The process is novel in the manner in which each of the aforementioned steps are performed as well as in its entirety due to the overall process/manner of operation.

Data collection according to the invention is accomplished using various methods technologies and equipment. One method of data collection is the conventional input of data into a computer program or database using a user interface, such as, for example a keyboard and a screen/monitor in concert with associated software. Data collected in this manner is easily stored and processed by the invention. Example types of data collected in this manner in the context of education are student grades and absences.

Another method of data collection included in the invention is the capture of behavioral information and the conversion of the information into data using other types of electronic equipment that monitor and detect information relating to behaviors and interactions. For example, various types of electronic equipment, either individually or in combination with others, could potentially detect actions, such as, the number of times a student leaves a classroom during a class, the number of times a student participates in class during a year, the time it takes for students to complete exams, the number of times a student raises a hand in response to a teacher's question, etc. The present invention captures the behavioral information in real time, or near real time, using these electronics ultimately connected to a program or computer. For example, electronic equipment can be used in a classroom to monitor if a student is in a chair during a class session thereby capturing information on attendance. The same equipment can be used to determine how long the student is out of his/her chair during the class perhaps to visit the bathroom or the nurse. The same recognition equipment in combination with audio and/or motion sensory equipment can be used to detect when a student raises his/her hand after the teacher asks a question, how long it takes students to respond to teacher questions, how many students seek to participate even if not called upon to answer to help quantity overall class participation and/or how much participation is requested by the teacher, how much of a class is lecture as compared to class participation, etc. Handheld electronic equipment that includes assignments for students to complete will also convert behaviors such as “time on task” or “number of visits” to data to be used as an overall measurement of behavioral activities in addition to using sensory and detection equipment which it possesses in order to detect measureable educational impacts for one or more stakeholders. All of this behavioral/interactive information is directly related to the performance of the students, teachers, class, school, school district, on an individual basis as well as between individuals, and is valuable information that is not captured by current technologies or performance evaluations methods. In education, such behavioral data is currently assessed and subjectively quantified by a teacher and/or observer in the aggregate at the end of a class, a semester, or a year-end period. At best, behavioral data might be subjectively assessed sporadically when there is a concern worth noting to the teacher, parent, or administrator. The current invention captures and converts this information on a more segmented (e.g., per occurrence) and objective level.

Even more examples of behavioral information captured by the present invention include quantification of the number of times (or lack thereof) an event occurs such as, for example, the number of times a student requests additional help from a teacher outside the class, the total number of hours of additional help a teacher offers and/or provides to a student/class per day or per semester or per year, the number of times a teacher contacts a parent or guardian and vice-versa, the number of assignments given by a teacher, the tone and tenor of written communications, the number of times a student uses a tutor for a subject, etc. Still more examples of behavioral information captured, converted, and collected by the invention are the time it takes for a teacher (or if the teacher actually performs the act) to report a student's poor performance, the parents time to respond to teacher communications, the time for a student to complete assignments, etc.

There are many aspects of educational practice, theory, as well as technological approaches involved in the concept behind said system and method. Researchers in child development and educational research emphasize the importance of multiple influences that impact an individual's development. They claim development is influenced by members and systems of varying proximity to the individual which are encompassed within spheres of influence. These ideas go as far as to attempt to describe the multiple influences that impact development across the life span of a student, such as parents, institutional, or societal norms and regulations. This suggests that development is influenced by the different contexts in which an individual finds oneself, and related interactions. To date, these theories have not been adequately tested through objective capture and quantification of information related to performance and behavior. Even when tested with the available resources that do exist, a pathway for these educational stakeholders (all of the individuals involved in the process) to use such information to maximize their educational experience in an objective way, or provide a means of interpreting the validity and relevancy of the educational content to a student stakeholder does not exist.

The behavioral and interactive information captured by the invention is converted into data. Such conversion may be accomplished using known and existing equipment such as, for example, analog to digital converters, audio/visual hardware and software associated with said system, and algorithms related to the analysis of data. The conversion of the information into data means that the information is converted into some form of number (e.g., binary code) that can be further processed and/or analyzed by the invention.

According to the invention, data is obtained by/through a computer program, system, or network from various input sources. For example, data may be input/imported into a computer program, system, or network, by or from multiple sources including: (1) teachers, e.g., grades or attendance, (2) motion and/or audio sensory equipment (including video) in the classroom connected to a computer program, system, or network which can detect/capture an individual's behavior (such as the raising of a hand by a child/student), associate the behavior with one or more children and/or the teacher and convert the information into data; (3) computer software that monitors/measures the time for a parent to respond to a teacher's phone call or written communication (e.g., email); and (4) other software, systems, and databases connected to the invention through networks, computers, handheld or classroom-based student or teacher devices that transmit relevant data, websites (including social networking websites such as, for example, Facebook or LinkedIn), etc. The invention includes the processing of all of the data from all input sources, in relation to one or a plurality of students, teachers, classrooms, schools, school districts, States, etc. to create an unbiased and objective statistical analysis of all of the data independent of an individual's opinions and biases during an evaluation event.

The present invention, through the collection and analysis of the aforementioned data and the creation of new data based upon the analysis of the data (new data and intermediary/derived data) creates previously unrecognized correlations and comparisons. The discrete data, as well as conditional and derived data, are included in the definition of data.

The current invention thus provides a means to capture/collect and interpret information and data concerning what occurs inside the classroom and outside the classroom to determine how that information/data impacts academic outcomes that researchers, students, teachers, tutors, parents, and administrators are interested in.

The present invention includes collection of information and data on a plurality of stakeholders in the educational process, including but not limited to, teachers, students, parents, administrators, tutors, institutions, peripheral and support stakeholders.

According to the invention, all data (including data created from the capture and conversion of information) is categorized/sorted by the invention for further processing and analysis. The invention categorizes/sorts data into either Performance Data, Effort Data, or Profile Data. Performance Data is data relating directly to performance such as, for example, numerical data in the form of test scores. Effort Data is data relating directly to effort of the individual as opposed to the presentation of a capacity to perform in an isolated period of time, such as, for example, the assignment of a value of effort for performing a single homework assignment or the raising of a hand in class to answer a question (behavioral and interactive events). Profile Data is data relating to an individual's profile, such as, for example, demographics, age, gender, medical conditions, geographic location, outside research data, race, relatives, friends on social networking sites, historical performance, life events, etc.

Sorting can be accomplished manually by a user or automatically by a program. For example, manual categorization prior to the data entering into the program of the invention includes a teacher inputting grades by first making a selection on the computer that the data is a grade and thus Performance Data, or the automatic capture and categorization of values believed to relate to the expenditure of effort. Another example of manual selection at the time of input would be a teacher selecting Effort Data on a computer prior to activating the electronic equipment in the classroom during a lecture for the collection of behavioral information. An example of automatic categorization may be a computer in the classroom automatically sensing a student is no longer in his/her seat for a period of time and recording the absence under Effort Data. Profile Data may be input by a teacher and/student or may be imported into the invention from a social networking site such as Facebook.

Analysis and processing of the data including Performance Data, Effort Data, and Profile Data is then performed.

Some of the data is normalized. The data resulting from the conversion of information, in particular, is likely to be normalized. Normalization of data is a statistical operation performed on the data in order to convert it to a form that is standard across all data retrieval sources for further processing by the invention. Normalization is accomplished in many ways using many different methodologies. For example, for one student's Effort Data relating to movement in a Science Lab classroom, the Effort Data relating to the number of times the students gets out of his/her chair may be adjusted upward or downward compared to Effort Data relating to the number of times the students gets out of his/her chair in a Math class because the student is expected to move around a Science Lab much more than a Math class. The invention analyzes the “norms” for the class, the school, and longitudinally, based upon all data and then determines a value for the data to use for further analysis, adjusted upward or downward as needed based upon the norms and/or thresholds. As another example, the raising of a student's hand five times during single class session may be adjusted into a numerical value other than “5” in order to quantify the Effort Data into another form for comparison and processing by the invention.

The invention then determines if the data qualifies as an Education Event. An Education Event (“EE”) is a conditional, derived, or discrete event deemed to have an impact of statistical or analytical significance on any level or sub-level of the three main/primary branches/categories of stakeholder measurement; performance, effort, and ability. The invention determines if the data is indicative of an occurrence that represents a deviation from what is typical for a particular absolute or relative measurement related to one or more stakeholders. EEs could include originating data (e.g., a poor grade), data created/generated as an intermediary result (e.g., a trend down in grades for a student), and/or a final result or observation (e.g., a determination by the invention through analysis that the student needs help due to poor assistance at home). An EE could also be a discrete event which impacts but does not materially represent the overall statistical representation of a stakeholder's performance such as, for example, a significant life event like the death of a relative. The invention assigns the EE a numerical value and analyzes the EE to detect potential causes for the deviation from thresholds, or the stakeholder's typical trends. An EE is compared to other EEs and the results of others analyses performed by the invention to determine if the EE is worth reporting. If so, the invention reports the EE as having occurred, identifies recommendations, and reports information to stakeholders related to the event. If the data does not qualify to be an EE or if the invention determines the EE is not worth reporting, the data or EE is stored for further analysis.

Using the data, the analysis according to the invention includes the determination/calculation of Perceived Performance, herein referred to as “PP”, Perceived Effort, herein referred to as “PE”, and/or Perceived Ability, herein referred to as “PA” for all stakeholders involved.

PP is a calculated value resulting from statistical analyses of data, including EEs collected, related to a variety of stakeholder inputs/outputs/measures deemed to be indicative of the academic adequacy of a stakeholder as determined by the data they generate. Examples include, but are not limited to grades, portfolios, standardized test scores, and any typical educationally related measures of stakeholder outputs.

PE is a calculated value resulting from statistical analyses of data, including EEs, related to the presence or absence of any educationally related behaviors, real or electronic, which may be aggregated, correlated, quantified, and qualified in order to facilitate the numerical evaluation of educational stakeholder behaviors, or the lack thereof. PE is related to the effort expended by an individual in achieving a particular performance outcome in relation to time.

PA is a calculated value resulting from statistical analyses of data, including EEs, and PP and PE. Therefore, analysis of PP relative to PE will derive measures of PA. Any previously derived ability statistics may be iterative in nature and therefore a changing value as more data becomes available. Facilitation of the determination of PA may also include supplemental data from standardized testing results, inputs, implicit or explicit data points, EEs, or other measures which are then integrated into a compiled figure. A conceptual example of a calculation of PA may include, but not be limited to, a stakeholder exhibiting low effort in an academic area, but performing relatively high from a performance standpoint. Such a stakeholder may be calculated to have a high PA in that particular educational area because they excel with little or relatively lower effort. Similarly, a stakeholder who displays high effort and low relative performance may indicate that said stakeholder has a lower PA. Such a stakeholder may encounter difficulty, cause for concern, or a consistently low ability in that particular discipline because it takes great effort to achieve said lower performance statistics. PA can be specific to a particular branch of academic study, subject, grade level, or as a function of coursework. Such data can be further analyzed to produce stakeholder specific or targeted feedback that may drive and evaluate course load, coursework and/or career direction and selection, identification of stakeholders who may have a need of assistance or intervention, identification of stakeholder strengths and weaknesses, and may ultimately be used to offer predictive and adaptive career guidance and/or recruitment. The evaluation of PA may be facilitated through a direct or indirect assessment of weakness and strength based on the analysis of effort and performance outcomes as compared to targeted PA outcomes which may be further analyzed in relation to other sub elements such as perceived persistence. Having the PA for a stakeholder provides a means to differentiate between two stakeholders who attain similar performance results, yet have differing PE to attain that result.

Using the data relating directly to an individual stakeholder (evaluatee), data for closely related stakeholders, data for associated or relevant stakeholders as determined by social or statistical analyses, as well data for more removed stakeholders (such as at the institutional level, where a stakeholder may comprise a compilation of many stakeholders), the invention analyzes the data to objectively account for the impacts of the various educational ecological systems as well as their impacts and interactions on an individual's educationally related development. The invention performs comparisons, determines trends, identifies cause and effect relationships, identifies patterns, identifies problems, associates and identifies solutions, etc. The invention analyzes the data to determine outputs relating to overall performance of all stakeholders.

The invention uniquely calculates and/or derives measures of PA of the involved individuals (at least one stakeholder) based on the data collected for the plurality of stakeholders involved in the process, not just for the one individual being evaluated. The Perceived Ability is a calculated result of an algorithm that uses the PP and PE.

The invention ultimately provides an analysis and interpretation of the PP, the PE and the PA for all of the individuals (stakeholders) involved. An algorithmic and/or adaptive approach to statistical analysis of PP and PE will reveal the true impacts performance and effort have on outcomes. This may be accomplished by examining the impact performance and effort have on the functional ability of an individual, analyzing academic outcomes related to such values, identifying the strengths and weaknesses associated with one or more individuals as a result, and to provide what is now a new context to the academic outcomes previously viewed in isolation. This may allow any stakeholder to more completely understand where to allocate limited resources, or what the best behaviors and options are to remediate a negative situation. In addition it will allow for a standardized way of analyzing stakeholders relative to each other although their roles in the educational ecological structure may be very different.

Perceived Ability is an expression of how one performed (PP) compared to the effort expended (PE) in relation to the total effort that was possible (PosE). Instead of being a measure of raw ability as a hard figure, it is an expression of how much functional ability one might have based on what has been measured for performance and effort. It is an expression of potential performance given current performance and effort measures.

Examples of how this could be expressed numerically would include, but not be limited to, Perceived Ability=((PP+(PP*PE))/10100)*100)−(PE−100)).

Where PP is the average of all performance values (PP=ΣP values)/n*100), PE is percentage of effort values completed (Ec) compared to “PosE”, or Possible Effort values (PE=ΣEc/n PosE*100), where Perceived Ability Relative (PAr) is ((PP+(PP*PE))/10100)*100), and where PE−100 is an account for the effort percentage which is missing.

So, an example could include, but not be limited to, Perceived Ability being considered as an expression of the relationship between performance and effort and thus be considered be to be expressed in several formulaic approaches such as PA=(PAr−(PE−100)).

This among many other measures now potentially possible, could further be expressed as a % of Ability currently utilized (PAu), or PAu=PAr/PA*100.

Reports may be generated in the form of written plain language, charts, graphs, alerts of EEs or impending EEs, goal EEs, or other visual, video, and/or audio presentation of data interpretations. Notices may be presented upon logging in to the system or as alerts generated both manually and automatically via text, animation, video, audio, SMS, phone call, alerts on any electronic and/or handheld device, etc. to any stakeholder to whom the EE alert may be relevant.

The invention thus provides objective, unbiased, performance evaluation of the educational system as a whole and in parts by evaluating the performance of individual parts throughout the system, including students, teachers, administrators, parents, etc., using volumes of data collected.

The compilation, processing, analysis, and interpretation of EEs provide a continuing, dynamic, and adaptive evaluation of learning, interpretive meaning of educational data, interactions between real and electronic social networks, behaviors, educational practices, professional development, customization of education, real-time research into educational practices and philosophies, and performance for any/all stakeholders.

The process, system, and method executes algorithms (a program) using a computer, which utilizes adaptive measures, computerized engines, a computerized graphical user interface, 3rd party computerized data integration, audio and/or imaging and tracking devices, and/or mobile devices integrated with the world wide web (or if preferred an offline mode), in combination with traditional educational performance measures, to derive and analyze stakeholder performance, effort, behavior, ability, and the quantitative and functional relationships between them.

Uniquely, the invention will evaluate the performance of one individual stakeholder, the “evaluatee” (e.g., a student), based on the evaluatee's own performance results, effort and ability. Further, the invention will contemplate and include in that evaluation, the performance results, effort and ability of the other stakeholders that impact the evaluatee (e.g., teachers, parents, administrators, tutors, etc.).

More specifically explained in the content of one embodiment, the process of the invention includes the transfer of all data to and through a Common Educational Identity Engine which converts captured information to data, collects data and categories it, stores and/or normalizes data, including information and data from electronic devices and/or web-based applications. The Common Educational Identity Engine preferably allows and/or acts as an interface for a system related front end software/user interface where the interface is uniquely designed to interact with users in such a way as to facilitate the most efficient capture of EE related data that is possible. Software for said system and method will differentiate between Performance, Effort, and Ability and/or EE data in order to minimize manual entry and facilitate data capture with minimal effort. For example, for one particular grade a teacher enters, said software might assign any combination of a Performance value, an Effort value, and Ability value, and possibly associated sub-measures, so that a user may generate and log such data without having to separately identify each data point. Also said system may prompt the user automatically to clarify the nature of such data if in fact it is ambiguous or unclear to said system. Furthermore software associated with said system may allow for the user to clarify or correct certain data point designations of Performance, Effort, or Ability if more accurate tracking and analysis of data is needed. In another embodiment, the Common Educational Identity Engine, may act as a data router which aggregates and/or sorts both incoming and outgoing data for or between the system and third party applications/peripheral equipment, such as, for example, a social networking website like Facebook or a gradebooking program on the internet, etc.

The invention creates and uses User Profiles for each stakeholder which are stored in the Common Educational Identity Engine. The User Profile may be created through imported data from a social media site and/or data inputted at a computer by a student, teacher, administrator, etc. The User Profile will include detailed information compiled from the accumulation and processing of all longitudinal data with respect to following; measured effort as a function of the presence and absence of behaviors, interactions, performance indicators, relative and/or absolute performance, effectiveness of instruction, effectiveness of instructional efforts, the degree of effort and involvement of any stakeholder, and summarizes this data in a possible customizable interface for purposes of evaluation, interpretation, comparison, professional development, goal setting, goal tracking, measures of intervention effectiveness, disciplinary measures, and/or defense of practice.

After the Common Educational Identity Engine, the data is transferred to an Adaptive Educational Data Processing and Evaluation Engine, where it is analyzed and processed using algorithms and programs, including determination of a PP, a PE and a PA for each stakeholder.

In preferred embodiments, the Adaptive Educational Data Processing and Evaluation Engine creates and analyses sub measures for these three basic/primary categories/dimensions of measurement (PP, PE, PA), such as, for example, Perceived Efficiency, Perceived Effectiveness, Perceived Proactivity, Perceived Awareness, Perceived Willingness and Engagement, Perceived Aptitude, Perceived Needs, Perceived Weaknesses and Strengths, Perceived Persistence and Interest, Perceived Academic Potential, Non-Core Peripheral Instructor Effect, and the Perceived Educational Philosophy and Approach of any educational stakeholder. By their nature, the spectrum of analyses for sub measures is more specific or limited in either scope, time, or implied focus/meaning for any sub categories of the three primary dimensions of measurement (PP, PE, PA), or may be an analysis between two or more such measures, or between two or more sub-measures within a specific type (e.g. analysis of two PP related measures to derive a new measure). Sub categories may then be used to derive more specified measures of any of the three dimensions of stakeholder measurement.

After the Adaptive Educational Data Processing and Evaluation Engine, all data, including EEs are transferred to a Stakeholder Reporting and Comparative Analytics Engine. The stakeholder Reporting and Comparative Analytics Engine accepts all data and EEs and completes the generation of the presentation of completed analysis which is both relative and/or absolute in nature by processing the data generated by other stakeholders who would be reasonable to draw comparisons between and forming the data in to reports and displays which may have value to either the system itself or its users. It does not report such results necessarily to a user, but frequently will. This engine allows the data which is generated and collected to derive meaning, and to provide a presentation of said data within the framework of an interpretive report. Data will be reported regarding the interpretation of said meaning to any/all stakeholders in ways which are developmentally appropriate and appropriate to the nature of the relationships between the stakeholders. Therefore outputs from the initial analysis conducted by the Adaptive Educational Data Processing and Evaluation Engine might be further analyzed for more specified comparative analysis within its sub-engines and the results of that analysis be presented to users. Outputs from the Stakeholder Reporting and Comparative Analytics Engine include emails, automated telephone calls, printed reports/letters, SMS, audio/video communications, alerts, alert messages, etc.

More refined embodiments of the invention can be tailored to specific data and/or outputs. For example, areas where educationally-based business application could be made would be the tailored match of a tutor with a student based on PP, PE, PA, or specifically related outcomes, the tailoring and marketing of textbook material based on PA, the provision of analysis of 3rd party data to 3rd parties, such as other gradebooking business where said system may analyze such data for PP, PE, and PA and then feed results back to them, decision making when selecting schools to attend, child matching to schools, staff allocation and needs assessment, as well as the assignment of disability, etc.

Accordingly, further embodiments of the invention include additional sub-engines. The Adaptive Educational Data Processing and Evaluation Engine could include within it, additional processing and/or analysis. For example, the invention could further include one or more of an Educational Social Networking and Collaboration Engine whose focus is based on the social and socio-ecological relationships as they pertain to outcomes, an Educational Business Networking Engine which may seek to leverage data known regarding PP, PE, and PA to connect service providers with those who may have need of their services, and an Automated Educational Practice Research and Educational Approach Recommendation Engine, which may analyze all known data in order to determine “best practice” and pathways of greatest likely success as pertaining to the behaviors of stakeholders. All of the sub-engines at least include a program that performs processes on the data (including the EE data).

Each engine in the invention is governed by thresholds, rules, existing or anticipated which moderate and direct the flow of data in the invention. There are many examples of the implementation of such regulations and rule execution with respect to EEs and data flow but for illustrative purposes the following is the intended process of data flow; the Common Educational Identity engine will, by default, accept data from hardware/software feeds, assign and categorize data, and move said data into the Adaptive Educational Data Processing and Evaluation Engine if it may be relevant to EE analysis and generation. Such data will be assigned designations based on the nature of that data, and applicable rules of analysis will be applied based on that assignment. Such data collected by the Adaptive Educational Data and Evaluation Engine may not always generate an event unless certain threshold for Events are crossed, however the nature of that data will have been predetermined by the Common Educational Identity Engine ahead of analysis and, therefore, rules for analysis and all possible EEs applicable to that data will have already been determined. Furthermore, said engine will differentiate the processing of data into other sub-engines such as the Educational Business Networking Engine, Automated Practice Research and Educational Approach Recommendation Engine, and Stakeholder Reporting and Comparative Analytics Engine if the EEs or data may pertain to those engines. By default, data entering said sub-engines will already be defined and categorized and the EEs possible to be generated by those sub-engines will be focused and finite. Furthermore, such data will need to be captured to profiles and every engine will feed data it receives and/or generates back to the Common Educational Identity Engine.

The output(s) from each engine becomes data (and sometimes an EE) and is transferred back to the Common Educational Identity Engine to form a iterative data loop.

The invention therefore represents a unified architecture that captures data related to performance, behavior and the absence of behavior, and facilitates the interpretation of the meaning of the data. The data, including the EEs, may provide baselines of comparison for the analysis and execution of educational approaches, and therefore context for outcomes. The invention may adapt and adjust measures it applies to any stakeholder according to past, present, and incoming data, in effect continually learning how educational stakeholders actually interact.

The invention uses information collected to interpret and assign meaning to educational data, identify related stakeholder patterns, and then adaptively present information, suggestions, and offer analysis relating to academic practice and development. The invention provides information relevant to the guidance of educationally related learning, business transactions and/or related connections, and guidance on interactions and behaviors in order to assist stakeholders in their journey through the educational experience by deriving educational “Best Practice” and integrating related recommendations in real-time with educational stakeholders.

As described above, said system and method will include the measurement and derivation of measures associated with behaviors. The results of the capture of said information and data will be the ability to monitor and assess not only the Perceived Performance of stakeholders from a subjective and/or numerical perspective, but also to measure the Perceived Effort and Perceived Ability as well as associated sub-measures of stakeholders through the tracking of stakeholder behaviors and interactions which are assigned numerical value and applied to the profile of any stakeholder. This approach therefore allows the measurement of not only teachers and students, but also any educational stakeholder who has a measurable influence on the outcomes of a student, including, but not limited to, paraprofessionals, parents, tutors, support staff, administrators, schools, school districts, and allows for the direct and indirect comparisons of any stakeholders.

Values assigned to any measure may be absolute and discrete, such as the entering of a known grade of known weight and value, or can be relative, such as by derivation or comparisons based on means, averages, deviations, norms, the presence or absence of anticipated data, and profile information. This approach is accomplished while simultaneously facilitating collaboration, sharing, and the formation of academically related business connections by providing an engine which connects educational business providers with stakeholders in need of remediation-based assistance. The invention provides a means for stakeholders to assess the overall performance of an educational stakeholder which may operate outside of a typical setting such as private, home-schooled, as well as public stakeholders.

The invention provides context in the assessment of the overall performance of a stakeholder throughout his/her educational career by ensuring that a “three dimensional” measure of stakeholder performance, effort, and ability are included in the evaluation of any stakeholder, and that more specific sub-measures are utilized to provide greater and more sensitive detail in analytical feedback.

According to the invention, information could be used to include or exclude stakeholders in the evaluation of any other stakeholder by permitting outliers or atypical stakeholders such as non-participatory students, student teachers, or substitute teachers to be omitted or included in consideration of data pertaining to a particular stakeholder such as a teacher.

The invention also detects, measures, and displays cooperative analyses between stakeholders through the incorporation of social networking data concurrently with educationally related statistics in order to facilitate connections and relationships based on the mutual interests of the stakeholders, including but not limited to, connections between professionals and connections between non-professional stakeholders, as well as the parent/student populations for the purpose of forming a business relationship aimed at increasing performance. Tutoring, peer tutoring, extra help assistance identification or supplemental curriculum needs could be detected and all relevant stakeholders made aware.

In addition, through the use of these unique measures, “educational proximity” and the “Jigsaw” and “Jigsaw Ghost” social network profile establish profiles which receive set parameters and rules of educational event generation and therefore a defined anticipation of the nature of educational data associated with such profiles based on the predetermined natural roles, privacy measures, and the levels of access connected stakeholders have to each other and associated information can be limited and or governed. As such, this system will provide an interface for all stakeholders from the institutional level down to the single stakeholder level to safely engage and exchange information.

The invention increases the convenience of the educational stakeholder experience, and intuitively suggests and applies as many functions and approaches as possible for a stakeholder. This process minimizes the amount of stakeholder effort needed in profile maintenance and provides a path of least resistance pertaining to social networking and the educational success by automating as many functions as possible. In addition, the invention streamlines user connection to details of important EEs and presents tasks and suggests behaviors based on perceived urgency and/or times of their likely occurrence.

Longitudinal data (e.g., related data collected about one individual or more individuals over a significant period of time) and cross-sectional data viewed in analysis of EEs will provide readily available information on predictions of educational success and aptitude and therefore presents a true representative profile of stakeholders, quickly identify stakeholder needs, strengths, and deficiencies, provide interpretive analysis, more quickly direct stakeholders in curricular and professional direction/selection, and create more relevancy within institutions of learning. Use of longitudinal data in stakeholder evaluation results in a more accurate measurement of stakeholder performance, ability, and effort over a period, or the lifetime of the stakeholder, facilitate real time research of educational approaches and philosophies, and ultimately allow for the realignment of educational options available to individuals, or possibly the realignment of educational institutions for the purpose of better meeting the needs of their stakeholders.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

There has thus been outlined, rather broadly, some of the features of the invention in order that the detailed description thereof may be better understood, and in order that the present contribution to the art may be better appreciated. There are additional features of the invention that will be described herein after.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

The accompanying drawings, which are incorporated in and constitute a part of this specification, illustrate embodiments of the invention and, together with the general description of the invention given above and the detailed description of an embodiment given below, serve to explain the principles of the present invention. Similar components of the devices are similarly numbered for simplicity.

FIG. 1 illustrates the information and data collection process according to the invention.

FIG. 2 illustrates the data analysis process according to the invention.

FIG. 3 is an overall representation of one embodiment of the invention with a computer system or server that hosts and processes components and programs according to the invention.

FIG. 4 illustrates the flow of data with respect to human action sensing devices, third party data providers, as well as one or more computerized input devices which may or may not collect data in real time in an educational setting. This figure shows the engines of the invention and system components which are used to generate outputs in the form of Educational Events.

FIG. 5 illustrates high level system protocol and data management and aggregation showing the relational interactions between databases which handle and store data of differing forms, and how such data within the engines of said invention interact.

FIGS. 6A and 6B illustrates the structural components and the relational nature between data entities used to store data. Data entities are discrete portions of data which by their nature are different or defined to have a differing nature and are a part of the Common Educational Identity Engine. Each entity may therefore need data from one or more other data entities before it can make a proper analysis of a particular educational event. For example, data pertaining to educational actions may be viewed and stored differently than data pertaining to performance measures, which may in turn be stored and analyzed differently than data pertaining to certain EEs. Each type of data may be stored and analyzed in isolation or in tandem with or from and incoming data or data from a sub-engine received from or contained within the system engines and the software components which capture data for the system to process according to one embodiment of the invention.

FIGS. 7A and 7B illustrate a software process flow according to one embodiment of the invention which describes the interaction of the following system components; Monitoring/sensing or computerized device(s), Third Party Systems, the Common Educational Identity engine, the Adaptive Educational, Data Processing, and Evaluation Engine, and the Stakeholder Reporting and Comparative Analytics Engine. FIGS. 7A and 7 B show an example of how data is handled between system components and how data may be processed with regard to EE analysis in terms of data, outcomes, and possibly in view of time. Sensing, interface and other data in addition to possibly third party data may first pass through the Common Educational Identity engine. At such point, decisions for normalization, analysis and reporting are made.

FIG. 8 is a representation of the many relationships between various stakeholders, administrators, researchers, third party systems, and the invention.

FIG. 9 illustrates the default parity concept, thresholds, Educational Event generation, Event escalation, data oscillations and comparisons between stakeholders, de-escalation, resolution and the means by which educational data is used to track and derive said measures, both in a positive and negative educational context according to an embodiment of the invention. Said diagram assumes the use of a measure/countermeasure approach, where for any value captured by the system for one user, there is an equal or equivalent value or values which serves as a statistical balance, and therefore a means of inter-stakeholder comparison. FIG. 9 therefore illustrates how the “tension”, “balance” or “opposition” between two or more measures each stakeholder generates may be used to make statistical comparisons between that data although the nature of the data each stakeholder generates may be different. For example, a teacher may assign and check homework where a student may complete and show the homework and such data may be assigned certain values. At such a point the normalized data could be used to facilitate inter-stakeholder comparisons. Where two measures of opposing stakeholders are equal in value such stakeholders are considered by the system to be at parity for that measure and will be tracked as time progresses.

FIG. 10 illustrates a multidimensional, multi-proximity, and multi-stakeholder representation of the tracking of multiple stakeholders according to the parity concept shown in FIG. 9 as time progresses.

FIG. 11 illustrates the components and system specific relationships of data. The figure shows how specific data captured and derived by a system and method according to the invention is used to derive measures and sub-measures of PP, PE and PA, and how analysis of the two results in measures and sub-measures of ability. Furthermore the diagram shows how aggregated data can be used to express a sum-total evaluation of said measures.

FIGS. 12A and 12B represent a portion of a system process flow which illustrates the interactions between a teacher and student stakeholder and the system and method. FIGS. 12A and 12B illustrate one example way the system accumulates data such as might relate to FIG. 9 and other diagrams in this invention in terms of outcomes and possibly in view of time. This diagram illustrates the monitoring of an educational setting or event and how information and data are captured, exchanged and transformed between related entities.

FIG. 13 illustrates a system process flow and sequence which shows behavioral capture, sequencing, and subsequent analysis pertaining to an example of real stakeholder interactions and participation within the educational setting as captured objectively by the system in terms of outcomes and possibly in view of time.

FIG. 14 illustrates a system process flow and sequence of behavioral capture, conversion, and analysis pertaining to detection and measure of disruptions of the educational process in terms of data, outcomes, and possibly in view of time. FIG. 14 demonstrates an automatic means of determining the difference between actual participation in an educational setting and mere disruptions to that setting.

FIG. 15 illustrates a system process flow and sequence of behavior capture and analysis pertaining to measurement of participation and the determination of baseline activity levels in terms of data, outcomes, and possibly in view of time. Such approaches are useful in determining parity lines, standards of comparison for behaviors within and outside of the educational setting, and other uses which apply to mathematical analysis.

FIG. 16 illustrates how data from standard Jigsaw profiles can be used to generate Jigsaw Ghost profiles, as well as how a single standard Jigsaw Profile can be used to generate one or more Jigsaw Ghost profiles. Data portions from known profiles are used to derive the existence of other stakeholders, their perceived proximities, the possibly EEs that person can generate, and facilitate for more accurate analysis of stakeholders who currently use the system.

FIG. 17 illustrates how a Jigsaw Ghost profile may be established by/assigned to an individual who decides to become an active user and therefore is assigned the data related to his/herself in the newly converted profile or converted to a standard Jigsaw profile through the establishment of an official account.

FIG. 18 illustrates how Automated Practice Research and Educational Approach Recommendation Engine utilizes data captured and derived from stakeholders and associated system engines to evaluate and guide the educational philosophy of an educator. Through the analysis of outcomes pertaining to EEs the invention determines which behaviors and approaches are most and least effective either as a whole or for certain stakeholders in terms of outcomes and possibly in view of available data and/or time, and then provides recommendations based on known outcomes.

FIG. 19 illustrates how the social interactions and related academic data of an electronic environment within the system and method, as well as the electronic, and interpersonal interactions and behaviors which occur within the social and ecological structures of the actual educational setting can be concurrently captured for or between one or more individuals by the invention, stored and analyzed within the Jigsaw and/or Jigsaw Ghost profile, and further analyzed to generate educational events not previously possible.

### DETAILED DESCRIPTION OF THE INVENTION

The accompanying drawings, which are incorporated in and constitute a part of this specification, illustrate embodiments of the process, method and system and, together with the general description of the invention given above and the detailed description of an embodiment given below, serve to explain the principles of the present invention. Similar components of devices, components, etc. are similarly numbered for simplicity.

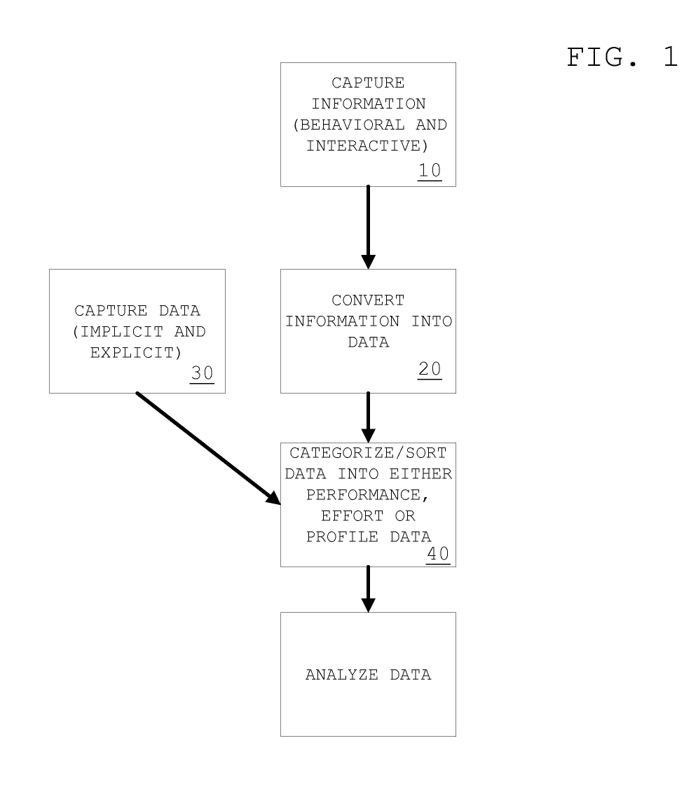

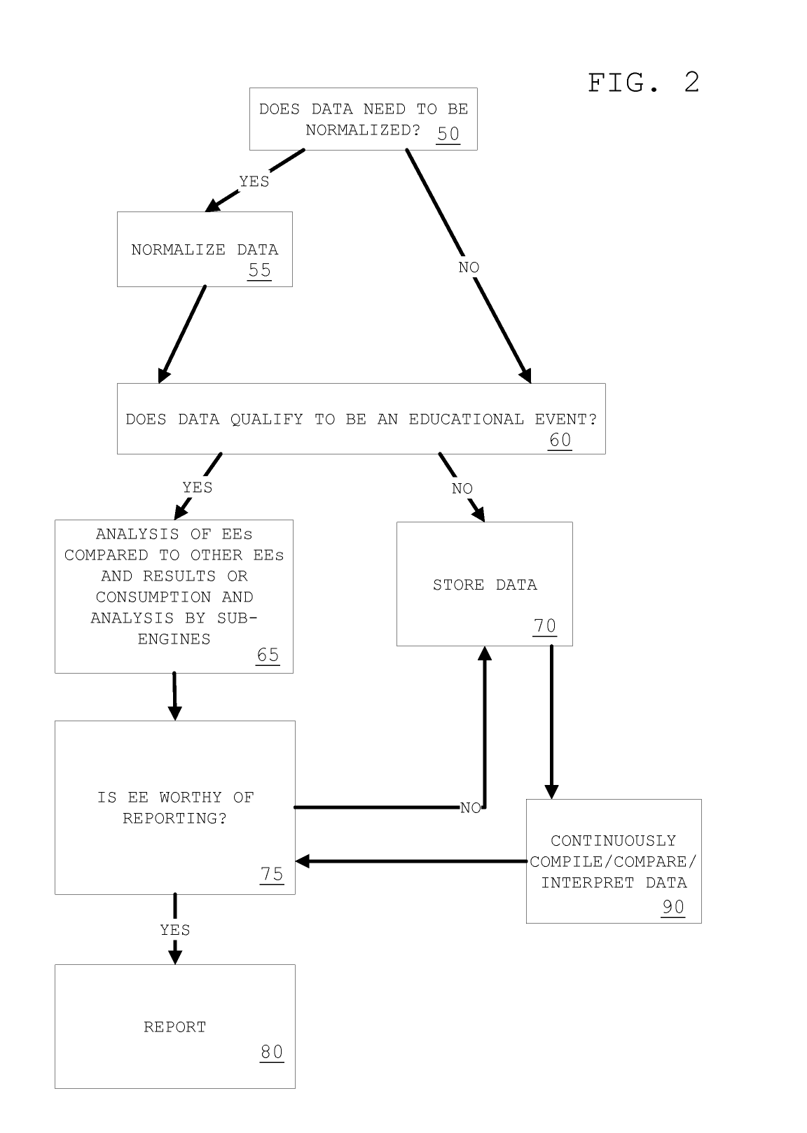

FIGS. 1 and 2 show process flow diagrams for the data collection process and the data analysis process, respectively, for the invention. As shown in FIG. 1, the invention includes a data collection process and the possible conversion of such data into a form which is usable by the system, after which a categorization may take place. Information and data is captured and/or input using equipment (e.g., a computer). Captured information (behavioral and interactional information) 10 is converted into data 20. All data (captured data 30 and data converted from information 20) is categorized/sorted into three categories of data, Performance Data, Effort Data, and/or Profile Data at 40. After categorization/sorting the data is analyzed as shown in FIG. 2.

The invention determines at 50 if the data needs to be normalized. If so, the data is normalized at 55. All data is then analyzed at 60 to determine if there is an EE. If not the data is stored 70 in a database, memory, or processor for eventual further use and analysis. If the data does qualify as an EE at 65, it is then determined at 75 if the EE is worthy of reporting. If not, the data is stored 70. If the EE is worthy of reporting, a report or notice is generated at 80. All data that has been stored is continuously compiled, compared and interpreted at 90 and checked to determine if an EE exists that is worthy of reporting at 75. In this manner, the invention is continuously and repetitiously performing operations on the data.

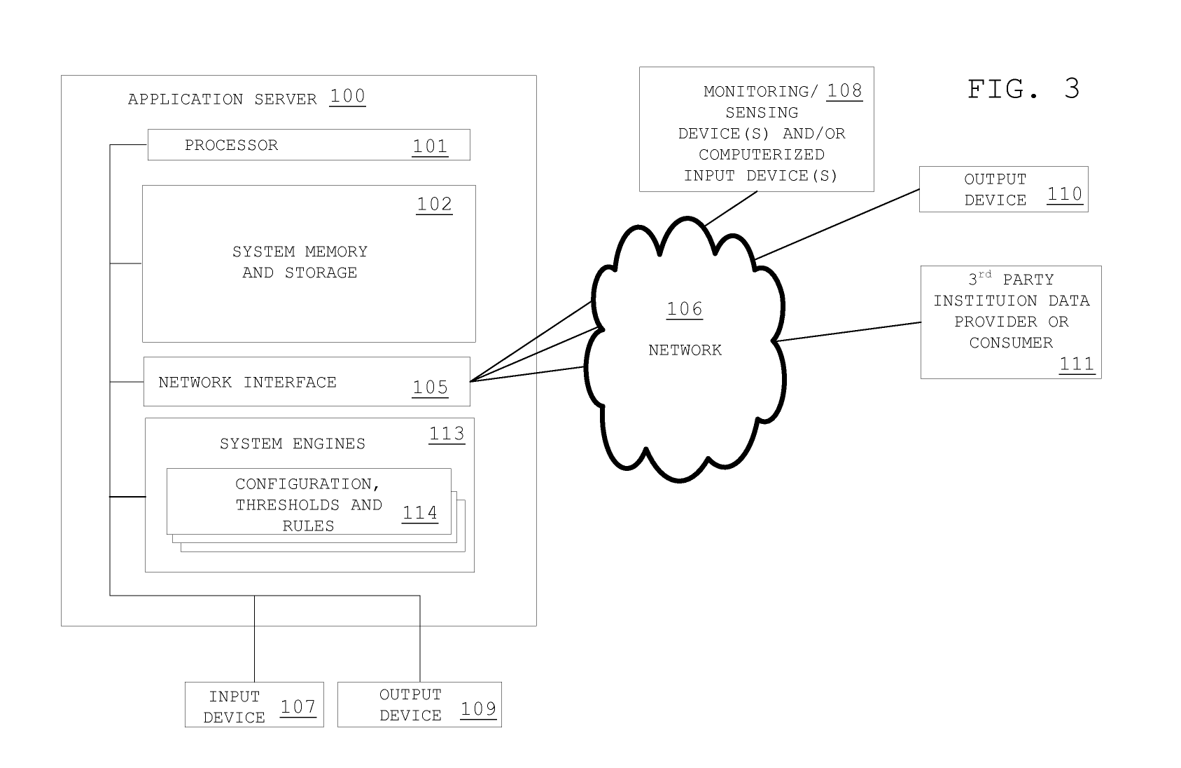

One embodiment of the invention is shown in FIGS. 3 through 19. The Integrated Educational Stakeholder Evaluation and Educational Research System 103 comprises one or more application servers 100, each with one or more a processor 101, system memory and storage 102, network interface 105, and. Input and output devices 107, 109 connected to the application server 100 capture and transfer data to and from the application server 100. The application server 100 is preferably connected to and transfers data back and forth through a network 106 which may further integrate monitoring/sensing device(s) and/or computerized input device(s) 108, output devices 110, third party institutional data providers and/or consumers such as, for example, schools or universities 111. All data, transformations, and related data capture and analysis is stored and transacted by invention Engines 113 (FIG. 3) which governs the flow of data and determines appropriate configurations, thresholds, and rules 114.

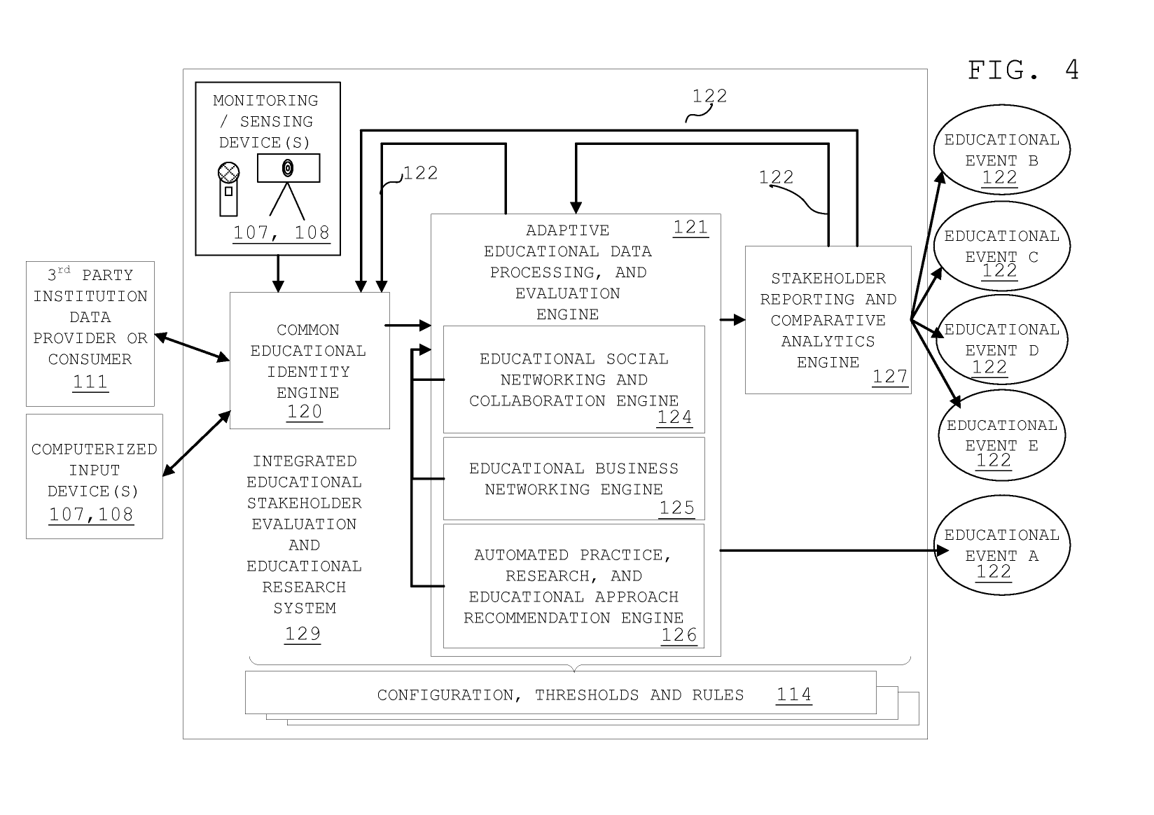

FIG. 4 illustrates how third party data 111, information and data from monitoring/sensing device(s) and/or computerized input device(s) 108, and/or currently existing Educational Event data 122 flow through the engines 129 of the invention. In the embodiment shown in FIG. 4, the engines include a Common Educational Identity Engine 120, an Adaptive Educational Data Processing and Evaluation Engine 121 and a Stakeholder Reporting and Comparative Analytics Engine 127. The Adaptive Educational Data Processing and Evaluation Engine 121 could further include as sub-engines one or more engines with more specified functions such as an Educational Social Networking and Collaboration Engine 124, an Educational Business Networking Engine 125, and/or an Automated Practice Research, and Educational Approach Recommendation Engine 126 as shown in FIG. 4. The present invention is not limited to an embodiment strictly limited to the confines of the Educational Social Networking and Collaboration Engine 124, the Educational Business Networking Engine 125, and/or the Automated Practice Research, and a Educational Approach Recommendation Engine 126 only as sub-engines. The invention also includes alternative embodiments where the Educational Social Networking and Collaboration Engine 124, the Educational Business Networking Engine 125, and/or the Automated Practice Research, and a Educational Approach Recommendation Engine 126 are independent from the Adaptive Educational Data Processing and Evaluation Engine 121. Other embodiments of the invention could exclude the Educational Social Networking and Collaboration Engine 124, Educational Business Networking Engine 125, and/or the Automated Practice Research and Educational Approach Recommendation Engine 126 entirely.

All data flows from the Common Educational Identity Engine 120 through the Adaptive Educational Data Processing and Evaluation Engine 121, including any/all other sub-engines 124-126 whereby Educational Events may be generated. Outputs from the system are created and generated through the Stakeholder Reporting and Comparative Analytics Engine 127. Upon processing data from said sources 107, 108, 111, 122, Educational Events are generated, escalated, resolved, or de-escalated 122. Said EEs may be fed back into the system for further evaluation and/or anticipation of new data necessary to generate or resolve a new or existing EE.

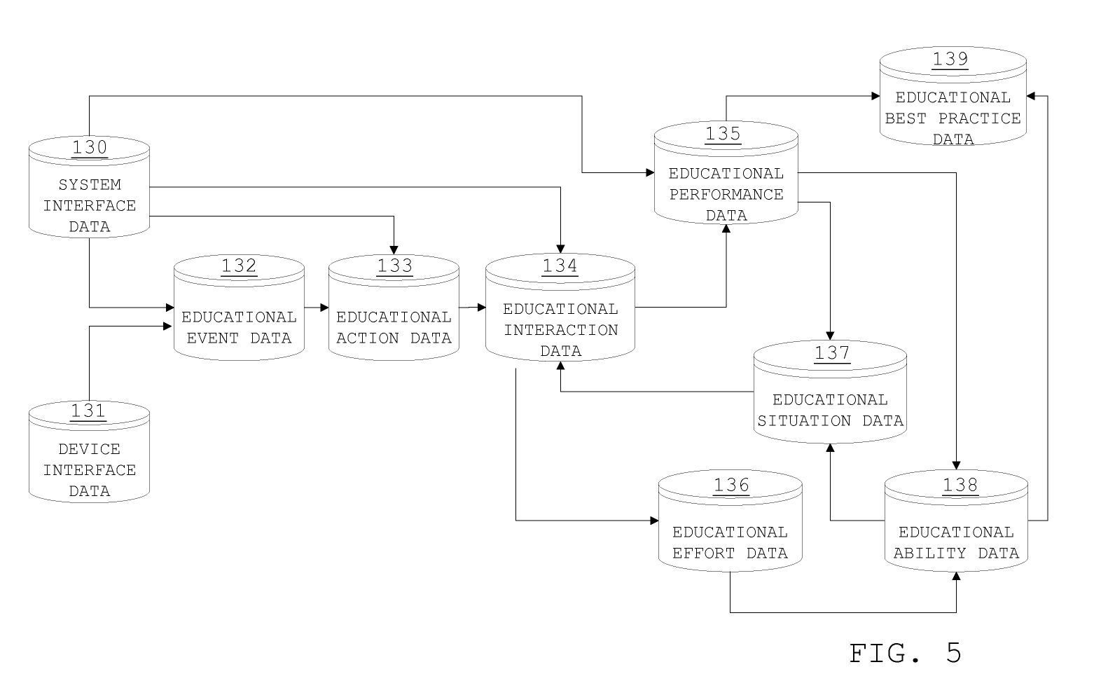

FIG. 5 illustrates how system and device data 130, 131 are normalized from various formats into data which can be useful in generating EEs in order to determine “what happened” 132, whereby the results are educational events represented as a canonical data representation of the system. Said normalized educational event data maybe aggregated during short periods of time into meaningful actions within the educational context as indicative of “who did what” 133. Outputs of 133 can be correlated events of stakeholders, at a location, during a time period into meaningful interaction data “Who Interacted with Who and How” 134, and then analyzed based on interactive 134, performance “Result of Interaction” 135, effort “Who and How much effort” 136, and situational data which provides context to actions captured 137, which may, among other analyses, reveal stakeholder ability 138. Resulting analysis will be fed to a best practice database 139. This diagram shows how differing types of data with unique natures and orientations can be processed and assembled in a unified architecture which may be able to derive performance, effort, ability, and best practice analysis.

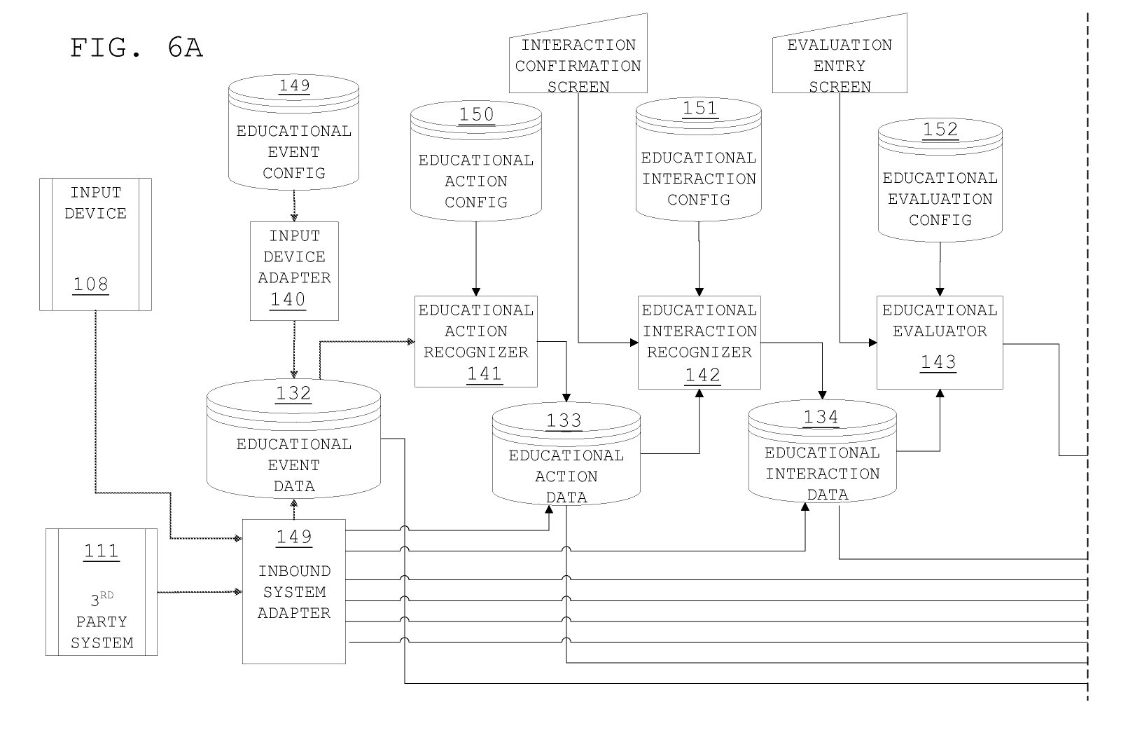

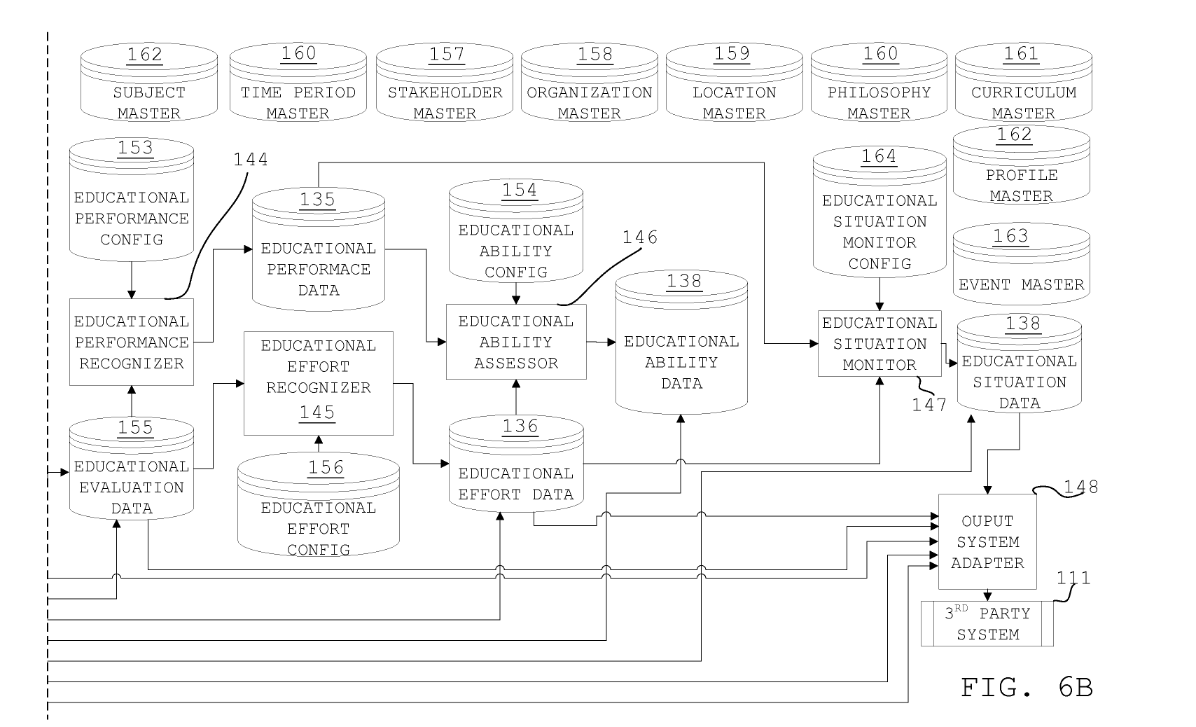

FIGS. 6A and 6B illustrate a more detailed representation of how data derived and captured from FIG. 3 interacts and integrates 132-138 with software components 140-147. Data recognizers 141, 142, 144, 145, assessors 146, adapters 140, 148, and evaluators 143 accept data from and deliver data to 3rd party systems 111, and/or monitoring/sensing device(s) and/or computerized input device(s) 108, and integrate/utilize data to and from event, action, interaction, configuration, evaluation, performance, effort, and ability databases 149-156. In addition, institutional, situational, educationally related data, and measures of time will be included in data/software relationships 158-164. This diagram shows the dynamic processes that will be involved in data analysis from the point of data acceptance from devices or 3rd parties, to the point of the output of the analysis of said data.

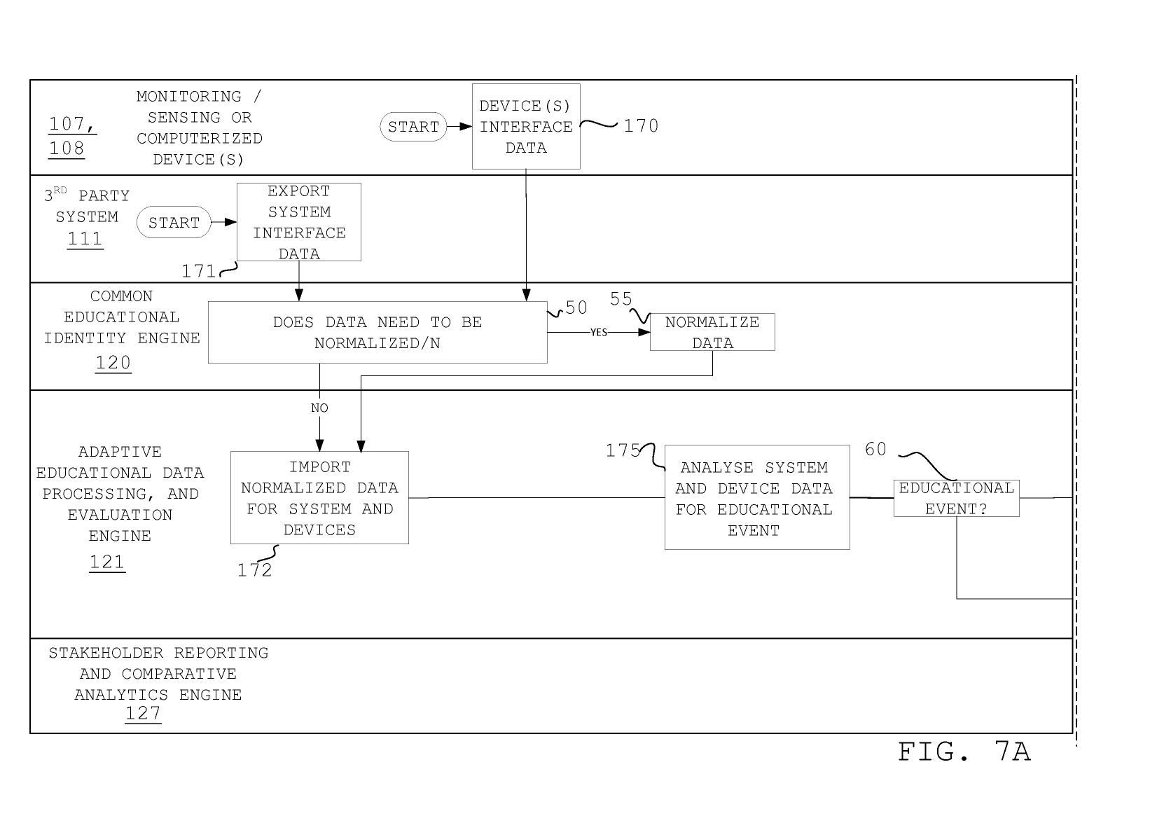

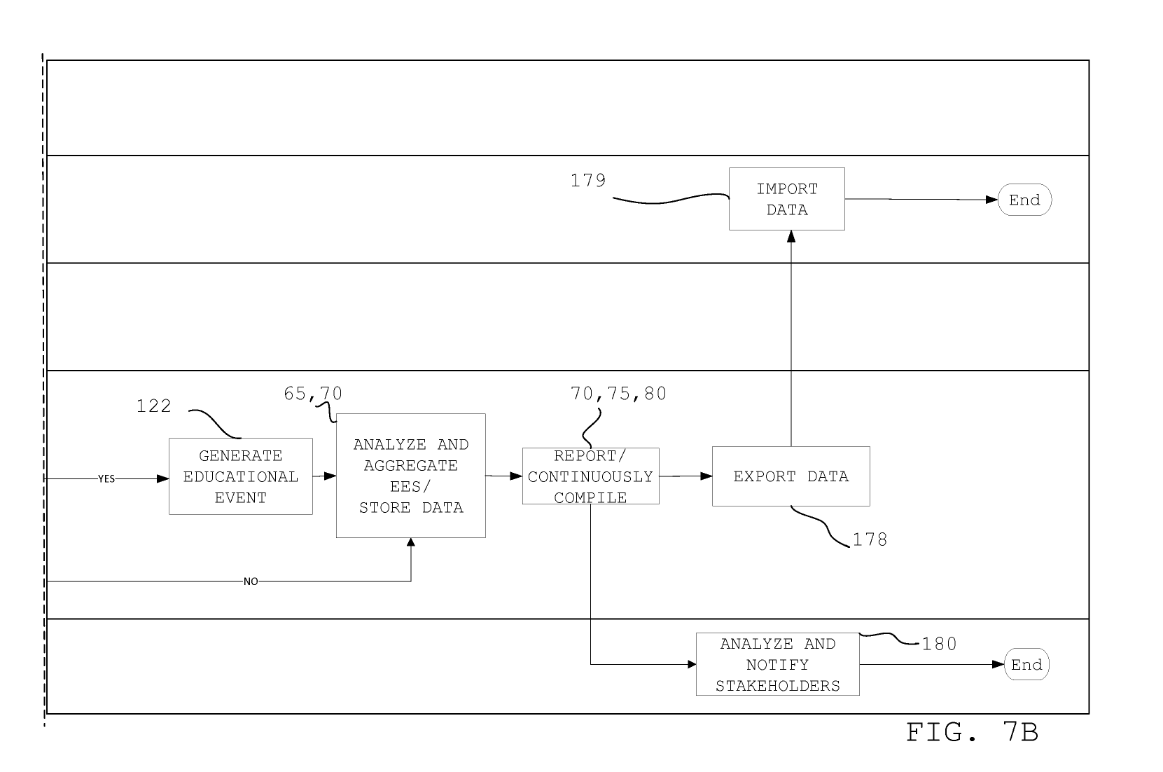

FIGS. 7A and B show how information captured from monitoring/sensing device(s) and/or computerized input device(s) 108 and 170, and data from third party systems 111 are processed by a Common Educational Identity Engine 120, an Adaptive Educational Data Processing and Evaluation Engine 121 and a Stakeholder Reporting and Comparative Analytics Engine 127. The output of said devices 107,108 and engines 120 is imported by Adaptive Educational Data Processing and Evaluation Engine 121 for EE analysis. Normalization may occur at 55, followed by an acceptance of such data at 172 and analysis 175 so that a decision 60 on whether or not to generate an EE 122 may occur. Educational Events will be analyzed for relationships and relevant stakeholders 65, 70 notified 70, 75, 80, and/or said data may be compiled, and then exported 178 to an interface which will import said data 179 to a third party system 111 or analyze and report results of such analysis 180 in the Stakeholder Reporting and Comparative Analytics Engine 127.

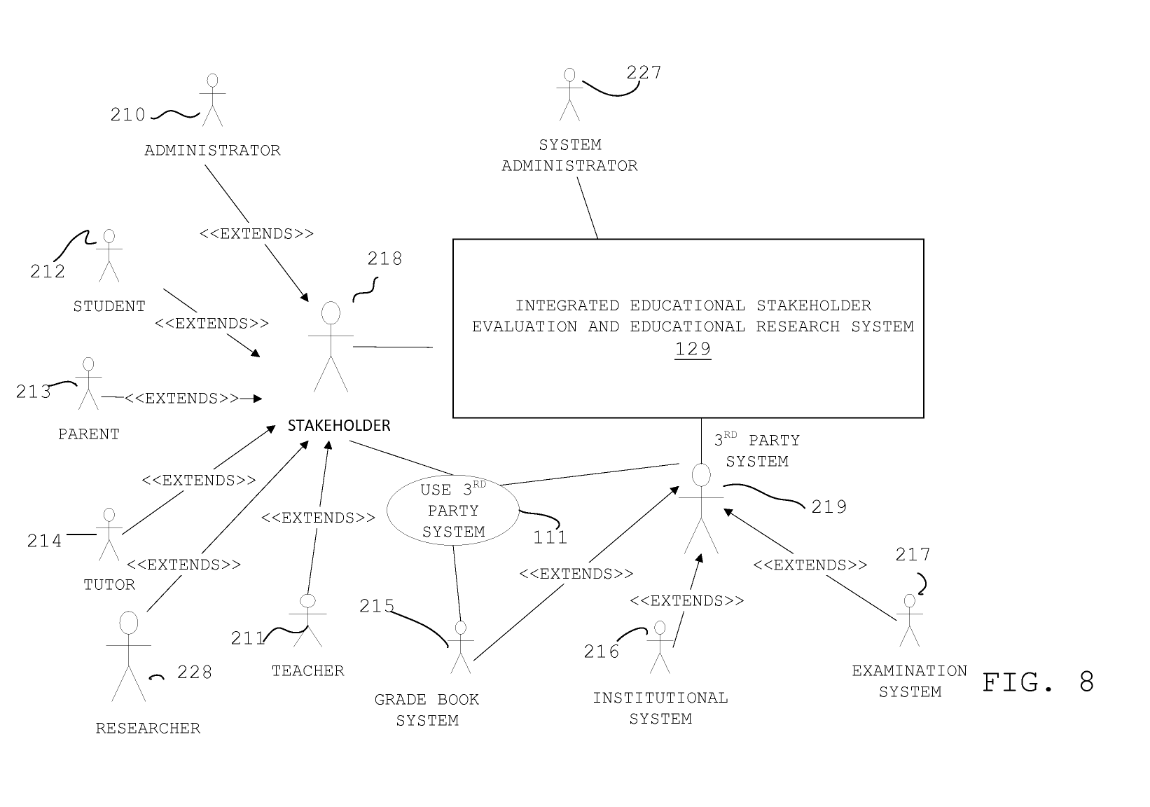

FIG. 8 depicts relationally how the invention views data which is collected from multiple stakeholders to be component to the profile makeup of one or more single stakeholders 218. Any stakeholder including, but not limited to school administrators, teachers, students, parents, tutors 210-214 may be considered by the system as having generated or having the potential to generate data which is relevant and of importance to the outcomes of said stakeholder 218 and vise versa. As data is generated/captured it is channeled into the Adaptive Educational Data Processing, and Evaluation Engine 121 for analysis as depicted in FIGS. 2 and 4. Data may also be collected from any 3rd party systems 111, which may include but not be limited to a grade book system 215, examination system 217, or an institutional system 216 for analysis. Data and events analyzed and generated as a result of processing in the Adaptive Educational Data Processing, and Evaluation Engine 121 may be imported or exported by a system administrator 227 or researcher 228 or further collected for research and analysis.

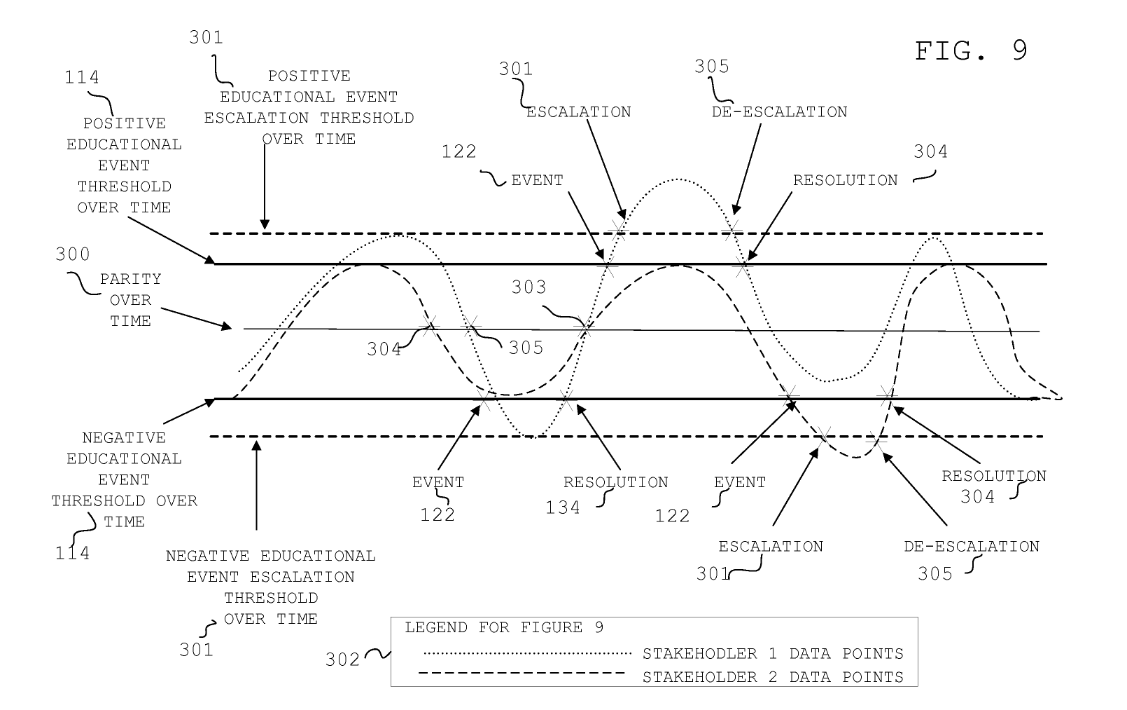

FIG. 9 illustrates how data processed according to the invention is analyzed by its component engines to determine if an EE has occurred. This diagram also shows a basis for the system to complete an inter-stakeholder analysis. FIG. 9 shows an example in which two stakeholders and their data are being simultaneously collected and tracked. The legend shows stakeholder data points 302 may be individual and/or clusters of data or data derivatives and results of analyses. Said figure conceptualizes the changing values of data by oscillating in a positive and negative direction. The parity line 300, represents the point at which a comparison of certain related data between two stakeholders will result in a particular measure and its countermeasure being equal and/or balanced in comparison to each other. This might include a single set of data between two users or be applied across many measures and stakeholders. In other words, given available data or available Educational Events or Event clusters, a comparison of these two stakeholders would result in them being considered at parity for that measure whenever their data points cross the parity line. Parity lines and thresholds may be considered to be either static and unchanging in nature or static and dynamic in nature being subject to the influence of data that is further collected. One oscillating line that crosses parity may be a measure for just a stakeholder attaining parity for measures pertaining to data within the profile of his/her self, or both stakeholder lines may indicate data for one individual and separate tracking of opposing data for an individual of comparison. In that case, the convergence and crossing of point 303 would indicate the point at which both stakeholders approached and/or attained parity for a value. Another variation could be each separate line for each stakeholder representing two differing and unrelated values, and when the data crosses parity they are at parity between themselves and another stakeholder they are considered to have educational proximity to 304, 305. However, in all cases a deviation to the positive or negative direction 114 indicates a deviation from parity for that frame of reference. It is understood that stakeholders will typically not be at parity for very long but that they may oscillate and variation within acceptable boundaries may exist that would be considered to not be worthy of being considered EEs. This would be data that fell anywhere within the confines of the positive and negative threshold 114. Also, although the invention may at times use standard deviations in deriving comparisons, it is not merely a calculation that produces a measure for standard deviations. Instead the invention analyzes data generated between two stakeholders which is considered by either the invention and/or its users as being equal and opposing/complementary in its nature, and analyzes how the interactions between such stakeholders relates to a theoretical or actual parity between two or more data points. Therefore, thresholds of normalcy are established that determine when a deviation from parity has absolute or relative significance at the point of 114. This may be based off of absolute measures such as a failing grade, or relative to shifting values, means, averages, deviations, etc. Examples might include the checking and assigning of homework by a teacher and the completion and verification of completion by the student. Given this example each action may generate a particular value that has the potential for equality in its measure and the analysis between such values will reveal if parity exists for such stakeholders. Crossing the threshold 114 results in an Educational Event 122 and further crossing another threshold may result in an escalation of an Event 301. Crossing back toward the parity line across these Educational Event thresholds will result in a de-escalation or resolution of Events 304, 305. Alternative data points may be permitted to allow for resolution such as the completion of an extra credit to make up for a missing homework, etc. Resolution may also occur as a function of time regardless of the necessary data being received that would ordinarily result in a crossing back over threshold 114. Crossing over these thresholds away from parity will result in increased system “awareness” and possible communication from the system to a stakeholder, and staying within thresholds may result in decreased awareness or the system considering related changes in data to be insignificant and therefore not needing attention.

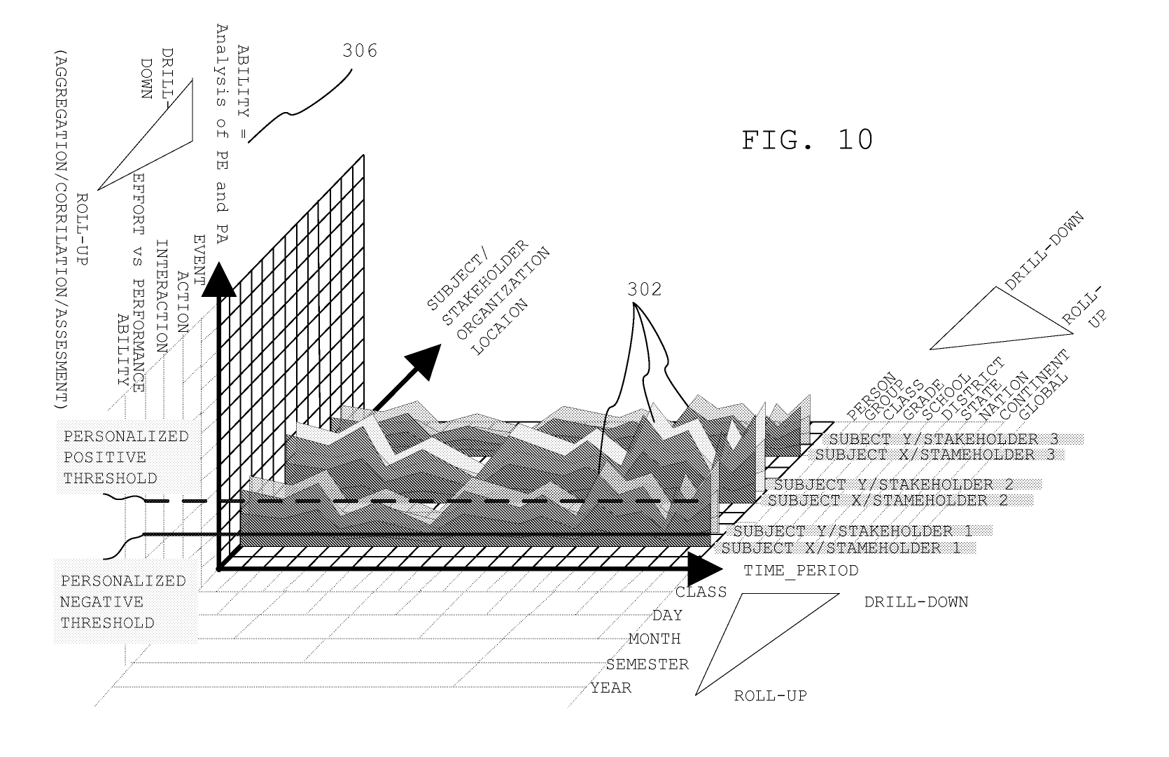

FIG. 10 illustrates the concept of FIG. 9 as applied across multiple dimensions and/or multiple stakeholders pertaining to measurement and analysis. FIG. 10 shows how measures relevant to FIG. 9 might be simultaneously tracked, captured, analyzed, etc. EEs which do or do not relate may be tracked simultaneously or in parallel. The data for many stakeholders as represented by the changing data values 302 may be simultaneously tracked across several dimensions of time 312, Educational Events, behaviors, interactions, and related data 313, thresholds 314, and proximities of stakeholders 311. Such data is captured and analyzed for measures pertaining to performance, effort, and ability 306 and allow for intra and inter-stakeholder analysis to occur as EEs are collected across multiple measures

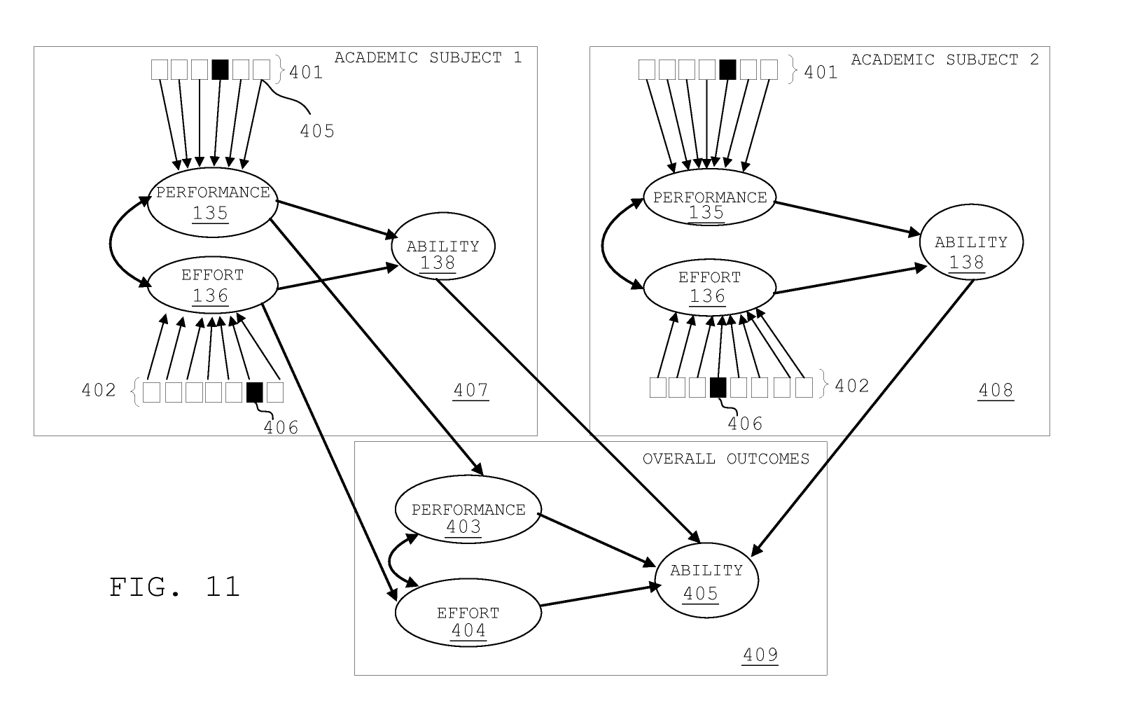

FIG. 11 illustrates the derivation of PA from data related to performance and effort, PP and PE. The Figure shows how data is used to derive a measure of PP and/or PE, and to further derive PA from analyzing the relationship between performance and effort. Such analysis can occur from data derived within or between multiple levels of study, subject, grade levels, etc. In the example provided, analysis can be conducted not only for one academic subject 407, but also for more than one subject or analysis focused on a particular measure 408, in order to derive overall 405 measures of PA 403, PE 404, and PA 409. Data 405 from performance-related events 135 and associated sub-measures 401 and data 402 from effort-related Events 136 and associated sub-measures 406 are analyzed to produce a new measure of PA 138

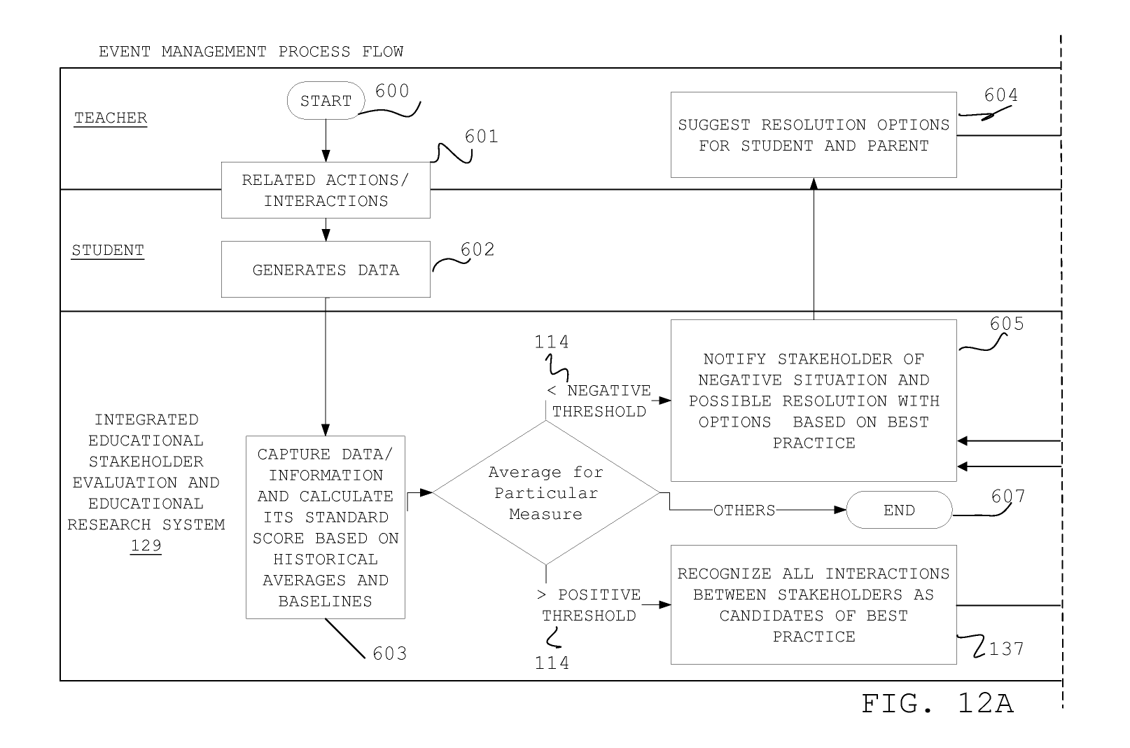

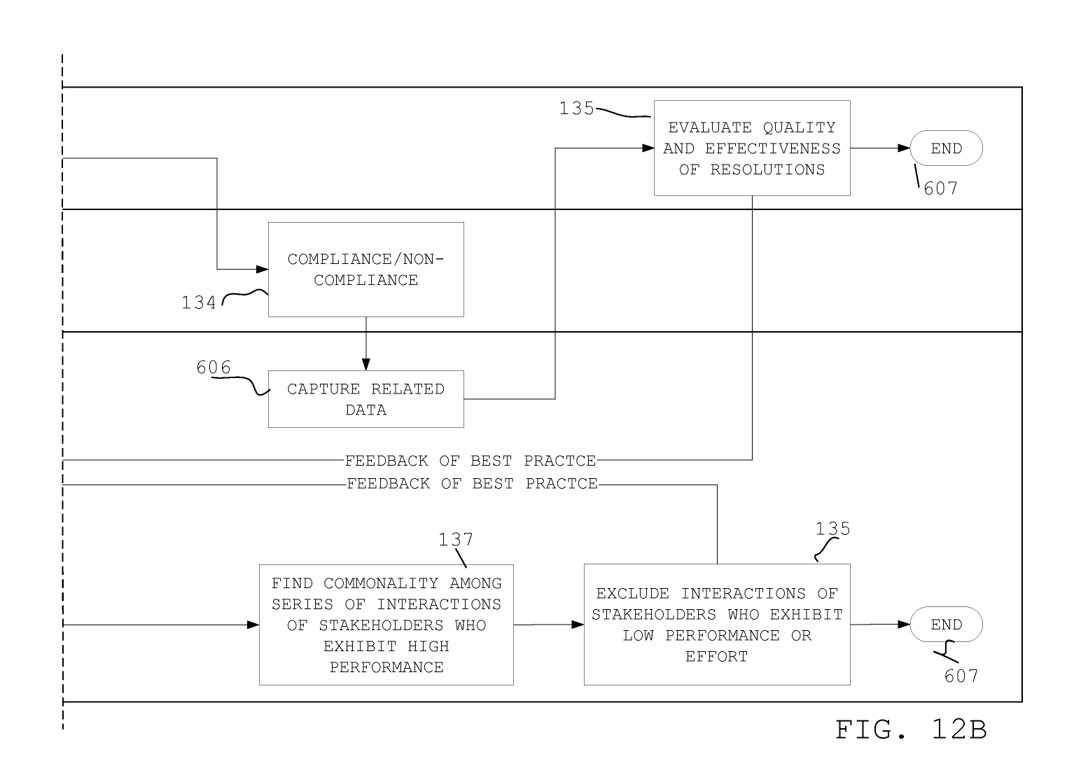

FIGS. 12A and 12B illustrate a data monitoring flow which shows how an event is tracked and handled between a, student, teacher, and the system. When information and/or data are captured 601,602,134 the data is compared against historical data and historical averages, measures and countermeasures 603 contained within the system 129, and assessed against thresholds for events in a positive or negative direction 114 according to the method described in FIG. 9. Analysis of best practice 137, 135 will simultaneously occur while notifications and suggestions to stakeholders 605 may be executed by the system. Resolutions may occur, or may not, and results of said analysis will be captured 606. Analysis of the effectiveness and quality of resolutions and actions as well as prioritization of options will occur. Sequences of monitoring may end if events are resolved or can go no further 607.

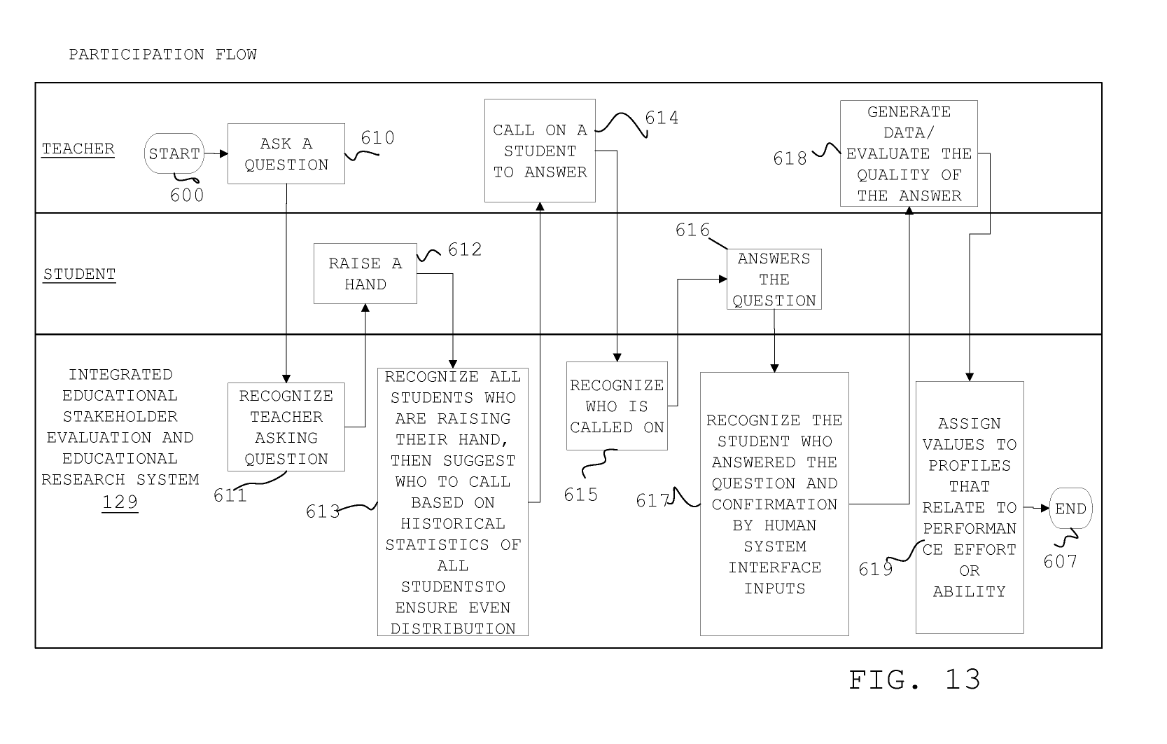

FIG. 13 illustrates example behavior and information that could be collected and converted into data, such as, for example, interactions between the teacher and students which the invention 129 uses to determine measures, including PP or PE as a matter of participation. This illustration shows how the invention detects and captures the sequence of a teacher asking a question 610, recognition that the teacher has asked a question 611, a student raising his/her hand 612, the recognition and capture of data relating to all students attempting to contribute an answer 613, the teacher acknowledging a particular student 614, the detection 615 of the identity of that student through any relevant monitoring or detecting device 107, 108 as described in FIG. 3, the capture of student response through the same means 616, recognizing that student answered the question 617, and then asking the teacher to confirm the answer either by data entry, video, or audio means 617, and generating data and/or evaluating qualitative and quantitative merits of the answer 618. At this point, the invention assigns values to profiles which relate to either PP, PE or PA 619, and the sequence may end 607. Ultimately the data created as a result of capturing such behaviors and interactions may be stored as data, video, EEs, and/or Event sequences. Data captured as a result of such behaviors must be normalized and converted into a new form.

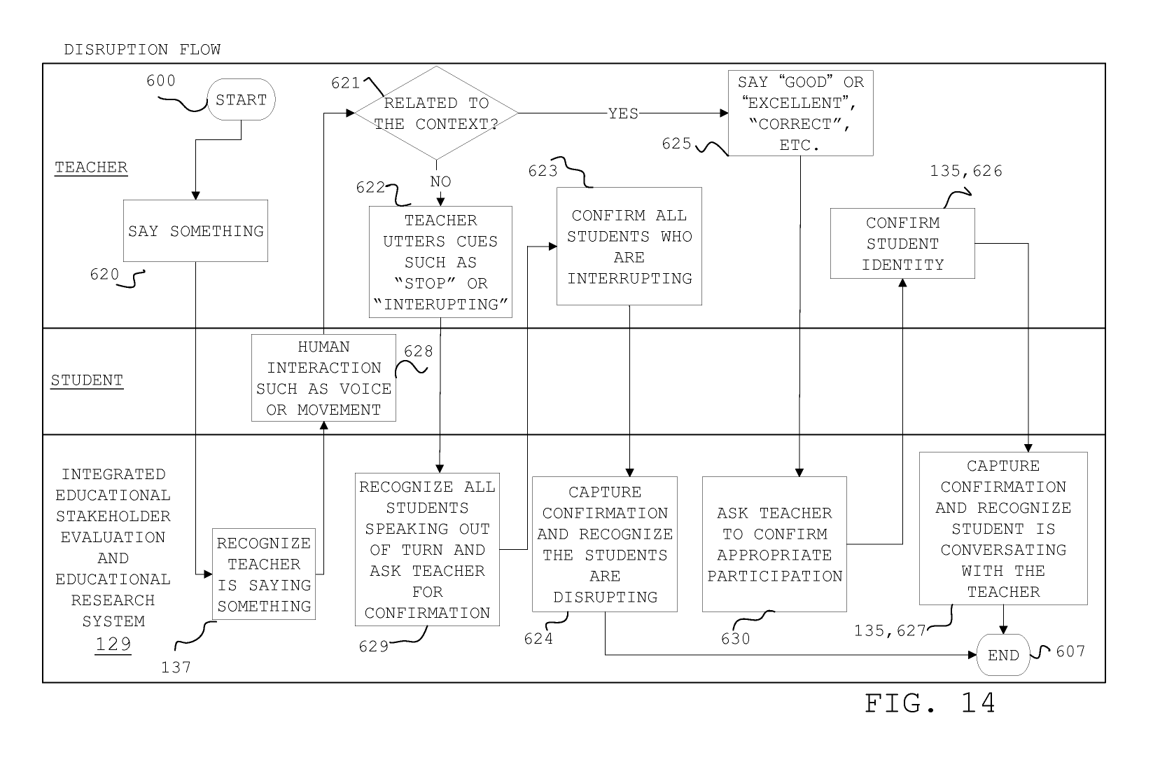

FIG. 14 shows how the invention is able to differentiate between participation described in FIG. 13, and possible occurrences of disruptive behavior within a class setting between teachers and students. At the beginning of the sequence 600, the teacher may or may not say something 620, the invention may recognize the teacher spoke 137, a student may say or do something 628 and the invention may detect if what the student said related to the question or content or context 621 if yes, then the invention may detect a positive utterance from the teacher such as “good” or “excellent” 625. If the student response was not relating or in turn or in context a teacher might utter a negative response such as “stop” or “you are interrupting” or “please raise your hand” 622. The invention will attempt to track who is interrupting based on a sequences of actions and/or utterances 629,624, and a teacher may be able to confirm manually or by audio/video methods which students are interrupting 630. Data is captured 624 and possibly ended/resolved 607. If the student who was positively affirmed was confirmed by the teacher 630, the invention may ask the teacher to confirm whether or not any other detected students were interrupting the question session or others who are having appropriate exchanges 630, 135, 626. In this context, the invention may also show a heat map to teachers and/or students based on either participation or disruption that is automatically determined by the system with graphic representations of their presence in the room which might change color as disruption/participation increases. The invention may also make allowance for normal and age appropriate behaviors by allowing a certain number of interruptions based on baseline data as determined by methods according to FIG. 9, or by not counting interruptions in a negative value if the system compliance with a teacher response to “stop”, etc. Therefore said invention has the capacity to differentiate between behaviors which would generate positive or negative events in one scenario verses the same behaviors which might not given another scenario or those behaviors occurring with a different set of students.

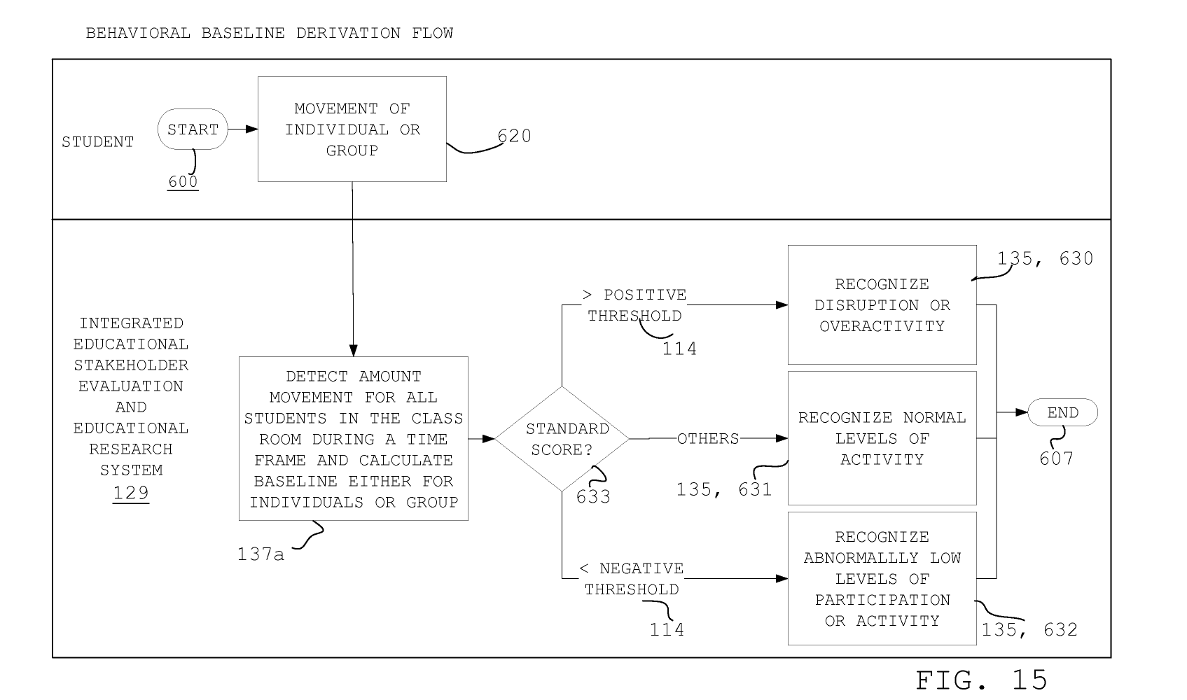

FIG. 15 illustrates how the invention is able to establish behavioral baselines based on detection as occurring between the invention 129 and students by recognizing general activity and participation levels. At the start of the sequence 600 the invention detects movement for an individual and aggregates individual activity level data into data for that one individual or may do so for all individuals in the room, or may detect the overall activity and participation level in the room as an aggregated group 620. At this point, the invention recognizes how each individual students' participation and activity level compares to baseline data 137a. Comparisons can be multifaceted and include but not be limited to comparisons to peers in a room, to peers overall, to classes or groups of classes, to age groups and/or demographically similar students, etc. 633. If the student crosses a positive or negative threshold 114 in comparison the average or standard score of such measures 633 then the invention recognizes the disruptions or overactive state 135, 630, the normal level of participation 135, 631, or the abnormally under-active state 135, 632, and may or may not generate an educational event at the end of the sequence 607.

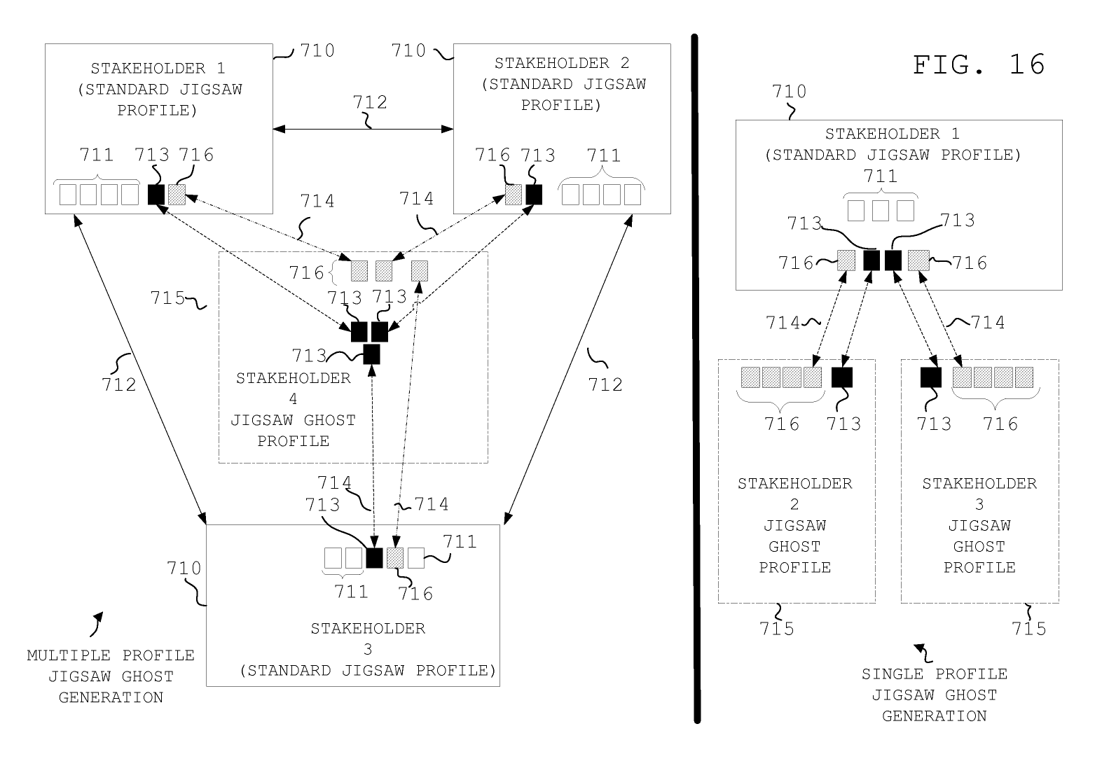

FIG. 16 illustrates two representations of how a Jigsaw Ghost profile 715 can be generated from data 713 that is captured/stored within a standard Jigsaw profile 710. Data 710 may be analyzed concurrently with data and events exchanged between profiles 712. Data which comprises an existing profile or is captured within a Jigsaw Profile 711 may sometimes show signs of the existence of a stakeholder of proximity who has not yet up to that point been identified as existing user, or who has not yet formally established an account or claimed a Jigsaw Profile. Because interactions and data associated with said stakeholder may hold critical information regarding the measurement of all impacts on a primary stakeholder or stakeholders, the invention generates a profile position which will allow for the gathering of data and interpretation of the impact of the interaction with said stakeholders 715 based on possible EEs and/or proximity. Said stakeholder data 711 may then be given a special designation 713 and that data be used to compile a Jigsaw Ghost profile 715 from one or more Jigsaw or Jigsaw Ghost profiles. As a result, new data and events 716 may be generated and exchanged 714 between all Jigsaw and Jigsaw Ghost profiles 710, 715. Because new events are possible, the invention generates all possible and potentially expected EEs based on rules and thresholds associated with the default proximities of stakeholders to the new Ghost profile. Potential EEs are anticipated based on current and historical data. For example the possible events assigned between a certain Jigsaw Ghost and another Jigsaw (e.g. stakeholder 1 and 4) may be different than between that same Jigsaw Ghost and a different profile (e.g. stakeholder 2 and 4) if their relationship is different.

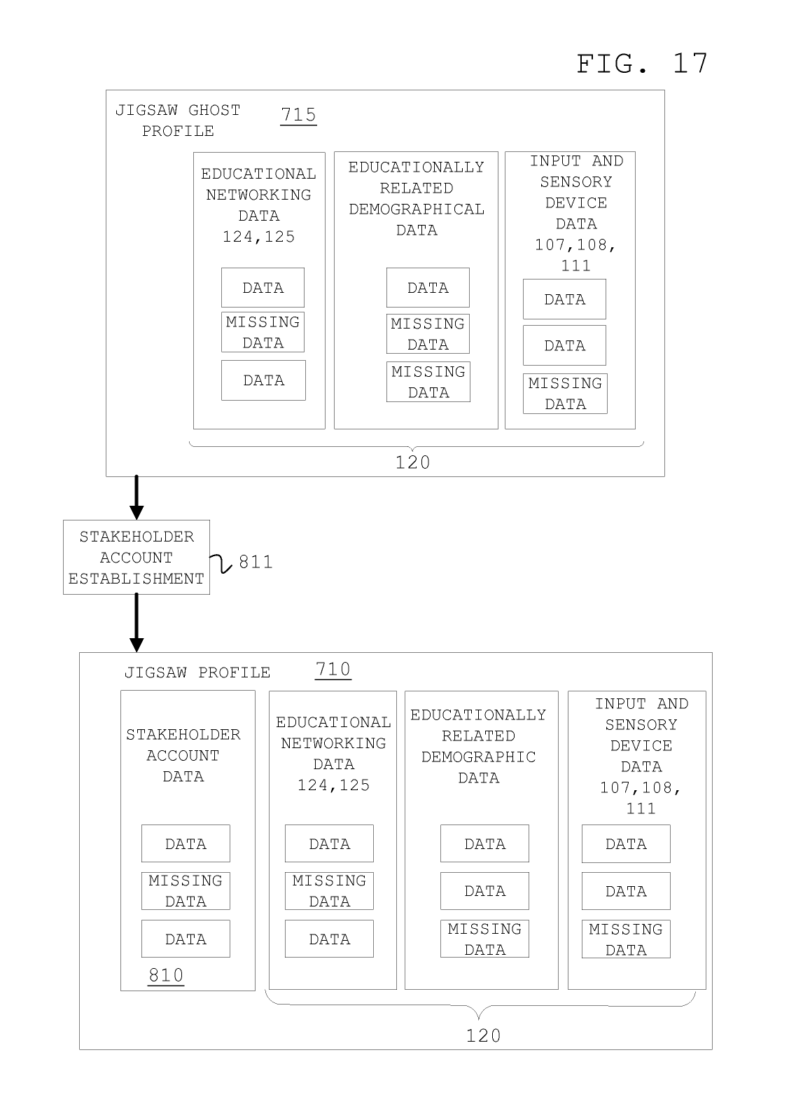

FIG. 17 Illustrates how a Jigsaw Ghost Profile 715 consisting of Common Social Educational Network Data 124, 125, Educationally Related Demographical data, and Input/sensory Device Data 107, 108, 111, all contained within a Common Educational Identity Profile 120 can be converted into a standard Jigsaw Profile 710 through the claiming of a Ghost Profile or the establishment of an account 811. This is accomplished by combining Ghost Profile Data 716 according to FIG. 16, with newly captured/entered stakeholder account data 810. Upon the establishment of an account stakeholders may choose to import all Ghost data or it may be possible to start with a fresh profile whose historical data is not erased but is no longer considered part of that profile. In other words, it may be possible to merely convert a Jigsaw Ghost 715 into a Jigsaw 710 or for a new Jigsaw 710 account to be established and the associated data of the Ghost profile 715 might remain concealed with said Ghost 715 while any subsequent data captured or generated is associated with the new standard Jigsaw 710. In either case, past data and Events might still be used to derive events and comparisons between stakeholders.

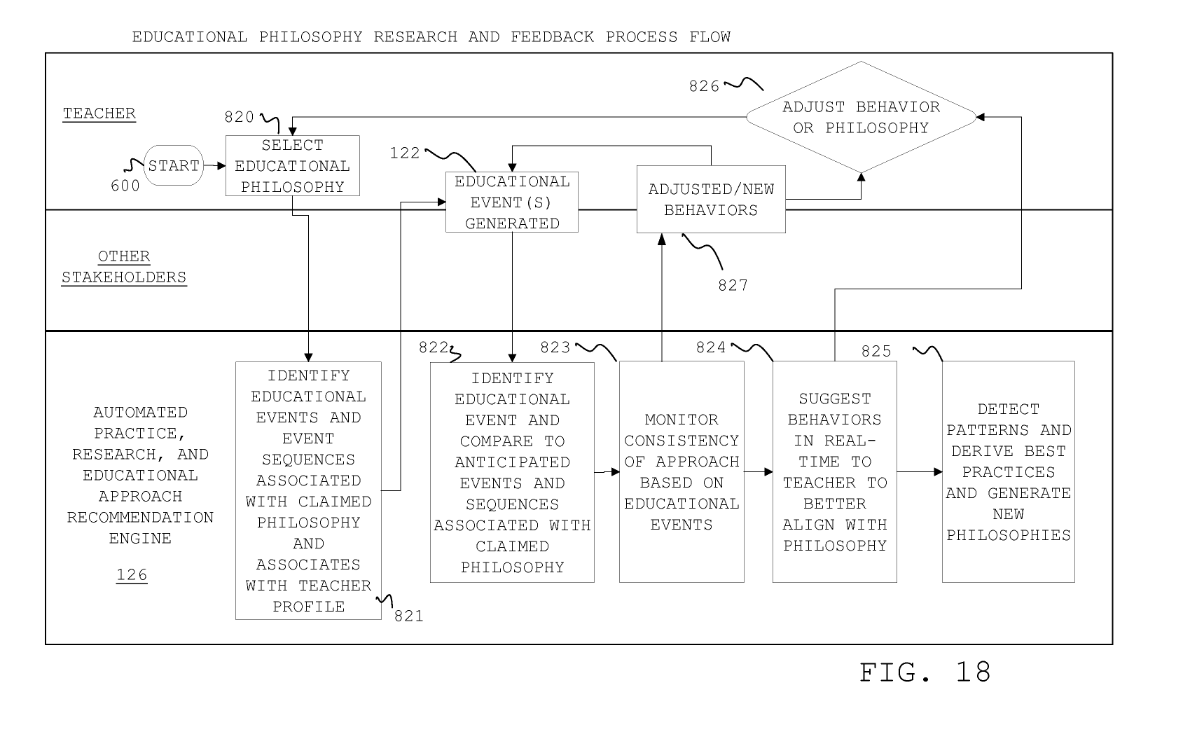

FIG. 18 illustrates how the invention, specifically a sub-engine of the Adaptive Educational Data Processing and Evaluation Engine 129 called the Automated Practice Research and Educational Approach Recommendation Engine 126, objectively evaluates Educational Events in contrast to a claimed educational philosophy. At the start 600, a teacher may select an educational philosophy 820. Upon capture of claimed philosophy, the invention identifies Educational Events and Event sequences 122 which most closely associate with that teacher's claimed philosophy 821, and assign predicted and/or potential Educational Events consistent with that philosophy to a Teacher profile 822. Upon claiming a philosophy, the invention monitors any and all Educational Events an educator then generates 122. Said Event data 122 will be compared to said claimed philosophy 820 in light of potential and actual EEs 821, 822 and anticipated Educational Events and Event Sequences that are associated with that philosophy 822. An analysis will continuously occur that compares claimed philosophy with actual events that are generated in order to determine how accurately said teacher's behavior aligns with his/her claimed philosophy 823. Upon completion of analysis, the invention determines on a relative scale where the stakeholder actually lies on a continuum of approaches in reference to their claimed or goal philosophy. The invention then determines which new Educational Events and Sequences would be most likely to assist said teacher in more closely aligning with his/her claimed philosophy and will actively suggest behaviors that will generate Events that more closely align that teacher with their philosophy or which philosophy more closely aligns with their behaviors 824, 826, 827. Said system will continue to monitor Educational Events and associated patterns in comparison to relative and absolute outcomes for all stakeholders and determine Best Practice 825. Best Practice may be absolute and generally applied to multiple stakeholders (a teacher and all his/her students) or relative and specified to the profile data of a particular stakeholder (a teacher and an individual student or a particular class). It may be possible that according to stakeholder needs or based on feedback a teacher receives they would be able to adjust their behavior or philosophy, or possibly employ a mixture of philosophies as appropriate 826. As a result of behavioral guidance from the invention new and/or adjusted behaviors may result 827 between stakeholders and may lead to new Educational Events 122. This process could be adjusted in real-time as more data becomes available. Stakeholders might also be able to indicate to the invention which practices and methods they employ in their teaching, for example grade book settings, or the types of assessments they employ, which would then determine the EEs which are possible for related stakeholders to generate within the context of that philosophy.

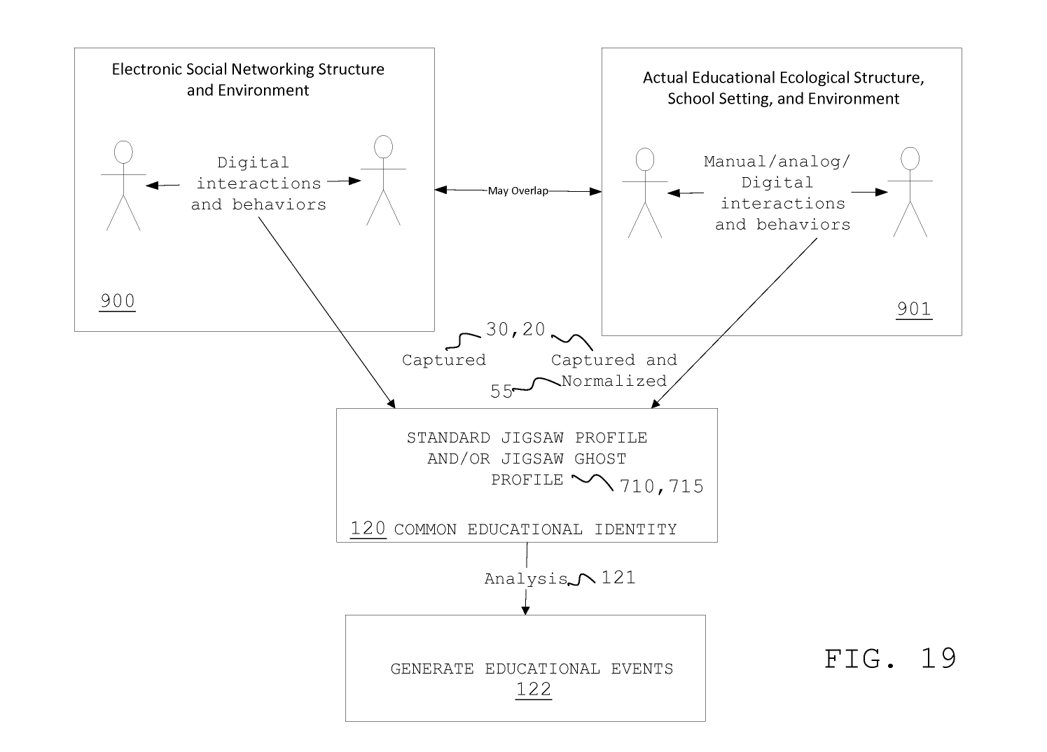

FIG. 19 shows how two related yet inherently different social structures may be concurrently analyzed to reveal and capture educational data and Events not possible in isolation. The Electronic Social Networking Structure and Environment 900 represents both educationally and socially related data captured by the system by means of interactions on an electronic level. Actual Educational Ecological Structure, School Setting, and Environment 901 represents any aspect of the educational setting which entails the natural or induced environments and related interactions between stakeholders within the day-to-day settings themselves. This environment assumes the natural or imposed social structures as well as inherent interactions are to be expected or unexpected within the setting or a sub-setting thereof. Data from both electronic 900 and interpersonal social networks 901 is captured 30/20 and/or normalized 55 whereby all interactions from both social constructs are converted into data which the system may then use for analysis. Such data is assigned ultimately to either a Jigsaw or Jigsaw Ghost profile 710, 715 within the Common Educational Identity Engine 120 where they are analyzed by the Adaptive Educational Data Processing, and Evaluation Engine 121 for the possible generation of Educational Events 122.

### Description of System Functions and Operations

### Specifics of Educational Events as Pertaining to all Engines/Sub-Engines

EEs act as a data “currency” between any engines/elements described in the engine, and are the basis by which they initiate and conduct meaningful communication. All interactions between elements rely not only on statistical calculations and data received, but also on EEs. Ultimately, the nature of a particular EE or group of EEs may determine which engines receive such data and which elements are connected by necessity for the proper processing of data and the proper integration of educational data points with behavioral data points which may lead to any derived EE.

The invention creates and monitors EEs. EEs are defined as conditional, derived, or discrete data events that are deemed to have impacts of statistical or analytical significance on any level or sub-level of three main branches of stakeholder measurement determined by the invention: Perceived Performance, or “PP”, Perceived effort, or “PE”, and Perceived Ability, or “PA”. The Adaptive Educational Data Processing and Evaluation Engine 121 determines the PP, PE and PA for each stakeholder based upon all data, including EEs. PP is a calculated value resulting from statistical analyses of data, including EEs collected, related to a variety of stakeholder inputs/outputs/measures deemed to be indicative of the academic adequacy of a stakeholder as determined from the data they generate. Examples include, but are not limited to Performance Data, e.g., grades, portfolios, standardized test scores, and any typical educationally related measures of student outputs.

PE is a calculated value resulting from statistical analyses of data, including EEs, related to the presence or absence of any educationally related behaviors, real or electronic, which may be aggregated, correlated, quantified, and qualified in order to facilitate the numerical evaluation of educational stakeholder behaviors, or the lack thereof. PE is related to the effort expended by an individual in achieving a particular performance outcome in relation to time.

PA is a calculated value resulting from statistical analyses of data, including EEs, and PP and PE. Therefore, analysis of PP relative to PE will derive measures of PA. Any previously derived ability statistics may be iterative in nature and therefore a changing value as more data becomes available. Facilitation of the determination of PA may also include supplemental data from standardized testing results, inputs, implicit or explicit data points, EEs, or other measures which are then integrated into a compiled figure. A conceptual example of a calculation of PA may include, but not be limited to, a stakeholder exhibiting low effort in an academic area, but performing relatively high from a performance standpoint. Such a stakeholder may be calculated to have a high PA in that particular educational area because they excel with little or relatively lower effort. Similarly, a stakeholder who displays high effort and low relative performance may indicate that said stakeholder has a lower PA. Such a stakeholder may encounter difficulty, cause for concern, or a consistently low ability in that particular discipline because it takes great effort to achieve said lower performance statistics. PA can be specific to a particular branch of academic study, subject, grade level, or as a function of coursework. Such data can be further analyzed to produce stakeholder specific or targeted feedback that may drive and evaluate course load, coursework and/or career direction and selection, identification of stakeholders who may have a need of assistance or intervention, identification of stakeholder strengths and weaknesses, and may ultimately be used to offer predictive and adaptive career guidance and/or recruitment. The evaluation of PA may be facilitated through a direct or indirect assessment of weakness and strength based on the analysis of effort and performance outcomes as compared to targeted PA outcomes which may be further analyzed in relation to other sub elements such as perceived persistence.

While sub measures of these three primary measures will be distinct and unique from one another, their indicators may occur simultaneously and/or overlap based on the context in which they occur. Therefore, it may be possible to derive further sub-measures not outlined below which may not be possible to perceive in the absence of each other. These would be data and related EEs which are more specified or focused in their nature and measurement.

Sub-measures of performance may be described as shorter term, derived, and/or more specified Events which pertain to analysis of performance. Such an analysis may involve factor analysis, derivation of means, and/or the presence or absence of data points as well as correlational analysis.

There might be many variations of such analyses but provided as examples of how to calculate ability and associated measures via the system the following is provided as one possible embodiment of the invention:

Performance
PP=ΣP values)/n*100
PTP=Total perceived performance−PTP=ΣPP all values/n*100

Effort
PE=ΣEc n PosE*100 where
PosE=Possible Effort=the total number of effort values one may possibly attain given a unit or data set of performance values. Ec—Efforts completed=Total number of effort values attained given a unit or data set of performance values need description in patent
TPE=Total Perceived Effort=ΣPE all values/n*100

Ability
PA=(PAr−(PE−100)) where: PAr=((PP+(PP*PE))/10100)*100)
PAu=Perceived Ability Utilized currently using available data=PAr/PA*100 TPA—Total Perceived Ability—a comparison between all of the PA generated within a profile or between that profile and equivalent the equivalent PA for one or more profiles. ΣPA all values/n*100.
   Although there are inherent limitations in the formulaic representations above, the above is provided as an illustration of how PP, and PE can be manipulated to generate PA. Such measures can be adaptive and/or multiple steps in data collection and analysis.

EE data may also be derived from analysis facilitated from data recycled by other main engines. In addition, by the generation of EEs, said system and method also provides a means to evaluate and generate sub measures thereof such as the adaptive measurement of unique features such as Perceived Efficiency, Perceived Effectiveness, Perceived Efficiency, Perceived Proactivity, Perceived Awareness, Perceived Willingness and Engagement, Perceived Aptitude, Perceived Needs, Perceived Weaknesses and Strengths, Perceived Persistence and Interest, Perceived Academic Potential, Non-Core Peripheral Instruction Effect, and the Perceived Educational Philosophy and Approach of any educational stakeholder, by means of adaptive analysis of said EEs. By their nature, the spectrum of analyses is more specific or limited in either scope, time, or implied meaning for any sub categories of the three dimensions of measurement. Sub categories may then be used to derive more specified measures of any of the three dimensions of stakeholder measurement.

The compilation of EEs and their interpretation will provide a means for the adaptive guidance and evaluation of learning, interpretive meaning of educational data, interactions between real and electronic social networks, behaviors, educational practices, professional development, customization of education, and real-time research into educational practices and philosophies for any/all stakeholders.

Said system and method may further analyze such measures in order to determine longitudinal assessment of any stakeholder including, but not limited to, Perceived Trajectory, Perceived Career Aptitudes, Perceived Total Performance, Perceived Total Effort, Perceived Total Ability, and a complete analysis thereof which may allow said system to arrive at a summative rating for any stakeholder. Said system and method may therefore allow for the assistance of stakeholders in their educational pathways and structures, as well as predict Perceived Academic Potential through the comparative use of longitudinal historical analysis of any/all stakeholders and their associated EEs.

Said system and method will include measures of any/all known stakeholders in the evaluation and analysis of a single stakeholder, and will allow for accurately evaluating any stakeholder and determine the impacts one or more other stakeholders may have on PP, PE, or PA of a particular stakeholder. For example, a tutor stakeholder may have involvement in the educational experience of a particular student stakeholder which will allow for specific EEs to be identified, targeted, generated, etc. Said system and method may make provision for collection, tracking, and stakeholder notifications as EEs occur or are approached statistically.

Stakeholders may establish, through a front end interface, customizable behavior or performance trackers which may collect data for informational purposes. In addition, if there is a change in performance as measured by EEs, an impact on the analysis of the approaches involved, behaviors, or interventions that lead up to that event for any stakeholder may be possible, thereby establishing the potential for the generation of further EEs. Therefore, EEs may be able to lead to further EEs.

EEs are continuously analyzed in the Adaptive Educational Data Processing and Evaluation Engine 121 to facilitate the adaptive creation, monitoring, tracking, and processing of any event of statistical significance. Said system and method will process, aggregate, and normalize, such data to a category or sub category of EEs which are assigned to one or more educational stakeholder profiles. The quantification, qualification, and then the assignment of anticipatory EEs and data sets which may lead to EE resolution may then be identified and assigned to a stakeholder profile thereby allowing an educational stakeholder to evaluate other stakeholders with a level of statistical detail which has not previously been possible as well as to view developing EE statistics and trends through an interactive application or display. EE capture and the assignment of statistical impact may be facilitated via electronic devices, mobile, tablet, wearable, audio, video, world-wide-web, and electronic human interface based devices. Such integration may allow for unprecedented fusion of the measurement of traditional educational data and behaviors which occur both in and out of the classroom and in electronic environments.

EEs are created through the analysis of all data, including new information converted to data, new data, existing data and EEs. All data is assigned to one or more user profile(s). Data includes but is not limited to, grades, coursework, coursework and assignment difficulty, extracurricular activities, implicit and explicit behaviors, course and/or labor agreements, personal, interpersonal and electronic interactions, collaborative interactions, standardized test data, demographic data, use of 3rd party tools and applications, standards, trends, known needs and deficiencies, apparent needs and deficiencies, socioeconomic status, formative/summative testing data for a single stakeholder or group of stakeholders, attendance, delinquencies, time spent on tasks, subjective feedback, contributions to tasks, task accuracy, material of importance, time spent on tasks, percentages of work contributed to a task, inputs or data captured from educational tools or derived EEs, behavioral data collected and interpreted as received from imaging, audio, Global Positioning Systems, or triangulation technologies, analysis of statistical certainty of any event or data analyzed, inter-stakeholder communications and associated data, reprocessing and re-evaluation of past EEs. The complete analysis of such data may allow for the generation, resolution, interpretation, and analysis of EEs. Data capture may also be facilitated from educationally appropriate proxies associated with institutional networks.

The Adaptive Educational Data Processing and Evaluation Engine 121 receives stakeholder data for analysis, normalizes at least some of the data, and evaluates said data qualitatively and quantitatively. The Adaptive Educational Data Processing and Evaluation Engine 121 will also assist in establishing the conditions necessary to balance or resolve an EE, or events, in order to resolve, continue, monitor, or generate further events as described in FIGS. 1-19.

The Adaptive Educational Data Processing and Evaluation Engine 121 analyzes performance data, effort data and profile data which are quantified and qualified. The Adaptive Educational Data Processing and Evaluation Engine 121 also analyzes the data for a Jigsaw profile (a Jigsaw Ghost). The Adaptive Educational Data Processing and Evaluation Engine 121 adaptively determines relative or absolute thresholds for typical or atypical benchmarks, predicts and supplies information as to which outcomes will lead to the best EE generation, resolution, fastest attainment of statistical parity, Event escalation, and/or continuation.

Any of the sub-engines may be used to further categorize, prioritize, quantify, and qualify data, and normalize data, for the eventual generation of EEs and then feed the data to any other sub engine as needed or relevant to that engine. Pertaining to data processing in said engine, as new data arrives, said system will reference existing stakeholder data, relevant educational proximity, and a historical database at which point said data will pass through an adaptive correlation and analysis of measures and sub measures of performance, effort, and ability in order to determine the potential or actual statistical use and/or impact said data may have. Said system and method will then adaptively render the most likely and relevant potential uses of such data points in the EE generation engine via a complete inter-stakeholder analysis. Absolute values, means, standard deviations, norms, and averages by which stakeholder profiles are to be analyzed when executing comparisons and calculations will be referenced, generated, or facilitated. This initial analysis will be the first and primary place where preparatory and anticipatory aggregation of data takes place according to rules and predetermined thresholds, or possibly by relative associations between data. Data received may also be assessed for levels of significance and effect size.

The Adaptive Educational Data Processing and Evaluation Engine 121, including the sub-engines, generates an EE if thresholds and rule sets dictate that statistical criteria are breached or satisfied (see FIG. 3), and that impacts are of practical or statistical significance, and assigns said EE and its statistical impacts to relevant stakeholder profiles contained within the Common Educational Identity Engine 120. Generation of an EE can influence the measurement of, the ratings of, and evaluation of stakeholders. If an event is determined to have a level of significance either within a particular category, or for a particular stakeholder and their associated analysis, it will be correlated with other known or potential EEs of similar nature, or categories for further processing or the assignment of an EE. Upon the completion of said analysis, the results of the analysis will be fed for proofing of data sets which may have potential for the generation of alternate EEs.

Upon the generation or assignment of an EE, dynamic system “awareness” may be engaged whereby the invention begins to raise or decrease levels of systemic “alertness” and “concern” pertaining to the current state of a particular stakeholder. This will be based mainly on the measure/countermeasure model of EE generation where stakeholders are not only compared to performance thresholds but also in reference to each other. This will impact how and when the invention initiates communication with a particular educational stakeholder through the Stakeholder Reporting and Comparative Analytics Engine 127 to assist stakeholders in understanding the data they are viewing and help determine if there is cause for concern and/or action. If there is further need for analytic evaluation, or for more detailed processing, the Stakeholder Reporting and Comparative Analytics Engine 127 and any sub-engine 124-126 will accept data sets back from any engine to the Adaptive Educational Data, Processing, and Evaluation Engine and tagged with any feedback that was generated, in order to guide more accurate assignment, correlation, or aggregation. Such an analysis may result in the recommendation for alternate EEs that are possible to escalate, or resolve current, future, or past data sets. Subsets of data could be fed back to the Adaptive Educational Data Processing and Evaluation Engine if the system recognizes that an EE generated may relate the generation or resolution of EEs which already exist. Therefore data 107,108,111,122 will loop between the Common Educational Identity Engine 121, the Stakeholder Reporting and Comparative Analytics Engine 127, and the Adaptive Educational Data Processing and Evaluation Engine and associated sub-Engines 121, 124, 125, 126.

In addition to the presence or occurrence of data points being used to evaluate stakeholders, the absence of a data point or EE can also be used to generate further EEs. Such EEs may be quantified by the analysis of data pertaining to EE assignment when both the occurrence and the lack of occurrence of EEs may be counted in the assessment of an educational stakeholder, quantified, and qualified in order to more accurately measure and assess stakeholder behaviors and/or lack thereof. If a stakeholder does not successfully execute a behavior, respond to, proactively engage, or intervene in response to an EE, that lack of response could be evaluated as an EE of significance which has a statistical impact. Examples could include, but not be limited to, if a stakeholder such as a parent or teacher being notified or confirmed to be aware of a student stakeholder being in need of academic intervention, or of the current academic state of a stakeholder, but said stakeholder not acting or not acting in a timely or appropriate way, the system could apply the lack of such measures as negative values to the assessment of a stakeholder. Another example could include, but not be limited to, the failure of a student stakeholder to respond to or act on incentives or efforts made by educational stakeholders aimed at assisting them in their academic struggles, such as extra help or tutoring.

The absence of an EE can be used as a partial measure of effort and could be used to justify the inclusion or exclusion of the measurement of a stakeholder in the evaluation of another stakeholder, such as a teacher. For example, it may be possible to normalize measurement of educational stakeholders by facilitating the elimination of data pertinent to any stakeholder whose connections generated data, yet another stakeholder was unengaged or uninvolved in the educational process. As another example, it would be possible to exclude data from any student unengaged and not present frequently from the evaluation of a teacher, or to set thresholds of effort and engagement for inclusion of that data in evaluation. Such a method would allow educational stakeholders to be evaluated based on their interactions with engaged individuals or individuals determined to meet a minimum level of engagement in the educational process.

EE pattern analysis and recognition may be facilitated by the establishment of links and patterns for any EE or group of EEs by analyzing events, inputs, and/or outputs of stakeholders, and then evaluating correlations, trends, and patterns between stakeholders and within a stakeholder's profile in order to derive whether or not an event or events have relational significance, or can be assimilated and aggregated into statistical analysis.

The invention therefore facilitates the tracking and generation of performance markers and thresholds for one or more stakeholders based on educator, institutional, or governmental standards and might be processed through the Adaptive Educational Data Processing and Evaluation Engine 121. The collection, qualification, correlation, and quantification of both objective and subjective data on either a scale of absolute values and thresholds, or an adaptive and dynamic scale through the establishment of baselines and norms as identified for typical stakeholder data in relation to known or similar stakeholders as related to EEs will be facilitated as described in FIGS. 9 and 10. Furthermore, the analyzing of typical oscillations and ranges in performance, and the analysis of deviations from means can be used to differentiate between EEs of concern, and those that are not of concern. For example, one EE may hold great statistical significance for a stakeholder, but may hold little or no significance relative to another stakeholder, dependent upon data analysis relative to the profile of each stakeholder and its associated data. Comparison of such data collected from any/all stakeholders can be applied to a single stakeholder, or group of stakeholders. An example could include, but not be limited to, the establishment of typical response times for an EE-based on the data analyzed from all stakeholders or stakeholders of similar demographic or profile who have already logged the same or similar EEs. Such data could be analyzed for the purpose of gauging EEs generated by past and present stakeholders, within the context of similar interactions and then determine if response time for a single stakeholder is qualified to be labeled an EE. The same data sets and points could therefore generate an EE for one stakeholder, but not for another depending upon their norms.

EE resolution may be adaptively executed by the Adaptive Educational Data Processing and Evaluation Engine 121 when an EE of statistical significance has been logged and tracked, said system and method then adaptively anticipates and predicts which conditions would be necessary for the resolution, continuation, or escalation of said event. Then, in addition to discrete and definitive events, the invention automatically adjusts EEs as resolved or continued if certain statistical developments result in what would constitute an effective resolution of said event. In other words, certain occurrences or EEs may serve to adaptively resolve existing EEs associated with a user profile. It is also possible that a series of EEs may lead to statistically significant changes in data associated with a stakeholder possibly resulting in an EE being automatically resolved. If there is no change in stakeholder measures or there is the development of further EEs of concern, said EE will be considered unresolved or will be continued or escalated in level. Continuation of an event results in a systemic “waiting” for data which will meet the criterion of resolution. Escalation may lead to further events associated with said event, thereby making it necessary to resolve more than one event related to a particular educational state or may result in a transformation of one EE into another of a greater level of impact or concern.

Recurrent post-event analyses may iterate to monitor existing EEs and their relation to new EEs. Events previously generated can be reevaluated based on new data as it is captured including, but not limited to, a continued event, a new event generated, an escalation of an event or an event resolved. Furthermore, new events will enter a state whereby the resolution conditions and data sets are determined and said system awaits the arrival of the anticipated data in order to satisfy the resolution of an event. In order to avoid “hanging” or “never ending” Events it is possible that if a stakeholder comes close to generating data which approximates the resolution of an EE, but does not technically meet the statistical conditions, the invention may either adaptively approve its resolution, or consider said event resolved upon the completion of a certain time frame or other event. As such, conditions for the resolution of an EE may be dynamically and adaptively derived, or may be absolute in terms of the values necessary for satisfaction of Event resolution criterion. Absolute event occurrences may also resolve preexisting events, for example if the school year ends, open EEs may be resolved. All EEs will integrate with stakeholder Jigsaw Profiles, Jigsaw Ghost profiles, and/or data captured in the educational setting may be integrated with an application that features messaging trough the Stakeholder Reporting and Comparative Analytics engine 127 in order to raise awareness of EEs. Additionally the invention may derive that a particular stakeholder likely has knowledge of that stakeholder's current state, and may communicate possible actions/conditions necessary to resolve or generate related or said events. The invention will adaptively apply rules, limits and thresholds to data flows and data to facilitate the generation and analysis of EEs.

The Adaptive Educational Data Processing and Evaluation Engine 121 determines resolutions to EEs. For example, in any measure attaining statistical parity where it can be said that a comparison of, for example, the effort between two individuals of differing proximities is the same, there may be a threshold which allows the resolution of a particular Event (FIG. 3). The attainment of statistical parity is therefore defined as the satisfaction of a term(s) of the “measure/countermeasure” model which makes statistical comparisons between stakeholders. Said model assumes every EE, whether positive or negative in context, has a contrasting EE which creates statistical balance. According to this model, every measure of a stakeholder shall be associated with either a corresponding countermeasure or group of countermeasures that establish potential statistical parity. Through the application of such measures and the statistical balancing by associated countermeasures, each EEs or group of EEs may have a counter EE or group of EEs. This establishes the potential for true statistical comparison between or within stakeholder profiles, and establishes true potential parity by default. The generation of an EE or event cluster of equivalent or similar oppositional weight may satisfy the measure/countermeasure model by statistically balancing a particular EE of a known topic, level, or other variable of consideration. By establishing a measure/countermeasure model, said system and method allows for the determination or derivation of a definition of parity between stakeholders in any given measure. Conditions for the resolution of an EE may be fixed or set dynamically and adaptively. Incoming data which may apply to the resolution of currently existing EEs may be applied to stakeholder profiles for that particular EE as a means of measuring the oscillations of stakeholder data and determining where a potential balance may be. Although balance may be possible, it may not be a place where stakeholder data remains stagnant. Rather, stakeholder data may move back and forth across that established line of parity and only generate an educational event when predefined statistical thresholds are reached.

Two stakeholders may generate data which is in a state of dynamic equilibrium. A method which establishes Default Parity and Equilibrium Rules and Thresholds fosters the monitoring and establishment of real or potential statistical parity, and/or parity-based thresholds based on available data, and utilizes EEs as a means of doing so, thereby allowing deviation from parity without necessarily generating an EE. It will also provide a means of generating expected data for Jigsaw and Jigsaw Ghost profiles. Default parity protocols may also serve as a vehicle for Event generation and resolution by assigning a counter measure to every statistical measure that is analyzed. Once the boundary of parity has been established, data captured, and/or manually established rules can be used to determine the range of normal deviation from any measure. Upon the establishment of parity and normal deviation/fluctuation statistics, it is then possible to establish the boundary at which point an EE can be generated and/or resolved. Systemic awareness may be heightened or lowered to indicate the need for stakeholder alerts and communications to be generated as said thresholds are attained or approached. A significant difference from normal stakeholder values may be in either a positive or negative statistical direction in reference to comparative analysis of stakeholders.

When data is not available, the Adaptive Educational Data Processing and Evaluation Engine 121 begins the rated interactions of all parties at statistical parity and then captures data relating to any stakeholder and seeks to determine how incoming data relates to the balancing of measures of performance, effort, and/or ability. The measure/countermeasure model assumes “potential statistical balance”. When such data is analyzed in reference to the historical data of any stakeholder, Adaptive Educational Data Processing and Evaluation Engine 121 is able to eliminate or reduce the need for stakeholders to attempt to determine if data associated with a profile is of concern or not. If said data is consistent with historical data, then statistical significance may not be reached, and therefore the Adaptive Educational Data Processing and Evaluation Engine 121 may reduce communications and awareness of a situation. Such a model may be applied to any/all EE measures related to any stakeholder or group of stakeholders.

Therefore, for any analysis ultimately used to calculate performance, effort, or ability, each stakeholder will have an equal statistical opportunity to achieve parity with any/all other related stakeholders they are linked and compared to.

Related to the Measure/Countermeasure model, Dynamic System Awareness, herein referred to as “DSA”, shall be defined as a series of Events which increase systemic allocation of actions and resources as a result of deviation from a statistical norm associated with an EE for any stakeholder. The occurrence of, approach to, or deviation from an EE may increase system awareness. Systemic attention can be defined or understood as the perceived need to execute communications with stakeholders and/or to facilitate the generation of guidance, alerts, or the communication of meaning associated with certain data sets as well as the dynamic application of associated EE impacts. When the awareness level is “low” the invention will perceive no statistical reason to alert any stakeholder of an impending or current Event if that Event or data point is consistent with norms for a particular stakeholder. This may apply to stakeholders who consistently behave or perform at certain levels. For example, a student stakeholder who always performs in a failing or average range may generate no alert due to their consistent, low performance. If that same occurrence were to happen in a high achieving student's profile it might potentially increase or decrease system awareness. Said system might be in a state of decreased awareness if new data is within parameters consistent with said performance levels. Only when a further deviation in either a positive or negative direction occurs would the invention communicate with stakeholders.

Similarly, said system awareness can be triggered by a specific EE, or statistical deviation from a typical value or trend of any measure of any stakeholder. The “awareness” level of the system is adjusted, and “sensitivity” of the system to the development of any new stakeholder data points may depend upon if they are applicable to data points which may establish Event resolution or Event generation, across a positive or negative threshold. It is possible that subsequent EEs may also hold more value if their potential occurrence holds greater value to stakeholder outcomes. When a stakeholder generates an EE of significance, the Adaptive Educational Data Processing and Evaluation Engine 121 assigns and places prominence on any subsequent events and will actively communicate progress between stakeholders. DSA will register and analyze EEs of high significance and/or issue suggestions to stakeholders for the most effective means of event generation, avoidance, and/or resolution. When the awareness level is increased to a certain point, the Stakeholder Reporting and Comparative Analytics Engine 127 may communicate with the stakeholder through application displays or messages, effectively keeping the current or potential academic state of a stakeholder at the forefront of their consciousness. The Stakeholder Reporting and Comparative Analytics Engine 127 is simultaneously applying adaptive measures to stakeholder responses in reference to their perceived awareness.

Events which the system is able to determine are chronically certain, recurrent, or sustained in nature can result in decreased systemic awareness by allowing the system to consider such occurrences to be average, typical, or standard for that stakeholder as the consistency of such data is established. It could then be dynamically throttled down or up depending upon subsequent data.

Thresholds are used to determine if events are to be considered chronic or an attempt to dishonestly generate EEs. For example, repeated attempts within a short period of time to contact a student, parent, administrator, or other stakeholder without said student or parent responding in a meaningful or effective way may occur with great consistency and therefore generate an event which instructs the system and method to consider such occurrences as non-events, or may possibly adjust the threshold necessary to trigger one. Such an instance might assign a lower awareness level to the current state of said parent or student stakeholder, and therefore not assign penalizing events to a profile of a teacher who then disengages from repeated attempts to contact said parent or student.

As an additional example, a student who rarely or never completes homework may be considered to have a chronic event and the system will not repeatedly alarm a teacher stakeholder once all thresholds or advisable means of intervention are implemented. In fact, the remediation of a student or increased efforts could possibly constitute new events that have potential to bring a stakeholder out of a chronic state, thereby increasing system awareness and initiating interpretations and communications to related stakeholders. DSA may also assist educator stakeholders in ascertaining the common trends incoming data from a student or parent stakeholder when they have limited information on a stakeholder. Examples might include but not be limited to a new relationship formed at the beginning of a year or quarter, or a newly formed tutoring relationship. This will assist stakeholders in knowing if there are events of concern developing, or if the events occurring are typical for these profiles.

Adaptive Calculations and Weighting Protocols may engage when one or more EEs occur related to an event that is registered by DSA processing. Said measure may apply adjusted weighting to subsequent EEs as they are applied to any stakeholder. Said measure derives a means to establish and monitor the norms of a particular stakeholder. These means are derived regardless of their current academic state, grouping, or level. The norms the stakeholder has produced in their past are used as a means of issuing incentive to improve one's condition by notifying a stakeholder of an increased value that will be applied to their profile upon attaining a particular EE. This may apply more weight to resulting subsequent efforts of a positive nature thereby accelerating statistical improvements if a stakeholder demonstrates Willingness and Engagement.

For this reason, it may be possible for stakeholders of authority, such as a teacher, to assist other stakeholders, such as students or parents, by embedding statistical rewards in an effort to encourage positive behaviors and EE generation, and the resulting presence or absence of responses may hold more value in the evaluation of the stakeholders involved.

Adaptive calculations and weighting will also allow for greater depth of measurement of how effective a stakeholder is at utilizing incentive and encouragement or whether a particular stakeholder has played an instrumental role in shifting a given stakeholder out of their typical statistical ranges in either a positive or negative direction. Therefore, when EEs of significance cause stakeholder performance measures to deviate significantly from user averages, or globally assessed stakeholder averages, there may be an assignment of special statistical value to a stakeholder who had said student stakeholder under their academic care at that time. Communications and associated data will be critical in tracking the progress of said approach. As another example, if a student drops or increases a certain percentage from the typical grade range of that user, or enters into absolute ranges such as thresholds for passing or failing, etc., the system may increase the attention given to all relevant stakeholders and apply more weight to subsequent events related to each stakeholder and the occurrence or lack thereof of particular events ultimately applying such measures to impacts assigned to individual profiles as appropriate. Such a system and method may therefore allow for more accurate analysis of which interventions and time frames are most effective for a particular stakeholder or group of stakeholders. The next EE of statistical significance, or elapsed time threshold, or certain numbers of EEs that occur from that point on may serve as statistical markers of progress or regression.

It is also possible that through the use of adaptive and manual impacts, a user can influence the impact of an EE on stakeholder measurement by manually indicating which events will bring about satisfaction of a requirement or resolution of an event, and whether or not there are events stakeholders are permitted to assign more or less value to. Compliance, or an improvement in the performance of the stakeholder, will allow limited increased or decreased impact on the calculations assigned to those EEs. EE Triggers and thresholds could be manually adjusted and customizable by users depending upon their profile roles, as thresholds for data points related to EE generation, data management, and stakeholder communications. For example, an educator stakeholder might set a threshold for a student stakeholder to meet in order to generate an EE of significant, increased, or decreased impact. Rules governing the ability of stakeholders to do so and to what degree such measures would be possible, would be dependent upon the role of each stakeholder in relation to another or in relation to educational proximity.

Further analysis of data can be conducted by the Adaptive Educational Data Processing and Evaluation Engine 121 in comparison to known data points in an effort to determine if certain events are more typical of the demographic relevant to a particular stakeholder, or whether the statistical changes that a stakeholder is experiencing are uniquely related to his or her relationship with other stakeholders because they are unlikely to have occurred by chance. EEs that are of higher or lower level or impact will have greater or lesser impact on statistical outcomes as well as systemic responses and alerts to stakeholders. Outputs from such adaptive analysis could then guide academic and collaborative decision making, facilitate and inform self-monitoring, direct and enhance planning, facilitate educational business practice and connections, assist in defense or critique of practice, identify stakeholders of interest or proximity, academic or geographical areas, or events of concern, thereby resulting in highly accurate assessment of stakeholders which includes the real-time integration of classroom data of any and all other stakeholders.

Perceived Statistical Certainty is related to PP and PE and/or a group of EEs and is defined as the degree to which an EE, EE cluster, or EE sequence and their impact may be relied upon as a true representation of the measures being detected at a given point in time in reference to stakeholder profiles. Perceived Statistical Certainty may be viewed as a scale or index which communicates the reliability of data as representing what is typical for a stakeholder. Such a measure would, by necessity, include analysis of EEs in reference to time, frequency, typicality, and the number of EEs which share common statistical significance or correlation. An example would include, but not be limited to, an analysis of a student stakeholder receiving a failing grade at the beginning of a marking period and the determination that said grade has a lower statistical certainty than a failing grade later in the quarter because of the number of grades, frequency of grades received, typical grades received. Likewise, EEs generated later in the term of a course or year may have greater certainty than those generated earlier. Such comparisons can be for isolated periods of time, disciplines, or across years/semesters/quarters in order to ascertain general consistency with past trends.

The number of different or associated data points accumulated would be influential on the perceived certainty and/or validity of a particular measure. The existence of multiple EEs of similar statistical categorization may also have an effect on the Adaptive Educational Data Processing and Evaluation Engine's 121 interpretations of data and associated recommendations for stakeholders. Examples would include, but not be limited to, a period of time in the beginning of a quarter or year accompanying the occurrence of a failing grade in tandem with the occurrence of missing homework assignments. In such a situation, there would be a greater statistical certainty than the isolated occurrence of a failing grade in the absence of missing assignments. Likewise, the occurrence of poor performance in multiple disciplines and classes will have greater statistical certainty for data related to a new class or new data which also indicates poor performance.

Historical analysis may also help a stakeholder determine certainty if the stakeholder of reference is logging data consistent with their past. For example, a student who consistently performs well and receives incoming EEs may possess a greater comparative statistical certainty if said stakeholder's present performance is similar to their past performance. Perceived statistical certainty provides a means for stakeholders to detect or request data related to the reliability of statistics they are viewing for themselves or another stakeholder, and for said system and method to derive appropriate interpretations. It also provides a basis for the guidance of stakeholder professional development, guidance, and monitoring. As another example, based upon the number of entries, or the time in a quarter or semester, the Adaptive Educational Data Processing and Evaluation Engine 121 may reduce the occurrence of statistical exaggeration which may be inherent in EE generation, or inform stakeholders of the potential that the grades they are viewing are either abnormal or exaggerated.

Perceived effectiveness, herein referred to as “PEf”, evaluates Event outcomes and frequencies in relation to the duration of said stakeholders' educational relationships. It includes dynamic and adaptive analysis of the interactions between two or more stakeholders, in relation to an adaptive statistical evaluation of the frequency, duration, outputs, and outcomes of stakeholder data and interactions as analyzed in comparison to relevant stakeholder performance, effort, and ability statistics. Such a measure may be executed within the context of isolated periods of time. PEf acts as a measure of the ability of a stakeholder to cause or have a significant impact on educational outcomes which effect statistically significant changes for themselves or other stakeholders. Such a measure may be able to predict the chance that a particular stakeholder is able to effect change in another and to what degree. The invention facilitates a comparison of the interactions between two or more stakeholders in the context of changes in statistical norms for PP, PE, and PA associated with the profile of another stakeholder over a period of time, as well as the subsequent analysis and possible assignment of cause to an educational stakeholder for said change. Changes in data of statistical significance which are captured and exhibit EEs in a positive or negative direction may be assigned to a proximal stakeholder as having played a role in said change if cause can be established. The magnitude, duration of time, or level of frequency of such change may impact the perceived effectiveness said stakeholder may be viewed to be.

An example of the potential impact of one stakeholder's behavior on another stakeholder might include, but not be limited to, a student stakeholder having high educational Proximity to a science teacher, an English teacher, and a Physical Education teacher as defined by their proximity definitions. Said English teacher may be determined to have a high level of effectiveness in improving a particular student stakeholder's outcomes. Said effectiveness in changes to performance in English would not necessarily be assigned to all stakeholders who have the student at that time. In fact, only those stakeholders who interact with the student stakeholder as it pertains to the English class could be considered to have an impact on the student and therefore be eligible to have an effectiveness impact. However, a value or EE which has capacity for generalization may allow for said English teacher to have a positive effect on a particular measure in another subject. The invention would therefore be able to detect the overall effect that each stakeholder has on the educational experience of a particular stakeholder or group of stakeholders in multiple domains. Another example might include, but not be limited to, tutors who are associated with a particular stakeholder on a limited basis, such as assisting in academic issues for a particular English class. At the point of the formation of a relationship between said tutor and a relevant stakeholder, subsequent interactions between stakeholders and subsequent EEs and data points would be used to establish the PEf of said tutor.

Another example might also be the application of such measurements to paraprofessionals and special education stakeholders as a part of a measure of statistical impact they influence in the classroom setting. Educational proximity data and data related to connections could be leveraged to determine if there was a significant change in any level of performance, effort, or ability for a stakeholder or group of stakeholders during the time of the associated contact. Data comparisons could be facilitated, for example, between typical data for a teacher stakeholder and typical data when another educational professional is present in their room, while also accounting for and normalizing confounding measures that may be associated with more typically low functioning student stakeholders, etc. For example, statistical analysis could be facilitated for student performance when a student teacher or paraprofessional is working with a teacher or student and therefore may have an impact on student stakeholder's educational data. Said system and method may analyze all data from before, during, and after contact to derive patterns. Such an approach may allow for the elimination of outliers, and/or normalization of data based on effort and/or ability in order to reduce inaccuracies in the evaluation of any stakeholder. Such statistical impacts detected may be positive or negative in nature, and said analysis could be applied to any educational stakeholder profile to assist in the generation of EEs or EE analysis. The more statistically pronounced such changes are to student data at the time of the educational relationship with said co-teacher or paraprofessional, the more statistically valid, and/or efficient a stakeholder will be perceived to be in generating an impact on stakeholders and therefor the higher the PEf of such a stakeholder. Said system and method may consider efficiency and effectiveness as statistically intertwined and related during calculations and analysis.

Educational stakeholders such as student teachers or business professionals, for example, might also use such data to advertise their efficiency and their PEf with respect to improving stakeholder performance and therefore provide reasons for another stakeholder to make use of said stakeholder's services. As another example, a baseline of statistical norms at the beginning of an educational relationship could, or may already, be established which could include past academic data analysis either in the other/historical classes or within the stakeholder's current class up to a certain point in time. During the course of newly established educational proximities and interactions, subsequent data points might be collected as they pertain to EEs of performance, effort, and ability, during a period of time, or at the conclusion of the proximal relationship to thereby determine the accomplishment of goals, evaluate changes in data, and/or predicted EE outcomes. Examples include, but would not be limited to; a teacher stakeholder causing a significant statistical change in a positive direction for the duration of a profile relationship with a student, or group of student stakeholders, as compared to previous stakeholder interactions that have a similar nature, subject matter, or profile proximity. Said teacher stakeholder would be considered to have a high PEf in comparison to that student or that group of students if they were able to effect a statistical change that is not typical for said student stakeholders.

As another example, a comparison between a teacher stakeholder and a student stakeholder may reveal relatively fast responses to academic concerns on the part of the teacher, and a tendency of stakeholders of concern to respond in a way that is statistically significant in a positive direction within a relatively short period of time. Such a stakeholder would be considered to have a high PEf rating and be considered highly efficient regardless of a change in student performance or effort because of the statistical data indicating that he/she appears to generate. Normalization for such a measure could be accomplished by accounting for effort and ability of any stakeholder. Such a stakeholder can effect statistical change for stakeholders they influence or who are under their academic care, or may generate an equivalent measure because of their willingness to demonstrate fidelity and engagement in the progress of stakeholders under their care. Comparisons could be inter-stakeholder in their nature, or could be for summative groups of stakeholders.

Perceived Efficiency, herein referred to as “PEff”, is defined as Events related to the creation and/or avoidance of EEs as a function of time in relation to the number of occurrences/attempts. A stakeholder who requires low amounts of time, or relatively infrequent attempts to effect an EE, a high PEf, Event resolution, or influences Event creation for either themselves or for another stakeholder in a positive context would be considered to have a high level of PEff. Likewise, stakeholders who attempt multiple approaches, require many attempts, or require a long amount of time to create or avoid said conditions for either themselves or another stakeholder would have a low PEff rating. Accommodations for the effort and ability of the stakeholders within the proximity of the stakeholder of reference would allow for normalization of data.

The perceived “need,” herein referred to as “PN”, is defined as Events related to short term and/or longitudinal measure of the educationally related deficiencies of a stakeholder in relation to PP, PE, and/or PA. Event or absolute thresholds and/or standards. Such needs are derived from measures or sub measures of PP, PE, and PA. PN can be derived from clusters of aggregated and/or correlated data points. In one example, a student stakeholder may demonstrate a high effort, but a low performance in a language class (i.e., low PA). If such a stakeholder were demonstrating an ability to compensate for their low PA they may not be considered to have a high level of PN in that area since they are able to demonstrate minimal competency or an ability to compensate for their difficulty. However, if given the same circumstance, said student stakeholder were not currently passing said class, a perceived need value may be very high, and an EE generated. Perceived need may also be calculated based on a need to attain a threshold or certain EE. For example, given the same circumstance above, a student stakeholder may also need to pass said class in order to receive a degree, resulting in a varying magnitude of PN escalation. Likewise, similar approaches could be applied to professional development as well through the establishment of relative weakness within the practice of a particular stakeholder. This would be helpful in the establishment of goals.

Perceived trajectory, herein referred to as “PT”, is defined as Events related to an analytical comparison between known academic and career outcomes to currently developing user profile trends, outcomes, and developing outcomes, and the subsequent formation of statistical extrapolations. PT refers to a comparison of actual stakeholder outcomes to current stakeholder EEs, data, and trends, and may be used to assist in guiding a stakeholder in their coursework, career choices, or in determining which set or sequence of EEs is most effective given their current academic state. Said extrapolations may form ranges of predictions for academic success, choices, aptitudes, and possible outcomes. PT may include derived predictions of college, graduate, or career levels of success, and aptitude may be based on summative evaluation of EEs, their typical outcomes, and assessment of accumulated k-12 stakeholder data as well as undergraduate, graduate, and standardized test data for any stakeholder. Said data may be compiled using data from any stakeholder or groups of stakeholders to facilitate suggestions for or predictions of professional PT or PT in reference to likely success. Such data may be applied to a profile in order to communicate the interpreted meaning of educationally related developments in data.

“Perceived Total performance”, herein referred to as “PTP” is a measure which is defined as Events related to the sum evaluation of all statistics related to an educational stakeholder over the lifetime of their profile. Said measure provides a way to more accurately assess the culmination of a stakeholder's PP data, and/or professional PP of an individual by including not only subjective assessment, but longitudinal data inclusive of key details of stakeholder historical data, demographics, and PTs spanning their entire educational career. Allowances may be made where an administrator stakeholder or other appropriate stakeholder of authority might indicate when another stakeholder has sustained traumatic or extremely stressful life events. Such life events could be assigned values or symbols, and then allow for the adjustment or exclusion of data associated with a certain period of time. For example, if a student experienced the death of a parent in the 8th grade, an administrator stakeholder may be able to indicate this in said system and method. Said system and method might then apply and indicator to data on that student profile only viewable within a certain educational proximity, or may apply either a short term, or longitudinal devaluation of certain data points and events because they may not represent an accurate portrayal of said student stakeholder typical data. Such statistical adjustments may be automated and may exist within fixed time frames, so that, for example, said stressful event would not allow for the lifelong adjustment of PTP data. If enough longitudinal data were available, said system and method might also be able to entirely eliminate a fixed period of time from PTP values.

PE is comprised of a variety of Event measures that pertain to the presence or absence of any educationally related behaviors, real or electronic, which may be aggregated, correlated, quantified, and qualified in order to facilitate the numerical evaluation of educational stakeholder behaviors, or the lack thereof. The invention includes automated and/or manual capture and tracking of the behaviors/information a stakeholder engages in during educational processes or for the tracking of behaviors a stakeholder does not actually engage in yet would be anticipated. Such information is captured and converted and is ultimately related to PP and associated sub-measures.

Examples include, but are not limited to, electronic and manual communications, video-based data, audio-based data, both of which may or may not be cloaked to protect stakeholder privacy, data derived from imaging, global positioning systems, or devices that rely on triangulation, stakeholder record keeping, the absence of a behavior, in-class behaviors, performance and/or behaviors captured through handheld electronic devices, compliance with requirements, participation as gauged by the behavior displayed in the educational setting (raising of hands, movement within a seat, head position, movement around the room, voice recognition and analysis, etc.), and the presence or absence of behavioral responses to EEs. All of this information could be collected as audio/video files which could be stored in the invention or alternatively, the invention could immediately convert this information into data without any storage of video file(s) in order to ensure protection of stakeholder privacy. All related behavioral data may be analyzed in reference to the Perceived Awareness of a stakeholder in reference to their current status.

Examples are numerous, but one might be in a classroom setting as follows: baseline data could be loaded that incorporates derived baselines for either students of a certain level, age, or of a particular school or district, or of that particular class in to facilitate comparison for classroom behaviors. A teacher who is engaging in questioning (FIG. 13) in the classroom may select or vocally indicate to said system “questioning” via an application, or said function may be automated. Upon engaging that portion of the application, said application would use imaging and audio technology to determine the number of times a student raised their hand, or the amount of time they spent working on a questioning task, or the level and nature of activity during that session. Such data could be processed and fully integrated with a stakeholder profile.

In addition, the absence of hand raising, refusal to engage the class or teacher, or lack of participation in the questioning event could be captured and integrated with the stakeholder profile as a numerical value even though said behaviors are non-existent. This will be possible because said system and method will generate anticipated behaviors and responses or response types given a particular setting, and attempt to determine if they occurred and what was typical for that class. The lack of occurrence, or the occurrence of inappropriate behaviors, may generate an EE. An educator may also make use of gestures or devices that facilitate the confirmation of interpreted events. For example, the ability of a teacher stakeholder to make a hand gesture to credit “student 17” with answering a question, or to point a device at a stakeholder which can log the type of interaction to the appropriate stakeholder profile, or the confirmation of a student stakeholder's video-based behaviors in reference to audio behaviors and sequencing. Additionally, stakeholders may be able to assign avatars to their profile, which are displayed on a visual device and shows actions they are engaged in, such as hand raising.

As another example, communications and the sequencing of audio, electronic, and video based data, as well as considerations for tone can be used to derive calculations of effort (FIGS. 12A and 12B, 13, 14). If a teacher stakeholder placed phone calls or emails as an attempt to reach out to a parent stakeholder and those communications were or were not replied to by a parent or student stakeholder, effort events could be logged on both sides, which may be used to derive relative effort. This could also apply to video and in-person conferencing.

Said system and method may utilize measures of effort and behavioral Events and related data as a means to provide data to professionals in educational or mental health fields, or who may wish to use said data to evaluate a stakeholder for potential diagnoses or for consideration for the receipt of intervention services. For example, an educator stakeholder might select to evaluate in class impulsiveness and assign a data point to a particular student every time they get up out of their chair, or said system and method could be used to compare said student to his/her peers and associated baselines in terms of physical activity, and such data be communicated to professionals wishing to study behavior. Said data could, for the first time, be accumulated without the need for such professionals to be present in the room, and therefore, would eliminate possible “acting” by stakeholders who are aware they are being watched. During this process, stakeholders may be identified by audio and/or video recognition software and hardware that may or may not integrate with 3rd party hardware and/or software.

Captured data may be applied to profiles either anonymously through identity concealment, or definitively by allowing identifying features associated with said data to be attached to stakeholder profiles and viewable based on educational proximity.

### Sub-Measures of Effort

Perceived Awareness, herein referred to as “PAw” is defined as Events related to the quantification and gauging of a stakeholder's awareness of current and historical academic state and apply quantification to said measures. Perceived awareness measures the likelihood that a stakeholder knows their specific or general state with respect to performance, effort, and/or ability and/or whether they have an adequate knowledge of items which are necessary to address in some way. PAw is claimed to be a measure of a stakeholder's perceived knowledge and/or awareness of any EE or data point which has material or practical significance to that stakeholder from an educational standpoint.

PAw indicates that a particular stakeholder has viewed, been informed of, or is otherwise definitively determined to have a likelihood of being aware of their current and/or past performance, and/or their general academic condition for either themselves, or for stakeholders under their proximal care. Examples might include, but not be limited to, a student stakeholder being aware of his/her own academic state, or a parent stakeholder being aware of the academic state of his/her own child. Other examples could be administrative stakeholder awareness of the state of their staff stakeholder states, or teacher stakeholder awareness of the academic state of his/her students.

PAw analysis may be derived from any data point that can have practical application to ascertain whether a stakeholder knows the status of data relating to their profile. This may be conducted across a broad or specified range of stakeholder profile data and/or EEs, which may be dynamically and adaptively updated by comparing data related to stakeholder awareness to historical profile data of said stakeholders. Awareness may also be evaluated performance data over discrete measures of time as well. When a reasonable PAw is high, subsequent behaviors related to effort in response to the knowledge of such data as related to the current academic condition may be tracked for further EE generation. Awareness may be derived by analysis of communications data, effort data, ability data, or behavioral data which is collected and derived from inputs, outputs, imaging and/or audio data, Global Positioning Systems and other triangulation technologies, as well as performance reporting/viewing, login, statistics collected from automated communications from said system and method, parent stakeholder communications, etc., in order to determine levels of activity, complacency, or concern truly engaged in by stakeholder. Therefore post-awareness data will be critical in determining EEs related to effort.

Perceived Pro-activity, herein referred to as “PPro” is defined as Events related to the quantification and measurement of the PAw in relation to the PE values an educational stakeholder generates in order to circumvent, avoid, or to create an EE of a positive nature. It may also be a measure of the behaviors in relation to time in which an educational stakeholder may engage as a likely response to an Event of consequence which has occurred in the recent past. One example might be that a teacher stakeholder becomes aware of a potential failure of a student stakeholder and acts to offer said student stakeholder incentives to improve his/her performance. Data related to the teacher viewing such information, and his/her response to it as perceived in time may indicate a high PPro value. Reactivity can also be indirectly derived. If given the same scenario, said teacher instead allowed negative EEs such as failure on a quiz to ensue and then issued incentives, such a teacher may be perceived to have been more reactive in their approach to an EE rather than proactive in its avoidance. Said system and method could adaptively monitor the behaviors a stakeholder engages in from the time of the occurrence of an EE to the time of resolution, and determine the degree to which a stakeholder was aware, what PE behaviors and EEs occurred subsequent to the occurrence of the original event, how said behaviors and events related to the passing of time, and the outcome that ultimately resulted in the resolution of such EEs. Said events and data points could then be compared to stakeholders of statistical proximity, or to all known stakeholders, as a baseline for an adaptive evaluation of PPro. For example, the overall PPro of a teacher stakeholder could be evaluated by analyzing related statistics and data points for all student stakeholders with whom said teacher is or has been connected. In another example, if a student or parent stakeholder was aware of an issue as determined from login and communications data, and did not act to initiate proposed resolutions, request help, or act to communicate concern, said student and parent stakeholder would be developing a pattern which could potentially lead to a categorization of low PPro. For this reason, EE generation for Proactivity may either be absolute in nature or may be dependent upon the interactions between stakeholders and may be used to determine whether or not data from a stakeholder such as a teacher should be included in stakeholder measurement. For example, it may be possible to analyze the PPro a teacher is perceived to possess overall, while simultaneous EEs are or are not generated based on the perceived statistical parity of that interaction. In such a case, a teacher, student, and parent all having similar Pro-activity data may not generate a negative or positive event, nor a change in system awareness, since historical data would suggest that all stakeholders are aware of a current educational state and it is determined based on past data said situation is unlikely to change.

Perceived Willingness, herein referred to as “PW”, is defined as Events related to short term measures for the quantification and tracking of PP trends compared to PE in relation to time, and within the context of targeted or proximal stakeholders as well as targeted statistical data points within a stakeholder profile. Such an analysis could be in relation to his or her own or other stakeholder historical data. Said system and method may be described as a shorter term measure of behaviors in relation to task or goal compliance, or completion of isolated tasks, events, behaviors, policies, curricular requirements, requests, standards, and extracurricular activities for a particular discipline/class. PW could be tracked for an educational stakeholder by analyzing the number of successful data “hits” (attaining a goal data point), number of misses (failing to attain, or to attempt a goal data point within a period of time), number and nature of EEs, and comparisons of such measures to related data, other similar stakeholders or to periods of time within the profile of said stakeholder.

As an example, an educator may set goal tasks in their curriculum or policies, and successful, and/or timely completion by student stakeholders might indicate high levels of PW. In addition, lateness in or failure to complete such tasks could indicate low levels of PW. Conditional Incentives which have quantifiable value may be possible to include automatically in stakeholder measurements, and might serve to encourage better performance through increased PW by attaching conditional rewards or calculation boosts to stakeholder data points, or to statistically significant events aimed at improvement goals. Similarly, subsequent presence/absence of a specified desired behavior or set of behaviors could be integrated into stakeholder evaluation, to a limited degree, by educational stakeholders of appropriate educational proximity.

Said system and method may allow users to establish customized automated conditional EEs or automated PP, PE, and PA rating impacts, based on EEs deemed important by the stakeholder. For example, a teacher or professor may indicate special EEs such as completion of enrichment work, which may impact PW ratings, behavioral measurement, and integrate such conditions and statistical impacts within his/her course syllabus or grading features. In addition, it may be possible that said data would only be available based on an adaptive customization to the need of the stakeholder. Short term descriptive terms can be constructed for data translation based on a scale or spectrum, such as numerically, or in descriptive terms, such as “unwilling and unengaged”, “unengaged”, “willing”, “engaged”, “willing and engaged”. In the above example, as the indicators move from left to right, the PW rating changes from negative to positive. Descriptors may also be made or gauged conditionally in reference to the level of parental support in order to assist another stakeholder in understanding the practical role a particular parent stakeholder plays in the life of a student stakeholder.

Perceived Engagement, herein referred to as “PEng”, is defined as Events related to measures of PW analyzed in contrast to PE, and in comparison to measures of time. Data relevant to PEng may be EEs pertaining to measures and sub-measures of performance, effort, ability, behaviors, policies, curricular requirements, requests, compliance with standards and/or requests, extracurricular activities, isolated tasks, or a particular discipline/class in comparison to others. Measures of PW and/or PEng could also be used to provide data to professionals in educational or mental health fields or stakeholders who may wish to evaluate a stakeholder for potential diagnoses or services. A stakeholder who consistently and repeatedly demonstrates high PW, or who does so with high PE values would be perceived to have high PEng.

Because the establishment of equilibrium and parity may result in low system awareness and a decrease in EEs, absolute values for performance would need to be analyzed relative to engagement for the determination of overall quality. For example, there a scenario could exist in which a stakeholder could receive high PEng values although they do not generate frequent or repeated PEng EEs often because this is typical for that stakeholder. In one example, a student stakeholder may generate high PE and therefore generate data of high PW and PEng, but may still struggle academically. Such a stakeholder may be more reliably determined to be in need of assistance, interventions, or modifications of some kind depending upon professional stakeholder evaluations of a student stakeholder. As another example, a student may generate EEs indicating academic difficulty but may also generate very low measures of PW and/or PEng, which relates to submeasures of PE. This stakeholder may have the ability to succeed if they were more willing and engaged, but may not be fully devoting their time and effort to doing so. Such a stakeholder might be identified as having academic concerns to be further evaluated and/or monitored. However, if services and/or classifications were being requested, a student stakeholder and/or his/her parent may be required first to demonstrate a genuine PE as determined by PW or PEng EEs before resources, classifications, allocations of relevant funding and personnel, or related modifications will be implemented. As such, said system and method may save educational institutions large quantities of limited resources and funds in wasted allocation of, for example, special education resources. In the above example, said system and method would possibly delay executing a calculation of PA of a stakeholder until more data is available to make it clear whether that stakeholder is capable of performance at a higher level, but merely disengaged from the educational process.

Such measures would permit educational institutions to justify prioritization of, or the ability to more effectively allocate valuable and limited resources to, students who are most truly in need, as opposed to those who may appear to have need but whose needs lie more in the realm of a need to increase PE, PEng, or PW with more consistency. Said system and method would also provide a framework for Special Education stakeholders to identify customizations to programs that are needed based on available data as well.

Because of these features, said system and method may therefore also allow for the automated, accurate, and guided assignment of tiers of interventions and approaches as well. Guidelines could be established whereby a student stakeholder and parent stakeholder are notified of performance concerns, and said system and method logs awareness to the profiles of those stakeholders when confirmation of awareness is determined. The conditions which are necessary in order to qualify for services may or may not be disclosed to stakeholders of appropriate proximity. Any academically related measure of PP, PE, or PA which is relevant may then be targeted, and thresholds applied to their successful completion or the crossing of such a threshold in order to determine whether there is a real and genuine need for the stakeholder of concern. Said methods may also utilize educational stakeholder comments on reports, report cards, etc. and apply quantified values, or integrate real-time data captured from behaviors committed in the educational setting in order to further pinpoint PEng and provide context to EEs.

A feature may be put in place whereby users are asked to read and confirm their awareness of the desired, required, and conditional performance markers and thresholds of a teacher or professor, so that performance markers are clear, awareness is ascertained and logged, relevant Event generating data points are highlighted, and integrated stakeholder measurement can be partially or completed automated. Examples may include, but not be limited to, an instructor requiring a minimum execution or participation in a process which includes educationally or course related goals or behaviors in order to qualify for an exam, requirement, credit, or further EE. Supplementary beneficial behaviors may be described in a course syllabus, and tracked by the system for checks of completion, compliance, and ultimately a net effect on the assessment of stakeholder performance, effort, and ability. As an additional example, if a teacher does not offer extra credit, but does offer extra help, time to tutor, or peer tutoring, such statistics can be stated in the course syllabus, agreed to by all relevant stakeholders as a course agreement, and the completion or lack thereof of related EEs may be logged for any relevant stakeholder.

Although it will be possible that a lifetime summative score may be negative in nature due to an accumulation of negative statistics for a particular profile, shorter term measures of PW and PEng via said system may provide a means for a stakeholder to demonstrate a desire to improve. In response, said stakeholder may perhaps accelerate ratings of PP, PE, and/or PA based on consistency and frequency of the efforts that are put forth in recent EEs. In such an example, said system and method or another stakeholder may issue a summative evaluation of a stakeholder which translates such data into terms that have meaning to a stakeholder, such as, “You appear to be unengaged and unwilling to complete many assignments. This is having a negative impact on your overall performance. In order to improve we suggest you complete your Math assignments more consistently and request extra help.” In the example above, said system and method will provide the stakeholder with interpretive meaning which is developmentally appropriate to their PW and PEng data and will provide suggestions for EEs that will assist them in improving their score. A user therefore may have the ability to demonstrate, by truly data driven means, a willingness to turn academic performance toward a positive direction. Significant shifts in these measures may act to increase system awareness.

Perceived Persistence and Interest, herein referred to as “PPAI”, is defined as the resulting analysis of Events related to the consistency of EE generation and/or data point frequency of pertaining to PE values as well as captured behaviors over a period of time. Perceived Persistence is an analysis of the frequency and consistency of occurrences of EEs of a particular nature, in relation to the time spent on such tasks and/or goals as well as coursework. Comparisons may be made to other EEs in order to determine how persistence relates to strength or weakness, and ultimately derive academic interest and compare such data to possible career choices or outcomes. Persistence and interest may be derived by capturing data points over long periods of time within said system, or via proxy (i.e. EEs or behaviors deemed by the system or a stakeholder as interest). The Perceived “Interest” measure, of PPAI is a short term or longitudinal measure of any discipline, career, subject, or otherwise educationally related pursuits a stakeholder appears to be driven to pursue, and/or shows a disposition for the generation of more exceptionally positive EEs. Said system and method may potentially reveal a repeated propensity to engage in topical pursuits independently, to a greater degree, or when the possibility of academic consequence is not a perceived threat. In other words, what a stakeholder seems to gravitate to as points of interest based on the frequency, persistence, or duration of time captured by said system in such pursuits would be logged as perceived interest. PPAI could be related to particular academic endeavors which are determined to occupy significant stakeholder time and effort, and therefore could be used to detect and measure interest as it pertains to the likes and dislikes of a stakeholder. Persistence in PE or specific EEs in an area of study or a discipline may be used as indicators of PPAI.

The resulting analysis could be correlated and derived in reference to comparisons to other stakeholders or groups of stakeholders in order to establish norms, averages, and baselines of comparison, or according to absolute values. As an example, if a stakeholder is struggling but consistently makes measurable efforts at remediation and improvement, Perceived Persistence may be measured to be high although the stakeholder experiences academic stress. It could therefore be deduced that said stakeholder either persists in areas where they struggle, which could indicate work ethic and other subjective evaluations, or derive PE values which indicate when said stakeholder struggles he/she persists in efforts to remediate the EEs of concern until positive EEs are generated.

In another example, if a stakeholder is excelling and consistently makes measurable efforts at continuing to engage in said subjects, topics, and classes of a particular discipline, perceived persistence may be measured to be high as well as said stakeholder's perceived interest. This may indicate an area of discipline the stakeholder enjoys pursuing. Therefore a convergence of Persistence and Interest may be used to derive what a stakeholder enjoys, where as a divergence between persistence and Interest (i.e., they try hard and persist when needed, but do not show any other behaviors indicating they enjoy it) may be used to derive disciplines a stakeholder will tend to avoid.

PPAI may be used to supplement guidance for coursework, extracurricular pursuits, career aptitude, and calculations of Perceived Trajectory, etc. as stakeholder outcomes related to said data can be compared to stakeholders currently in educational activity. An example could include, but not be limited to, a tendency for a student to select science courses, strength in performance related to science, exceptionally strong effort in extracurricular clubs that relate to science being completed by said stakeholder, and testing that reveals a strength in areas of scientific study. Through the analysis of patterns related to the above description, it is possible to derive the PPAI of an educational stakeholder. Another example might include professional evaluation of stakeholders based on their behavioral tendencies. Such captured data may assist in human resource allocation or professional development guidance.

Persistence of a particular behavior or the capture of behaviors of consistent nature in the educational setting as measured through imaging, GPS, or triangulation devices, or sequencing of video and audio data points within the classroom or school setting could be used to determine thresholds of educationally related measures of persistence. For example, the persistence of head turning in class, and the persistent or frequent orientation of two heads toward each other within a 3-dimensional space could indicate distractedness or social behavior during a class setting.

Such information could be used to assist professionals in the early identification and diagnosis of psychological disorders or classroom based concerns. Persistence portions of PPAI related to such behaviors could indicate an academic or medical concern if the occurrence crosses normal thresholds of and EE and may possibly be used to determine classroom-based decisions, or be fed to medical or educational professionals to determine the appropriate measures or diagnoses applicable to said stakeholder. The statistical presence and increase in occurrence, or the statistical absence or decrease in occurrence of effort and/or longitudinal persistence may indicate a level of interest. There might be many examples of motivating uses of such a system and method, for example, a student stakeholder who does not usually participate may now begin to log hand raises that positively affect their effort rating because they are now aware of the need to do so as well as the potential benefit. Another example might be the generation of EE alerts for a student whose activity or bodily motions exceed or under perform in comparison to standard stakeholder baseline data and said data may be used to motivate and inform stakeholders of appropriate proximity. The absence of behavior may be used to derive a lack of effort displayed by users and allow the lack of their occurrence to be logged as EEs related to any relevant measure. Another example of a possible use may be to allow an educator to assign behaviors to another stakeholder, or for automated collection of said behaviors and efforts, and the manual or automated capture and synchronization of said data through electronic devices with user profiles and associated EE data via the world wide web. For example, a teacher stakeholder may be able, through software and hardware used in the classroom setting or 3rd party software, to target a particular behavior for a student stakeholder. Examples would be numerous, but one might include but not be limited to, a teacher and parent stakeholder agreeing that a student stakeholder should participate more, and a teacher stakeholder setting sensory hardware and software to target hand raising behavior within the classroom for that specific student stakeholder. During the course of a classroom setting, behaviors related to the target behavior would generate a potential EE, be counted, logged, analyzed, and reported to all stakeholders involved. Others within that same class may have different target behaviors assigned to their own individual profiles, thereby making it possible to track multiple goals and behaviors within a single setting, each with their own EE generation goals. This approach would allow for real time individualization of multiple goals and simultaneous capture and tracking of associated behavior, and measure their occurrence without the need for subjective recollection.

Perceived Total Effort, herein referred to as “PTE”, is defined as Events related to the total compilation of all measures of effort and associated sub measures over the lifetime of a stakeholder profile. It may be described as the longitudinal analysis of all measures and derived measures of effort. Said measure may include comparisons to data relating to other stakeholders.

### Ability

Analysis of PP relative to PE will derive measures of PA. Previously derived ability statistics may be iterative in nature and therefore a changing value as more data becomes available. Facilitation of the determination of PA may also include supplemental data from standardized testing results, inputs, implicit or explicit data points, EEs, or other measures which are then integrated into a compiled figure. A conceptual example of a calculation of PA may include, but not be limited to, a stakeholder exhibiting low effort in an academic area, but performing relatively high from a performance standpoint. Such a stakeholder may be calculated to have a high PA in that particular educational area because they excel with little or relatively lower effort. Similarly, a stakeholder who displays high effort and low relative performance may indicate that said stakeholder has a lower PA. Such a stakeholder may encounter difficulty, cause for concern, or a consistently low ability in that particular discipline because it takes great effort to achieve said lower performance statistics. PA can be specific to a particular branch of academic study, subject, grade level, or as a function of coursework. Such data can be further analyzed to produce stakeholder specific or targeted feedback that may drive and evaluate course load, coursework and/or career direction and selection, identification of stakeholders who may have a need of assistance or intervention, identification of stakeholder strengths and weaknesses, and may ultimately be used to offer predictive and adaptive career guidance and/or recruitment. The evaluation of PA may be facilitated through a direct or indirect assessment of weakness and strength based on the analysis of effort and performance outcomes as compared to targeted PA outcomes which may be further analyzed in relation to other sub elements such as perceived persistence. It might be necessary to evaluate sub or intermediate measures of ability such as the Perceived Relative Ability or PAr, the Perceived Ability Utilized, or PAu in order to determine what the functional ability, or Potential Performance is (PA)s.

### Sub-Measures of Ability

Perceived Aptitude, herein referred to as “PAp”, is defined as the result of analysis of Events pertaining to PP, PE, PA, and any derived measure, or sub-measure in the context of longitudinal data and perceived statistical certainty. The recurrence of such statistically related data as it pertains to coursework of a certain discipline or general orientation may be determined to imply strong correlation and therefore a strong aptitude for said discipline or skill related careers. Longitudinal feedback on consistency and pervasiveness may indicate stronger statistical certainty of the PAp of a stakeholder, whereas shorter term or limited availability of data may prevent or delay a calculation of PAp until appropriate. An example could include, but not be limited to, a stakeholder student displaying a pervasive longitudinal pattern of a higher level of performance and a lower level of effort in a particular study, subject, or area of discipline. For example, a student stakeholder may show consistently low effort and high performance in any discipline whose orientation is scientific, or perhaps linguistic in nature. The consistency of such data over time would increase the reliability of the stakeholder's perceived aptitude with respect to this measure. An analysis that reveals consistency in related EE patterns may reveal attitudes, aptitudes, and affinities. Therefore, the greater the statistical effect and/or certainty of such measures, the greater the number of occurrences, the greater the duration of time over which such measures are collected, the greater the reliability of such measures. For this reason, statistically derived stakeholder affinity/performance in a particular academic area, and/or statistically derived stakeholder avoidance/low performance in a particular academic area may determine which disciplines and careers a stakeholder has a propensity to succeed in and which may be recommended to avoid. In addition, measures of the time spent on extracurricular or voluntary tasks, as well as the data derived and captured related to the pursuit of certain activities or tasks, may factor in measures of aptitude as well. Said measure and associate EEs could be involved in the driving and selection of customized instruction and coursework based on career orientation.

Perceived Academic Potential (PAP) is defined as longitudinal analysis and extrapolation of Events relating to PA, trajectory, and PAp in relation to the outcomes of all known stakeholders, either within or across stakeholder profiles, in order to determine a predictive analysis of likely outcome ranges of academic and/or career choices and academic outcomes which stakeholders will ultimately be likely to attain. Such an analysis can be facilitated by a dynamic processing of known PP, PE, and PA data and associated EEs in relation to longitudinal data and known outcomes as compared to developing trends for current stakeholders in order to determine and report the likely outcome and outcome range of an educational stakeholder as well as an assessment of the effort and behaviors necessary to attain certain outcomes. Said measure will provide stakeholders with a comparison of the analysis of the effort and behaviors needed to effect a significant change on the academic performance they may be currently experiencing and may dynamically provide feedback on likely outcomes.

Perceived career aptitude, herein referred to as “PCA”, is defined as an analysis of Events related to PAP and known career skills/pathways. Such a measure will provide stakeholders with a means of translating information from their academic data into an analysis that will assist with matching career choices. The long-term evaluation of related stakeholder profile data, and a comparison of said data to known information pertaining to career choices and outcomes may be facilitated through a tabulation of PCA, and may be integrated with data from 3rd party stakeholders.

Said system and method will also be able to determine a Non-core/Peripheral Instructional Effect, herein referred to as “NCPIE”, which is defined as a comparative analysis between typical Event data and measures generated by a core educational instructor stakeholder to Events and data captured and generated after the point where a peripheral stakeholder is established to be present and proximal to the same associated stakeholders within the context of time. NCPIE is a system and method which accounts for the effect of the presence and participation of a peripheral, non-core instructor or stakeholder, such a student teacher, special education teacher, English as a Second Language teachers, tutors, support staff, counselor/psychologist, or paraprofessional, on measures of PP, PE, and PA in relation to contact time and sequencing. As such, it may apply to an individual or group of stakeholders during the period of time in which those stakeholders are under the educational care of related stakeholders, such measures may be integral in the evaluation of any stakeholder. NCPIE allows for a statistical capture of data and adjustment for the positive or negative effect a peripheral stakeholder may generate while they are in proximity to related stakeholders.

Typical student stakeholder measures and baselines could be established within the scope of time, setting, year to year comparisons, demographic, or data and Event data collected within a group of student stakeholders before and/or after a said peripheral stakeholder connection forms. Adjustments could be statistically facilitated to account for student stakeholder performance, effort, and ability norms. Upon the formation of an educational relationship between a peripheral stakeholder and his/her associated students and/or the stakeholder who has primary connection to student stakeholders, the educational proximity will be formed. New EEs may be generated in order to integrate comparisons of any subsequent data points to typical student performance while still maintaining a real or derived separation in the data generated during and after the connection between the peripheral stakeholder. It may be also possible to facilitate analysis of historical performance of that same stakeholder in reference to present or past groups of stakeholders. Using data derived from PP, PE, and PA measures of educational stakeholders, comparisons may also be made between groups of students within a particular period of time such as a calendar year, or to the statistical norms an educational stakeholder typically achieves. For example, the analysis of the impact of a tutor on a student could be measured, or the analysis of the differences between baseline performance for a teacher stakeholder or group of student stakeholders before and after the presence of a special education, tutoring, or paraprofessional stakeholder contact forms comparisons of student stakeholder data points from some class periods, or blocks of students may be compared to periods, or students who are not under the indirect care of such a peripheral stakeholder.

In addition, it may be further possible to measure the statistical effect an administrator stakeholder has on their staff stakeholders. The perceived strength of collaborative relationships could also be derived by analyzing student stakeholder performance in comparison to differing combinations of educational professionals.

### Stakeholder/Systemic Communication and Interaction

EE Alerts can generate a framework for a dynamic and adaptive messaging system which determines, and cites critical relevant Event data in facilitating comparisons, and integrates such data into communications between stakeholders and to stakeholders by pulling data from each stakeholder profile and including such information in the periphery or body of communications between stakeholders. Such information could include, but not be limited to, EEs, trends, areas of concern, areas of strength and weakness, and overall evaluations and statistical displays to provide for expedited and targeted communications. Alerts and notifications may be based on the occurrence of an EE or on a past EE, or the future likelihood of the occurrence of an EE. Said messaging system may eliminate the need to manually reference student data in other portions of a web site or grade book. Information may be presented in the periphery of any communication. Synchronization of actions between a calendar, and the messaging system is possible where relevant.

In one example, through the use of EE data and data related to PP, PE, and PA a platform may be generated whereby conditional intervention plans may provide a means to motivate struggling stakeholders. Said system and method may grant educator stakeholders the ability to initiate one or more conditional statistically significant incentives in the form of an intervention plan, which may or may not be acknowledged by stakeholders of potential impact, and may also be acknowledged in some way in order for any further positive or negative event to be assessed related to conditional subsequent EEs. The successful completion or the failure to complete the referenced EEs may have greater statistical impact in a positive or negative direction, especially if conditions were acknowledged prior to their completion or deadline. The choice of a stakeholder to agree to the terms of an intervention would allow for validity and clarity with respect to the impacts in either direction, thereby increasing stakeholder accountability and the confirmation of viewing the option to agree may be used to calculate PAw. Said system and method may analyze, and determine when an intervention succeeds in, or fails to, result in changes in stakeholder behavior, and EE generation, measures, time frames, and if necessary, periodically or conditionally remind stakeholders of their responsibilities and/or suggest recommendations to stakeholders while they are in the process of completing a conditional intervention plan. All of this may ultimately be used to calculate PEff.

Institutional/Contractual Adaptive Formulations would allow stakeholders the ability to adjust Events, measures and weights applied to any stakeholder based on restrictions by law, contract and union related negotiations, or institutional preferences. This provides options for variables pertaining to PP, PE, and PA to be added, omitted, or to be adjustable and customizable to the needs of the stakeholder. In this case, an individual user, school, district, state, and/or government institution who wishes to influence the weighting or inclusion of an EE in the assessment of educational stakeholders may possibly be able to customize, to a degree, the method by which stakeholders are assessed with respect to EEs, and measures of Performance, Effort, and Ability. If, for example, the needs of a school district are not aligned with the system and method's default measures for stakeholders, they may be permitted to change certain items assessed and which measures and EEs may be viewed and displayed between educational stakeholders of appropriate educational proximity as well as the weights applied to them to create a customized institutional profile. This custom profile can be compared to systemic defaults and averages, as well as searchable parameters. Therefore, it may be possible to predetermine limits and parameters for that stakeholder or institution. Contractually oriented EE modules might serve as negotiations templates with interactive menus which establish the configuration of preferred formulas and EE preferences and show matching and conflicting desires between two or more parties with proposed solutions. For example, a union may select certain EE parameters, a District another, and ultimately, said system and method show where similarities and differences arise and possibly suggest a common ground for stakeholder measurement.

Independent stakeholder development derivations may interpret the meaning of accumulated educational statistics, provide feedback to educational stakeholders, and allow a stakeholder who finds material challenging or who wishes to further understand development goals to independently explore information in a traceable way. This exploration would occur within a context of that specific topic through suggested or proxy/automated processes which capture information related to PP, PE, and/or PA.

Event alert management based on a menu of events or a customizable Event tracker would allow for reminders and indications of targeted statistics or behaviors to assist the achievement of statistical parity or equilibrium. Stakeholders of comparison may have the ability to alter the terms necessary to allow for completion of an EE by, for example, extending compliance time frames or adjusting parameters related to said events if deemed necessary by the current stakeholder of authority within an appropriate educational proximity. Requests for such Event term triggers or threshold alterations by any stakeholder may be facilitated via a user interface.

### Connections of Main Engines and Sub-Engines of Invention

The Common Educational Identity Engine 120 acts as an interface between third party applications and equipment and/or other network interfaces connected to the Common Educational Identity Engine 120. In the embodiments shown in FIGS. 3 and 4, the Common Educational Identity Engine 120 functions as a data router and also captures information and data. The Common Educational Identity Engine 120 collects all relevant stakeholder information and data from one or more sources, including inputs from a computer, sensory equipment, motion sensory equipment, the internet, etc. The capture of information from detection equipment may be in the form of data from video, audio, detection and analysis of differing waves of the electromagnetic spectrum, movements, triangulation of data from multiple detection points and any possible combination thereof from one or more electronic devices which feed to the engine, The Common Educational Identity Engine 120 converts all of the captured information into data. All data is categorized and sorted into three categories: Performance Data, Effort Data and Profile Data. Profile data includes data from social networking.

The Adaptive Educational Data Processing, and Evaluation Engine 121 analyzes data, EEs that have already been created and creates EEs based on statistical analyses, feeds data (including EEs) to other engines, and aggregates data into meaningful transcriptions and translations to provide meaning and context to educational data. All data flows through the Adaptive Educational Data Processing, and Evaluation Engine 121 in order to continually analyze the data for relevance to EEs and facilitate the feeding of data to any other engines.

The Stakeholder Reporting and Comparative Analytics Engine 127 provides for the automated or customized presentation of data related to EEs of any one or more stakeholders. Said engine also provides an interface that allows stakeholders to generate and evaluate reports.

Although existing separately from the foregoing engines in the preferred embodiment, and executing different functions, there are several sub-engines to the Adaptive Educational Data Processing, and Evaluation Engine 121 including:

Educational Social Networking and Collaboration Engine 124

Educational Business Networking Engine 125

Automated Practice Research and Educational Approach Recommendation Engine 126

The Educational Social Networking and Collaboration Engine 124 may concurrently exist as a sub-engine within the Adaptive Educational Data Processing, and Evaluation Engine 121. The Educational Social Networking and Collaboration Engine 124 analyzes social data for relevant connections and not yet received data, determines the level of proximity each connection warrants, helps form profiles for stakeholders, anticipates and captures EEs as they occur and applies related data across stakeholder profiles. Additionally the Educational Social Networking and Collaboration Engine 124 works to feed connection and interaction data to the Educational Business Networking Engine 125 in order to assist in the identification of potential business connections based on perceived need and services provided.

The Educational Business Networking Engine 125 conducts an analysis of needs, claimed services, availability, relative proximities educationally, and within the context of PP, PE, and PA, serves to find the most suitable match between a service provider and a stakeholder in need of services. The invention concurrently analyzes stakeholder profile data in concert with Jigsaw and Jigsaw Ghost data. Examples would include matching tutors with those in need and forming further connections, supplemental materials and marketing to gifted students and students in need. Marketing of materials to administrators based on school profile data, etc. all of which are aimed at the generation or avoidance of EEs. The Automated Educational Practice, Research, Educational Approach, Recommendations, and Collaboration Engine 126, preferably a sub-engine to the Adaptive Educational Data Processing, and Evaluation Engine 121, provides real-time research and related analysis of the data pertaining to all engines and also provides the findings relevant to stakeholders, to any necessary engine for high level interpretation related to and between data points which are normally otherwise separated or undetected.

All main engines and sub-engines transfer data between each other according to preset thresholds, rules, and processes that moderate and direct data flows and usage.

The following description gives a general explanation as to how the main engines connect and how data flows between them, but is not intended to be exhaustive.

### Common Educational Identity Engine and the Nature of Identity Profiles—Jigsaw and Jigsaw Ghost

The Common Educational Identity Engine 120 utilizes computerized input and output devices, human interface devices, environmental sensors, and/or audio/visual/imaging sensors to collect, process, and federate implicit and explicit data associated with educational stakeholder interactions and academic data values. The Common Educational Identity Engine 120 establishes an educationally related identity for each stakeholder which is called a “Jigsaw” profile 710 and/establishes “Jigsaw Ghost” profile(s) 715 for a stakeholder(s) who does not yet exist in the system and/or for any data unassociated with a particular stakeholder which may be of interest or consequence to the EEs of a particular user. The Common Educational Identity Engine 120 organizes and categorizes data received including data derived/created by other engines, such as the Adaptive Educational Data Processing and Analysis Engine 121. The Common Educational Identity Engine 120 captures real-time behaviors from the educational setting and converts information into data. The Common Educational Identity Engine 120 acts as a primary data capture, aggregation, and storage location of data pertaining to any stakeholder or relevant to any main engine, and includes a cyclical and adaptive feed of inputs and outputs to and from each engine which may be dependent upon the statistical relevancy of data those elements received or feed.

For example, it may be possible to use any spectrum of light, including, but not limited to visual or infrared, laser, GPS, visual, audio, or other imaging technologies that have the ability to scan the profile of a room or individual as well as potentially monitor educational stakeholders to establish means and averages of relative or absolute behaviors in order to determine deviations from said means for the purposes of capturing targeted behaviors for individual stakeholders or groups of stakeholders 107,108,111. The system would capture behaviors occurring as a result of interactions in a classroom setting and are used to more accurately determine true performance, effort, and ability of any stakeholder as opposed to the PP, PE, and PA of a specific stakeholder only. Examples of ways in which it may be possible for devices which are mounted either within the classroom, an object in the classroom, or possibly on the person of a stakeholder, to capture behaviors include but are not limited to: questioning in the classroom setting, the occurrence of targeted or captured behaviors, the establishment of behavioral means and averages, their frequencies, durations and occurrence as well as deviations thereof. Data transfer would be mediated through the integration of hardware and software dedicated to said tasks and functions.

The Common Educational Identity Engine 120 creates coexisting, unified, and integrated, yet conceptually different, social networks; a basic educational social network which consists of Jigsaw profiles, Jigsaw Ghost profiles, and the integration of real life social/behavioral components captured in the classroom. The invention will normalize and capture data that is assigned to one or more stakeholder profiles. The electronic Jigsaw/Jigsaw Ghost networks will capture any and all educationally relevant data which includes electronically based interactions and behaviors. To a limited degree, some educational networking connections will be made as a result of the place of a stakeholder within the educational system, therefore those placements and associated data may be categorized as real-life social networks and their associated data integrated with data from the electronic social network in order to enhance stakeholder interactions and their analyses. The invention captures stakeholder interactions and behaviors within said environments in order to supplement data capture and the creation and analysis of EEs. By integrating human behaviors and interactions within their real life setting concurrently with the electronic educational social networks, the invention is able to produce analyses of educational stakeholders that are more representative of the stakeholders true relationships, interactions and behaviors than would be possible for either approach alone.

The Educational Social Networking and Collaboration Engine 124 finds and determines logical connections based on educationally related data and/or EEs pertaining to PP, PE, and/or PA. In addition, connections may be determined by more traditional means such as by analysis of existing relationships that then may suggest or automatically form other educationally related connections of varying proximities. However, by their nature such connections may be uniquely and adaptively afforded and granted differing levels of access to academic information. Parameters of time placed on data availability, and/or connections dependent upon the determined educational proximity, and/or customizable stakeholder settings may be instituted as well.

The EE-based Social Networking engines 124 and 125 facilitate the integration of educationally based data captured using computerized input and output devices, human interface devices, environmental sensors within the educational setting, and audio/imaging sensors to operate within the context of EE generation and resolution, as well as subsequent analyses and their relation to the Common Educational Identity Engine, and 3rd party data integration. EE-based social networking begins when said system and method facilitates educational social networking connections based on data and calculated educational relevance between stakeholders and potential Educational Proximity through the collection, correlation, and processing of data from any other Main or Sub element. Said system and method functions to facilitate adaptive connections which may be permanent, temporary, or shifting in the nature of the connections between stakeholders based on the degree of “educational proximity”, which is defined as the level of educational relevancy of a connection between two or more stakeholders and the likelihood of the relevancy of an educational social connection based on educationally related tasks, coursework, related educational profile demographics, the likely duration of connection, the level of connection, and likely need to access sensitive educationally related data based upon the qualifications, relationship, and directly requested input of any stakeholder or group of stakeholders in order to facilitate connections between stakeholders that provide relevant and timed connections as well as access to stakeholder data. Said Educational Proximity may be based on the likelihood of mutual stakeholder interests, and/or potential to benefit or inform the data captured on any educational stakeholder. Potential benefit may be determined from statistical analysis and/or the potential relationship that one stakeholder may have to other stakeholders. In addition, consideration could be given to other variables such as stakeholder demographics, profile patterns, and/or educational institutional data derived directly or from 3rd party systems.

Data for potential connections will be evaluated based on perceived “Educational Proximity” between stakeholders, and determine the likelihood of potential connection benefits that are possible between two or more profiles, and potential connection relevancy based on profile information. Proximities may be dynamic, or flexible, in nature and subject to oscillation or shift such as the increased proximity and decreased proximity between teachers and students who are placed together by a school or, for example, one stakeholder may have one proximity as a parent to some stakeholders and another proximity to others and that proximity may shift or change based upon contacts and interactions and how they develop over time and shift or change. Upon identification of proximity, relational rules of connection and data sharing will be established adaptively and also be influenced or controlled by user choice/input/request that is appropriate to the age and perceived level of competency of the user. Said system and method will therefore facilitate developmentally and level appropriate interactions that adaptively change as stakeholders progress during the course of their educational roles. Default rules of connection formation and disassociation can be automated, timed for connection and disconnection, facilitated, and/or applied between profiles, and further customized within reasonable, and/or legal guidelines. A parent/guardian may have permanent high level access to the data of their child, as well as a permanent high level connection as determined by their relationship to that child stakeholder. Such a stakeholder would be assigned a high level of educational proximity by said system and method. A teacher stakeholder may have temporary high level proximity and therefore data access to academic history based upon the registration of that student stakeholder within a teacher stakeholder's class. In that same scenario, a teacher may or may not be able to directly view historical parental statistics, or associated stakeholder statistics, dependent upon user or institutional settings, coursework, or requests to view such information that may potentially need to be approved by relevant stakeholders with permissions and/or available use of administrative rights. As another example, a teacher stakeholder may only have access to such information for the duration of their educational relationship with that student stakeholder. A friend or classmate connection may have adjustable and/or timed levels of access, or have permanent connection with low level access, and various other stakeholder connections may simultaneously exist which also have differing levels of access to profile information based on their own educational proximity. Another example might be a connection formed by a student stakeholder and a tutor stakeholder. A tutor stakeholder may possess or request a very high level of targeted academic information access and be assigned a corresponding educational proximity, but for a very short period of time. As another example, student stakeholders may have broad low level access to profile data as determined by their association with a course, subject, or grade level. This “classmate” connection would be timed unless stakeholders wished to continue their connections post classmate status and transfer to a friend status if for example they still wished to remain connected but will no longer be in the same class. Such stakeholders would be permitted to select such options to establish such proximities and connections and all decisions would be restricted to the developmentally appropriate skill level of the stakeholder. Benefits of such dynamic connections could be numerous, including the capacity to capture and measure EEs and educational data not previously quantified, information and profile data sharing, calendar synchronization, alerts, etc. At the completion of a course, the educational social networking system would automatically terminate the connections between said stakeholders but still permit the viewing of EEs and associated data which was captured during said connections.

The invention forms educationally related connections via adaptive data sharing, as well as tiered and/or timed connections based on the degree of perceived relation, relevancy, desire to connect, or need to connect of any stakeholder, for the purpose of the sharing of knowledge and information, evaluation of indirect connections of interest, stakeholder decisions/inputs, and formation and response to suggested connections all to achieve the ultimate purpose of increased efficiency in educational communications and information sharing whose security and access is governed by proximity rules and any/all applicable laws. Although connecting stakeholders is an important portion of the invention, a primary function will be to collect and analyze behavioral data helpful in deriving the relationships between PE, PP and PA and related sub-measures. Connections may be permanent in nature, such as with a parent or guardian, or temporary in nature, such as for the duration of a grade, class, project, or task, with the possibility of user customization of access to profile information either before or after the connection is established. The invention incorporates implicit and explicit analysis for the function of improving the identification and formation of educational stakeholder connections in order to facilitate the capture of EE data. The invention uses EE data to form and identify potential business relationships, as well as to facilitate derived measures of stakeholder performance, effort, and ability for the purpose of facilitating improved outcomes and the connections of educational stakeholders who have or may have potential academic needs and educational stakeholders who provide public and private educationally related business or service-based services.

The Common Educational Identity Engine 120 adaptively and actively monitors the timing and permissions of established relationships which are defined by the Educational Social Networking and Collaboration Engine 124 and Educational Business Networking Engine 125, and facilitates formation and automatic detachment of relevant relationships.

Restrictions could also be applied if a significant change occurs to stakeholder profile proximity, as indicated by institutional stakeholders, or data which has legal relevancy. For example, the development of a divorce between parent stakeholders may influence proximity levels and therefore access to student stakeholder data if one or more parents are legally restricted. Said example may influence levels of proximity between student stakeholders and parent stakeholders, etc. Data collected on behavior from said profiles will be retained and utilized in the calculations of further EEs.

As an example of timed variable proximity connections, a student stakeholder may have a few timed classmate connections, a few friend connections, and a few timed teacher connections, some of which will end at the end of the current school year, some that will be granted more permanent or semi-permanent proximity status manually, and all of which have differing levels of academic access. Data derived from said connections may be fed to any other main engine. EEs may now be captured which would otherwise not have been measurable or formed outside of said connection.

Adaptable cyber-security and academic information sharing could be engaged in tandem with settings associated with each level of educational proximity based on user selections, age, and relevant state and federal law. For example, academic information could be released to a stakeholder for a period of time such as a school year, or could be released based on the relevancy of such data, such as “all science performance”, or “all recent EEs” so that an educational stakeholder could perceive appropriate levels of greater depth with respect to the sum total of stakeholder PP, PE, and/or PA of a particular individual, as is relevant to said stakeholder. Such information would be used in the establishment of and measures of data associated with educationally related business connections. If necessary, de-identification of data could be facilitated in order to ensure secure data transfer between said system and method and 3rd party systems. An academic data sharing protocol and user interface could be engaged for “As needed” sharing, transferring, and viewing of specific portions of an individual's confidential academic history. Examples might include allowing access for a period of time, as specified by the selections of the user, and/or within legal limitations, to share such information with another stakeholder of relevancy. As another example, after a business connection is formed between a tutor stakeholder and a student stakeholder, said protocol could provide for sharing of data between the profiles based on the perceived need of the stakeholders to know such information about the other. A math tutor may gain access to a student stakeholder's historical math performance.

There may also exist potential to enhance user, professional, or other stakeholder analysis if said stakeholder has educational connection to a stakeholder and/or immediate need for sensitive information, or possibly to an educational institution that is in need of transcript, performance, or behavioral information for a possible diagnosis or addressing of a concern. Said system and method may also benefit a peripheral stakeholder, such as a tutor, who has a vested need in attaining knowledge of information relevant to the discipline which they wish to assist a student stakeholder.

In the context of EE generation for PP, PE, and PA, a stakeholder meeting room or electronically facilitated meeting place for profile owners to convene could be facilitated through the establishment of an interface for educators in order to facilitate the expression of data and the unification of stakeholders of a particular course, age, ability, subject, or grade level, into course or grade-level related tasks, such as study or focus groups, information/data sharing, extra help sessions, supplemental services, as well as individualized and structured instructional settings, thereby increasing the efficiency of educational stakeholder connection, interaction, and the derivation of data for measures of performance, effort, and ability.

Data will also generate Jigsaw Ghost profiles as described and integrate and derived data from said profiles into a standard Jigsaw Profile. Said educational social networking platform may include a dashboard and a user interface which is integrated with all main elements and front end applications such as grade-booking and educational statistics collection/display features, or associated software, in order to view and make relevant connections or potential connections.

Further examples of the interactions of connections and proximity might include; connections between stakeholders of authority, and staff stakeholders, or members of clubs and organizations. More specifically, a particular educationally related club and its members could be informed of each other's existence and membership and offered a possibility of forming a connection with appropriate proximity. Interesting or relevant information could be shared such as performance or task progress, or there might be events or links established for verification of completion of various activities so that club facilitators or presidents can monitor progress for a variety of tasks. As another example, a peer tutor relationship could be formed which is possibly facilitated by a support staff stakeholder, whereby EEs are generated and tracked, and the communication of analyses could be facilitated and logged to verify completion of requirements for entry into the organization or maintenance of such a class, community service, or club requirements.

Stricter rules for younger/disabled stakeholders and parental approvals could be put in place as checks and balances in order to ensure that a minor is not sharing inappropriate, sensitive, too great an amount of information, or information otherwise not ethically or legally permissible by a stakeholder who is younger or lacking judgment, or a stakeholder who has limited legal and/or mental capacity to share or receive such information. Such limitations could also be imposed by a parent or authoritative stakeholder to ensure forced protection of another stakeholder's information.

Furthermore, academic data sharing protocols might act for transmission and dissemination of transcript information, sharing and viewing of sensitive information for flagging of potential, and analysis of stakeholder concerns or considerations such as special needs, diagnosis, classification, 504 status, or behavioral data between stakeholders or groups of stakeholders, and views of any measure of the performance or effort of a particular stakeholder could be facilitated as well. It is possible that information collected as a result of the interactions between educational stakeholders either directly or indirectly could be used to gauge thresholds for certain interventions or levels of assistance provided to a stakeholder.

Another example of integration may be through the use of a stakeholder messaging system, so that when a user receives, views, or responds to communications from and to any other stakeholder or group of stakeholders, such data from a user would be viewed as behavioral and/or PE related data and relevant to EE data corresponding to any relevant stakeholder of reference via a front end application in order to minimize the need for a stakeholder to seek such information. This would reduce the need to view multiple screens of an interface. The invention could also leverage data derived from viewing of said communications, and critical data relevant to response, or to proximal EEs before, during, or after such occurrences, in order to assist in the generation of EEs related to PP, PE, and/or PA. Said system and method would facilitate EE-based communications between stakeholders, calendar synchronization, collaboration, event sharing, event generation, file sharing, information sharing, facilitation of professional development goals and goal tracking that will assist in the tracking, generation, and resolution of EEs. Said system and method will therefore assist in the more accurate evaluation of any stakeholder as well as increased efficiency in the execution of tasks and a reduction in the time and frequency necessary to dedicate to certain educational tasks. Because of the centralization of all data related to both performance and real as well as electronic behavior, said system and method would be more capable of assisting stakeholders in deriving and monitoring professional and educational development goals. Related EE statistics may display them via a user interface via electronic, mobile, tablet, wearable, imaging/audio hardware and software.

Another feature could consist of a document and file, or folder sharing protocol whose access is dependent upon Educational Proximity derived by direct or indirect connections between profiles. Sharing files with friends, or sharing with any stakeholder with a similar Educational Proximity could be automatically and adaptively facilitated when stakeholders are in need of related material as determined by information collected via profile data. Such sharing would not merely be decided upon by social connection or by user invite, but also suggested and controlled based upon static or dynamic proximities. The invention could be facilitated within an institution, or across institutions based on proximal relevancy. Variations might involve the adaptive facilitated sharing, viewing, and completion of assignments, documents, calendar events, and related information, either publicly or by determination of derived proximity and relevancy.

EE-based data may allow third party educational entity, stakeholders, businesses, or institutionally mandated materials to be distributed and/or sold via a pathway that matches curriculum with EEs of a stakeholder, and may also be integrated with data from other main elements, in order to more accurately target such materials to the need of relevant stakeholders, and to more accurately target marketing and academically related services to stakeholders based on their PP, PE and/or PA.

The interaction between stakeholders of common educational interest may be facilitated via a software-based Internet-connected virtual computerized environment, whereby collaboration and integration generates EEs that are associated with a profile. Said EEs can be used in the provision of individualized feedback, EE generation, monitoring of and by educational stakeholders, and performance feedback on one or more stakeholders. Said system and method therefore provides a way for stakeholders to connect and to collaborate, while simultaneously creating, comparing, evaluating, and generating EE data. Such data can create further EEs, verification of required statistical or behavioral goals and obligations, the tracking of professional goals and development, or for the determination of the most statistically effective social practices a stakeholder has been able to implement, a comparison to similar stakeholders, and the subsequent sharing thereof of related pertinent information with other stakeholders.

Jigsaw Vs. Jigsaw Ghost

In addition to Jigsaw Profile for each stakeholder, the Common Educational Identity Engine 121 creates a profile called a “Jigsaw Ghost.” 715 Network connections for jigsaw profiles may be analyzed for information aimed at deriving the existence of stakeholders who do not have active profiles, and a Jigsaw Ghost profile may be derived in an active and ongoing basis as related stakeholder profile data is created and captured. Said Jigsaw Ghost profile will act as a means of facilitating data exchange and analysis for EEs that would otherwise be lost without accounting for the existence a particular stakeholder who does not have an active profile. Similar to the construction of a real jigsaw puzzle, Jigsaw Profiles which are generated for a user as a standard profile will then be constructed with a set of anticipated EEs based on the nature of that profile and its associated connections. Captured data will be analyzed against profile data for one or more stakeholders for any EEs which are possible, and therefore “anticipated” as missing data “pieces”. Said incoming data serves as “missing pieces” for one or more EEs which cannot be generated until all data requirements for an Event are met. As Events are generated and missing data is captured, a more complete “picture” or representation of the academic condition of a stakeholder will be apparent. As data arrives to a profile it is “pieced” together within potential Events similar to how missing pieces of a jigsaw puzzle are put together. The system may also fill data piece gaps with data derived from a user who presents as having an extremely similar profile or extremely similar data in order to more accurately determine possible EEs and/or outcomes. This will allow said system and method to form a data composite where one piece of data may relate and connect to one or more actual or potential Events.

Said Jigsaw Ghost profile would translate and transmit data to an actual stakeholder profile when associated with an actual individual or created by the stakeholder of reference, and allow the conversion of said jigsaw ghost profiles into real profiles when that profile owner claims rights to it according to FIG. 17. This will, thereby, adaptively and automatically establish as many connections as possible that have relevance and that reference real stakeholders who have real impact on the educational outcomes of another stakeholder independently of whether or not a stakeholder uses said system and method. Therefore, the collection of critical and presently unmeasured data is possible without the need for a user to directly establish a user profile, and the establishment of or the analysis of connections with a Jigsaw Ghost profile can be facilitated through adaptive analysis of available data 121. A Jigsaw Ghost profile could contain specific information that is limited to basic demographics, any data importable from publicly available institutional sources, inputs from verified educators, and exchanges between profiles of relevant proximity, and would accumulate data as a stakeholder or educationally proximal stakeholders added or generate such information. Verification of the true existence and validity of a stakeholder associated with said jigsaw ghost may also be accomplished through the comparison of data inputs from multiple educational stakeholder profiles and used to determine whether or not a stakeholder profile is being established by valid means.

As stated above, a Jigsaw Profile refers to a typical user profile. At the establishment of a formal Jigsaw, said social/educational networking profile will establish rules for information sharing and data capture that anticipate the filling of data values or the capture of data important toward generation of EEs. As data arrives it is assigned to anticipated and potential spots that that may be used or accumulated until EEs are generated. The establishment of a Jigsaw Ghost profile will be preferably used to feed data to, from, and between user profiles through which EE-related data can be further generated, accumulated, and consumed. An example would include but not be limited to; A teacher stakeholder who is utilizing said system and method is able to establish a student profile if they are taking classes for themselves (perhaps college courses), as well as to set up a parent profile if they have children, as well as a tutor profile if they wish to provide educationally related services.

The Jigsaw Ghost profile network may or may not actively seek to derive connections based on educational proximity data and other data factors, use data from multiple profiles, and attempt to predict which connections are existing, present, or possible. The Jigsaw Ghost profile may be displayed to users in such a way as to differentiate its status from a real profile, such as the use of a visual cue indicating its status. Said profile could also feed information to stakeholders who possess real profiles by integrating data which may be relevant in the formation of EEs between a Jigsaw and a Jigsaw Ghost. Additionally, a user may be permitted to embed timed and/or the conditional release of academically related data at determined by set times, and/or proximities.

A Jigsaw Ghost profile could also be manually or automatically established for users who have not yet established a profile themselves, but for whom information is available from user inputs, or automated processes, and for whom said data has a potential effect on the measurement of another stakeholder. As described above a Jigsaw Ghost profile may be converted to an active profile later if the user it represents chooses to claim it, or if an educational institution associated with said profile wishes to claim and assign it to an educational stakeholder.

An educational stakeholder would be permitted to establish a “Jigsaw Ghost” profile for any user they wish to identify as having a statistical relevance to, or an educational relationship with according to FIG. 16. At such point of profile creation, any/all relevant data, communications, and interactions might be captured and logged in and between said profiles. This will allow a stakeholder to enter, or the invention to anticipate and capture, relevant data which would be stored on said jigsaw ghost profile for any stakeholder who has not yet established a formal identity and active profile with said system and method. A stakeholder with an active profile may use said profile to add profiles of stakeholders within their educational proximity to said system and method. Such a stakeholder would have an interest in creating a profile for another stakeholder to facilitate the collection and analysis of data relevant to their own profile. In addition, if such a profile already existed, a stakeholder would have an ability to add to or derive information from said Jigsaw Ghost profile. Said system and method of profile integration would assist in the capture of information that is derived from another stakeholder in order to generate statistical comparisons between or within stakeholder profiles.

In an example of the interaction between a Jigsaw and a Jigsaw Ghost profile might include, but not be limited to, one stakeholder wishing to enter and process data related to the educational interactions and measures they generate between another stakeholder. Said stakeholder would have the ability to enter and collect data points related to the latter stakeholder via a profile which is automatically generated by said system and method when demographic and other information is entered by said stakeholder. Said data could be retrievable if the stakeholder of reference wished to establish a formal identity at a later time. Said system and method could then serve to collect and process EE data derived from data captured related to any main element and be appropriately integrated with the profile data of any relevant stakeholders. Data stored in the Common Educational Identity Engine 120 would be continuously updated and capable of feeding relevant data or EEs to any other main element through an Identity Data Provider which may then loop its processed results and outputs back to the Common Educational Identity Engine 120 to prepare for further analysis, storage or resolution.

Examples might include but not be limited to, a teacher collecting and compiling data on interactions that occur between him or herself and a parent stakeholder, such as communications, agreements, etc. Such information could be captured independently of whether or not said parent establishes a profile by the capture of computerized data, or computerization of data related to analog events such as phone calls. Such data could be processed and displayed for said teacher or other stakeholders who wished to view statistical analyses derived from said data. Data could be entered by one or more stakeholders in the educational field, and as data captured contributed to the completion of new and statistically valid calculations, such data could be used to create new EEs.

A stakeholder may establish one or more identities dependent upon the capacity they wish to operate under, which may be integrated with a main database according to FIGS. 6A and 6B, and supplemented with data imported from third parties 111 in order to assign, store, and catalog this data in a retrievable form that can be called upon for analysis, distribution, reference, and processing toward the ultimate goal of total stakeholder evaluation. For example, one stakeholder may have a parent profile, a student profile, a tutor profile, and possibly more or less active profiles depending upon the educational roles they wish to play, currently play, or have played in the past. Said system and method may be adaptable to multiple forms and formats in order to facilitate educational identity and statistical unification, inter-platform and 3rd party communications, data exchange, the creation and association of multiple educational identity profiles based on educational proximity, the adaptive structuring of educational stakeholder data, as well as the exporting of educational data across a variety of formats and platforms, for the secure exchange, and display of educationally related data. According to their nature and their place in the educational ecological system, each profile may have unique EEs that are possible to generate, while others may overlap.

Furthermore, the interactions between the Educational Social Networking and Collaboration Engine 124 and the Stakeholder Reporting and Comparative Analytics Engine 127 facilitates the sharing of data and integration with third party educational management, and learning management systems, as well as file and document management systems, so that any educational stakeholder data management, business, or educationally related entities may communicate across common standards of data exchange in order to facilitate support for the delivery and collection of data of interest. It may also allow for private and personalized targeting of advertising while simultaneously avoiding the violation of privacy laws and boundaries of ethics by personalizing advertising delivery in one direction to the stakeholder whose EEs are relevant.

A web client server, or composite front end application integration point may serve as a portal for application integration which provides communication between said system and other systems and/or stakeholders who use said system and method. XML, or other data or application integration technologies, may be utilized to accept and return data.

For example, educational performance data related to district, individual stakeholder, social networking data, or custom data points from third party learning management systems could be imported or integrated for consumption and be fed back an analysis of said data by said system and method to further enhance the richness of profile or performance data for said third party.

EE data will be applied across profile roles, and user profiles depending upon the nature of the data, profile role, and the profile of that stakeholder. For example, certain EEs may only pertain to the tutor profile of a particular stakeholder while other data pertains to their parent profile all possibly contained within a single identity. Third party systems may be integrated with the invention to allow users who may not wish to deviate from their current services or statistical analytical approach, but who may wish to utilize data derived from the invention.

To verify the release of sensitive historical educational information, a process might be employed in order to facilitate the proper identification of a stakeholder as having claim to such data, the handing of said data, and in the conversion of a jigsaw ghost profile into an active standard jigsaw profile if such a stakeholder had a desire to do so. Upon verification by a stakeholder with the authority to do so, past data could potentially be disclosed or associated to said account.

### Business Related System Functions—Tutoring Connections and Facilitation, Advertising, Needs-Based Integration

### Integrated Educational Business Networking Engine

As a part of the Social Jigsaw and Jigsaw Ghost profile network, the Integrated Educational Business Networking System 125 draws analysis from data derived from any main engine or sub-engine to create and facilitate business connections between educational stakeholders and create business communications and advertising of educationally related services. The Integrated Educational Business Networking System 125 integrates educational business tools with information relevant to EEs, PP, PE, and/or PA as fed from profile data in order to more efficiently identify which stakeholders are experiencing difficulty in academic performance measures, which educational business provider stakeholders are available, the relevancy of possible and ongoing connections, the best potential match to assist in improving performance, as well as the generation of business from the formation of relevant business connections. Said system and method also assists in the generation of EEs subsequent to profile connection establishment. The Integrated Educational Business Networking System 125 provides an analysis that determines the value, efficiency, and effect of stakeholder business connections and interactions on derived outcomes as well as to allow the subjective feedback of users to play a role in advertising EE accomplishments attained by a particular business provider.

The Integrated Educational Business Networking System 125 allows business service providing stakeholders to advertise services either publicly, or at targeted stakeholders so that any stakeholder who may be interested in services relevant to them based upon independent searches, stakeholder recommendations, or based on relevant educational proximity and/or Event data, can find and connect with other stakeholders or groups of stakeholders wishing to engage in related educational business transactions. Examples of such transactions could include, but not be limited to, tutoring services, coaching services, advertising, etc.

The Integrated Educational Business Networking System 125 utilizes data from The Common Educational Identity Engine 120, social connections, EE data for PP, PE, and PA as well as associated sub-measures to match educationally related services with related stakeholders who have need. The data that are generated may be based on an analysis of relevancy of connection, perceived need, recommendations from other stakeholders, and statistical or educational proximity, and may establish an engine whereby educational stakeholders can establish a professional services provider profile or be connected with someone who actively claims such a profile. The completion of the time for connection and the disengaging of an active educational business relationship may ultimately result in a stakeholder having the ability to request and/or post objective and subjective feedback to the profile of an educational business provider profile for advertising/display to other stakeholders who may be considering the formation of a future business relationship with that stakeholder.

For example, a tutor stakeholder who has had a recent educational connection to a parent and/or student profile may wish to request a review of their services from said parent and/or student stakeholder. In said scenario, a teacher stakeholder may be able to request that parent or student provide a review of the services, such as tutoring that were provided, whose inputs will be assigned to that tutor's profile for other stakeholders to view when considering forming a business relationship of his/her own. Educational business connections will have the potential to generate EEs pertaining to PP, PE, and PA. Determination of the capacity to connect may be based on the implementation of a connection filter, outcome, or the nature of potential connections, and/or user decision. Data may relate to potential, past, or active educationally related business connections.

The Integrated Educational Business Networking System 125 identifies which stakeholders have the greatest need for educationally related intervention, and what the nature of said needed intervention may be.

The Integrated Educational Business Networking System 125 determines which stakeholder profiles have the greatest chance of forming an educationally related business relationship based on data also fed from the Educational Social Networking and Collaboration Engine 124 that has potential to be mutually beneficial between stakeholders, based on EEs, especially pertinent to performance and outcome related EEs, educational business services offered, past ratings and performance with respect to statistically similar educational situations, recommendations from other stakeholders, or customizable availability settings.

An interface may be established whereby potential connections can be suggested, requested, communicated, and initiated between stakeholders. Negations and agreement between stakeholder with respect to price/frequency/degree of PN, etc. of services provided may then be facilitated. Said system and method will allow users to foster agreements related to the terms of the new business relationship. At such a point, users may establish relationships that integrate profile connections between stakeholders in order to facilitate the generation of EEs and/or systemic monitoring of interactions after the point where said connections are formed to detect the possibility of the creation of a new EE or the resolution thereof. In addition, data may be fed to other relevant main elements. Rules of proximity, communication, data access, and known potential EE generation protocols to any connection related data, and generate educationally related Events which can be associated with any other stakeholder, and related EEs, performance, effort, or ability calculations, or associated statistical derivatives, and serve to feed such data to other main elements.

Statistical and subjective feedback may be allowable, requested, and advertised in reference to those who provide educationally related business services and their clients whereby EE data may be displayed. Said feedback could be used to evaluate or advertise business service stakeholders as well as integrate stakeholder preferences and thresholds in order to customize the presentation and display of said information to any stakeholder if, for example, an EE were to occur whereby thresholds are crossed. In this case, it might be beneficial for a stakeholder to view who is considering forming a business relationship with a provider and wishes to know how their clients have performed once the relationship has been formed.

Upon receipt of statistical data and its analysis, said system and method functions to search known databases, the World Wide Web, known connections between stakeholders and their associated profile entities, and then conducts an adaptive analysis to find stakeholders of relevant potential educational proximity. The openness of a stakeholder to service connections or advertising of such services could be established in a user's business provider profile, and changed depending upon a customizable menu. For example, a student or parent stakeholder may indicate that they only want to be notified of potential tutors that are available when they cross certain EE thresholds. Educational business providers may only wish to advertise to stakeholders within a certain geographical location, are within the confines of other stakeholder connection limits, or possibly via stakeholder recommendations. Educational business provider profiles will be analyzed as they pertain to business relationship related performance thresholds or to customized parameters whose requirements have been met so that inter-stakeholder connection attempts are automated, or viewable and searchable on a computerized device via the World-Wide-Web or relevant application. The information may be displayed with sorted or ranked results that are prioritized based on user selections or on educational proximity. In addition, it may be possible that a service provider would only be viewable, searchable, or suggested based upon the crossing of a data threshold. Said system and method may also utilize data collected in educator tools to target the needs of all stakeholders, and if the potential for mutual benefit from a relationship exists, said system may suggest that the stakeholder seeks assistance from a provider of relevant educationally related business services.

There are many possible variations of the descriptions above that are able to be described between stakeholders. More examples of the above descriptions could include, but not be limited to, a publisher wishing to provide customized textbooks, services, test batteries, or seminars to a stakeholder who is in a particular class or level, specific EEs, PP, PE, or PA, or Educational Proximity. Another example might include a tutor search only showing business providers that wish to offer tutoring, mentoring, or other services related to a stakeholder as determined by profile information and threshold selections. It may be possible that a tutor search or potential tutors may possibly be suggested only after certain EEs, or combinations of events, occurs. Another example could include a student stakeholder who is struggling and, as a result, adaptively matched with a teacher who wants to offer his or her own tutoring services. In addition, a parent stakeholder who might be struggling to effectively manage the educational state of their child and interested in learning educationally related parenting techniques might be connected to services aimed at coaching them in their interactions with their child. Such a scenario would also potentially result in the generation of EEs related to effort or another measure for said parent. These connections and behaviors described above may be shown to stakeholders as relationships of potential benefit and said stakeholder may be asked to consider forming connections based on search results that are customized based on the greatest probable relevance, relation, and statistical chance of academic success after formation, as well as to establish or suggest connections based on the analysis of educational stakeholder data, EE data, demographic data, and/or social connections, including imported 3rd party data.

It may be possible that business provider information may be viewable to a limited degree on a publicly searchable database. Stakeholders searching the World Wide Web could be shown limited information on a potential match that is displayed after their query for an educationally related service. Examples might include searching for educational product or services such as tutoring, advertising, opportunities, or other services which are specifically related to the perceived needs of a stakeholder. The publicly searchable portion of said system and method may integrate with common Boolean search engines in order to facilitate the viewing of potential educational matches. Results from such a search will be filtered by said system to reveal only specific information that is summative in nature. An individual who is searching on the World-Wide-Web may be able to view statistics on a particular tutor, business, or institution. Said individual would be able to facilitate comparisons between such entities, but will not be able to view statistics on individual stakeholders who may be able to provide a service to them unless they establish an account or a connection between profiles. In such an example, it would then be possible for two stakeholders to initiate a formal contact and possible connection. Such operations could be accomplished via mentioned Boolean search engines, via a front end application, or could be integrated with 3rd party systems.

A service provider may be able to pay a fee to facilitate the unrestricted listing of such services. If a stakeholder were to offer unrestricted access to potential customers via a web based search or application, the educational service provider contact could be made anonymous. For example, a phone number or email address that is actually used to notify a stakeholder who is advertising services might be masked and hidden to prevent privacy violations. The contact could instead be facilitated through the system and method's user interface.

During the facilitation of said interactions, a tutor or service provider may charge for interacting or meeting with a student or parent either in person or via computerized methods. A stakeholder may also wish to provide a product. Negotiation of price can be as simple as a stakeholder accepting the advertised terms of the service offered or through a controlled negotiation communications exchange via messaging or direct contact. Ultimately, once all parties agree to the terms of a business relationship, any stakeholder could manually form the educational business connection via their user profile, or allow the automated connection thereof which could be confirmed by the other stakeholder within their own profile. The formation of said relationship may or may not be viewable by other stakeholders. For example, it would be possible for a teacher to be notified that a tutor and student have formed a connection, and then the integration of their profiles would occur for the purpose of EE generation and facilitating the ability of any stakeholder to track progress to provide relevant information and details to any stakeholder involved in a particular interaction but their friend or classmate stakeholders may not be able to view such information based on proximity rules.

Upon completion of the formation of the connection of profiles, the presentation of communications between, and statistical effect, of their associated profile relationships may be used to generate further EEs. During the course of their profile connection, information would be continuously collected from communications, interactions, EEs, and/or statistical developments. Some examples would include, but not be limited to, test completion, time durations directly and indirectly derived from connections, face-time and contact, frequency data, confirmed meeting times, compliance data, accomplishment of scheduled meetings, analysis of academic performance before, during, and after the formation of the relationship as derived from an alternate stakeholder, such as from data derived teacher inputs which have connection to a student profile, analysis of performance changes, quantity and duration of any task issued from one stakeholder to another, etc. Multiple proximities of stakeholders may be concurrently engaged in order to enable the tracking of progress statistics across proximities. Examples might include, but not be limited to, a teacher viewing or tracking the progress and information exchanged between a tutor and student, and being able to communicate with the student and/or tutor for the purpose of improving the quality of any interaction, and improving educationally related outcomes by providing needed or relevant information. Said information may possibly be fed to a tutor via automated processes.

Following a set period of time or the manual or automated completion and/or termination of a stakeholder's business connections, the data captured could be used by said system and method in order to facilitate a review or evaluation of the services by both stakeholders of services which were provided by an educational business provider. Verification of valid historical connection could be initialized before allowing the review of that business service provider. It is also possible that the stakeholder issuing a review could be anonymously or publicly linked to a particular educational stakeholder. For example, a student or parent could provide a review of a tutor's services, and their profile identities hidden, but the validity of the connection may be verified via internal processes. In another example, connected stakeholder profiles might be displayed along with the review said stakeholder issued if the educational proximity of one of said stakeholders is high or is common to stakeholder of high educational proximity.

The service providing stakeholder could also request a review, if desired, through a facilitated message/request. Educational stakeholders could assist business service providing stakeholders by adding them to a “recommended” provider list. For example, a stakeholder profile could list, in an appropriate display, “Joe recommends this tutor for math”. The stakeholder profile could also possibly facilitate connections by allowing other users they are associated with to view their current or past connections for the purposes of identifying a service provider with whom they have a history. In another example, a student, teacher, or parent could share and display a list of tutors they feel are effective and whom they have had a positive interaction with, which provides links that facilitate communications between a viewing stakeholder and said tutor. A tutor could also request that a parent list the tutor's services as recommended to other parent stakeholders they are connected to, in the event said system and method determines children of their associated parent connections may benefit from the services of such a provider as derived from data on level which is based upon performance, effort, and ability Automated connection initiation could be engaged at a later time if EEs occurred that warranted a potential connection. Users, who viewed the profile of a parent, student, or other educational stakeholder, could be linked to advertised services/business service providers to begin possible negotiations or connection formation.

A review process may be established whereby a stakeholder may release relevant academic records, including standardized test results, subjective commentaries or information, EE data, and/or past performance for the purpose of the establishment of a reputation of such a stakeholder based results an educational business provider may have generated while providing services to a client stakeholder. This would assist in improving instructional efficiency and in allowing a business provider to have a better assessment of their interactions with their clients.

Stakeholders, such as tutors or service providers, may be granted the ability to view stakeholder profile data during the course of their business connection to the degree that the data pertains to the relevancy of the service they are providing. Examples would include, but not be limited to, a tutor being granted access to view the present and/or historical academic performance of a particular student as determined by subject/grade level relevancy, default or user setting, or a teacher providing communications to a tutor that will contain information relevant to their future or current sessions. There might also be a custom field where a user could enter or log time spent on such materials for the purpose of evaluating PP, PE, and/or PA, or any derivative thereof.

This system and method may also serve to provide suggestions and/or guidance for public meeting places, whereby stakeholders who have or are considering establishing a business related connection can view, suggest, and establish a meeting place of mutual convenience. Such connections could be based, in part or whole, on an adaptive analysis of profile data that derives said meeting place from geographical, educational, and statistical proximity data. For example, before formation of a connection, a nearby library or other public meeting place could be searched for and suggested to stakeholders as a potential place to meet for related services. Safety warnings could be issued for best practices related to meeting a tutor, and stakeholders could select options that register their agreement with the place to meet. Reminders could then be issued via profile, 3rd parties, applications, etc., which provide the details of the scheduled upcoming meeting.

There could be an application within said system and method for testing practice that feeds event data to a student profile and is assigned based on identifiable information to be viewable by a tutor profile. Additionally, the use of a computerized device during the course of a business relationship whose identity has been verified and attributed to a particular profile could facilitate data collection when relevant, regardless of user location. Examples could improve data captured from tablets, mobile devices, imaging, and/or audio devices and software.

### Automated Educational Practice, Research, Educational Approach, Recommendations, and Collaboration Engine

The invention processes relevant data and facilitates educational research, which can occur in real-time, and the results of such research can be compared to available hypotheses, theories, as well as available stakeholder data. In contrast, traditional approaches must then be tested for validity, and later implemented in part by only a few stakeholders who desire to test such approaches and whose results may only be debated or used in limited capacity.

The Automated Educational and Collaborative Practice, Research, and Educational Approach Comparison Engine 126 accepts EEs directly from a feed provided from the Common Educational Identity Engine 120 as well as inputs from the Adaptive Educational Data Processing, and Evaluation Engine 121, or any other engine related to the Adaptive Educational Data Processing, and Evaluation Engine. At this point it will analyze the relationships between patterns, short and long term data. Said sub element will then examine Event generation, resolution, efficiency as well as differences in stakeholder approaches. Said system and method establishes “Best Educational Practice” through an objective analysis which may integrate current and past educational philosophy with current and past educational statistical outcomes. Said system and method may analyze implicit and explicit data from inputs, outputs, EE Data, event resolutions, comparative analysis, behaviors, and the analysis of the academic outcomes of any stakeholder or group of stakeholders in order to facilitate the analysis of past and present educational data events as they relate to behaviors, philosophies, EE data points, projected outcomes, and measured academic outcomes, which will have the greatest and least statistical chance of generating targeted goals, outcomes, or improvements in stakeholders. Such a method may also be useful for determining which educational approach is most likely to lead to outcome success or failure, as derived from historical and demographic analysis as well as provide for dynamic philosophical approach differentiation depending upon EE development for any/all stakeholders.

Therefore, “Best Educational Practice” may be defined as the pathway of actions and EEs which is most effective and efficient at leading an educational stakeholder to desirable EEs, EE resolution, the avoidance of an EE, or the best targeted outcomes based upon the given philosophy, approach, needs, and educational data of the profile of a particular stakeholder. Best Practice analysis may collect information from the outcomes of Events and their associated behaviors, and analyze them in reference to the ultimate outcome of EE resolution, or the measurement of an educational stakeholder, through quantification of behavior and inputs, analysis of subsequent EEs, and ultimate outcomes on the data and Events generated by any stakeholder or group of stakeholders, as well as the integration of any subsequently derived data into the assessment of stakeholders and their related or matching EEs. Said system and method will provide for statistical normalization of said data to prevent unfair comparisons or comparisons whose statistical and practical validity is compromised. Said system and method may also examine existing EE data for the purpose of establishing relative or absolute norms and averages in order to establish a baseline of data which is typical for a particular measure. Said system and method may then make comparisons to the approaches actuated or in progress by any/all stakeholders by referencing event data which has already been resolved and logged with the system. Said system and method will determine which educational philosophy/approach an educational stakeholder is currently most aligned with from a behavioral or statistical standpoint, and/or whether or not said stakeholder is consistent with goals assigned to the profile of a particular stakeholder who has already demonstrated a soundness of educational approach.

Data may be fed to and from direct or indirect connections to any other main element. The function of said system and method is to analyze data reported by such elements and their associated sub-elements in order to determine which patterns of educationally related behaviors, practices, and EE data has the greatest and least correlation to the overall performance of a stakeholder or group of stakeholders. Any data derived and captured from all main elements may be used to facilitate real-time research and real time evaluation of educational stakeholders, their collaboration, and professional development through analysis and tools which guide users based on EEs. Such a system and method could encourage the generation, resolution, and/or avoidance of further EEs so as to aim for the generation of data that may benefit any stakeholders that are involved. Said system and method could be used by a stakeholder for self-evaluation, defense, advertising of services, or by educational stakeholders of authority for goal generation, professional development monitoring, and the guidance of disciplinary measures. Said system and method will function to guide any and all stakeholders in the completion of the EEs most likely to result in a targeted statistical outcome, provide guidance on educational paths of most statistically beneficial outcomes, provide feedback on the most efficient means to attain Event targets, and/or the best path to attain statistical equilibrium between stakeholders, and may also evaluate the impact of individual or institutional stakeholder approaches as well as the choices they provide stakeholders under their care.

Therefore, said system and method may utilize all compiled data on EEs, PP, PE, and PA and associated sub-measures in order to drive instruction, professional development, educational stakeholder performance directives, collaboration, evaluations, institutional supervision, and curriculum assessment through derived measures. Said system and method will provide for the tracking of targeted EEs, behaviors, and data sets which could be critical or related to any stakeholder's EEs and Event outcome. Said system and method provides a way for stakeholder practices to be adaptively evaluated in real-time, their practical validity evaluated based upon known outcomes derived from the compilation and analysis of related EEs, and to generate new approaches, philosophies, encourage, measure, and/or evaluate stakeholder collaboration while simultaneously generating development goals, collecting data for the purposes of measuring compliance with required professional goals and obligations, or for the tracking of general professional progress.

The system will also allow stakeholders to claim a particular educational approach or theory, import, or accept the data points they feel or that said system determines are statistically relevant to that approach, and make comparisons of such approaches to similar stakeholder approaches and/or all stakeholder approaches, and possibly for the consistency or variation of approach to be analyzed in comparison to claimed approaches and/or known educational approaches. Such analysis could be completed in part by communication between the Automated Practice, Research, and Educational Approach Recommendation Engine 126 and the Stakeholder Reporting and Comparative Analytics Engine 127. Said system and method further collects and analyzes related data to evaluate longitudinal histories of stakeholder success and failure in terms of approach and style and re-evaluates and possibly adjusts recommendations in real-time for greater accuracy as new data becomes available. Said system and method may allow stakeholders to enter or claim an existing philosophy and attach it to their profile, in order to identify the intended orientation of their educational approach. Said system and method would then determine the default EEs, timings, and sequences which are most consistent with said approach, and provide feedback and suggestions for proper alignment with said claimed philosophy or approach. Said system and method could also analyze any/all other educational approaches or stakeholders and determine where on an educational philosophy spectrum a particular stakeholder lies in comparison to their claimed/actual educational philosophy/approach. Consistency of approach and alignment with claimed philosophy could indicate the accuracy of meta-cognitive processes of the perception an individual may have regarding his/her own instructional delivery within the classroom, or of the educational state of philosophy a stakeholder is currently operating under, and allow said stakeholder to analyze and demonstrate a consistent understanding of the principles involved.

Said system and method may also allow for the generation of new philosophies based on captured data. Said system and method could evaluate the effectiveness of educational stakeholders claimed or actual approaches in reference to available data and feed said data to a derived instructional and educational practice recommendations system and database in order to facilitate the generation of suggestions for improvements to such a particular approach for a particular stakeholder or group of stakeholders, or make suggestions for the adoption of another approach given current data. In addition, said system and method could dynamically adjust philosophical or approach tactics as new Events occur, and provide feedback on the level of impact that collaborative communications and idea exchange has on stakeholder statistics.

Said system and method then functions to reference stakeholder data and EEs in order to provide real time feedback via analysis of data derived from EEs, Event clusters, PP, PE, and/or PA and associated sub-measures, in reference to the actual educational practices a stakeholder employs, the consistency of Event execution and avoidance, the consistency of alignment with a particular claimed or unclaimed educational philosophy, or the practices a stakeholder should consider employing in order to foster the best chance of academic success for educational stakeholders under their care. Said system and method, therefore, eliminates the need for costly and delayed research methods which often result in data that is sorely lacking in in the ability to account for a variety of confounding variables, and would be very costly to implement systemically. Said system and method will accept EEs, inputs, and data feeds from the outputs of any other main element and categorize, prioritize, quantify, and qualify said information, and perform higher level correlation and aggregated analysis of the data collected, adaptively and dynamically analyze it, and feed it to other main and sub elements where necessary, for the eventual analysis of EE data, and event outcomes in relation to stakeholders and the practices they employ. Subsequently, the facilitation of the global and collective analysis of EEs and their sub-measures that are associated with any/all educational stakeholders will occur in order to establish high level thresholds and averages for implicit and explicit data points. A data consumer may then feed data to any other sub element as needed or relevant to that element. In effect, all high level aggregations of EEs will be compared to all known EE outcomes and data on educational philosophy and will be compared to stakeholders currently engaged in educational practice in order to provide meaning and context to their practice. Analyses may be longitudinal or short-term.

Said element can therefore identify the instructional practices which are most effective in true educational practice, and adaptively apply such results to data comparisons between system-captured data and any/all stakeholder data, or between groups of stakeholders. Comparisons could be automated or implicitly/explicitly derived. In one example, as described in part in FIG. 18, educator stakeholders may claim a particular philosophy and then be compared to other stakeholders who claim a similar philosophy or against EE cluster sequences identified to be ideal or most consistent with a philosophy. Identification of those stakeholders who experience the greatest level of successful outcomes for stakeholders within their educational proximity and care may then be utilized for the facilitation, the generation, or the sharing of educational practice recommendations (for example, “when you had a student like this. ______ approach worked 85% of the time.”), via a system that constantly monitors and updates when new data is received. Such information could be made available based on general terms, or targeted to profiles of stakeholders who claim to, or whose outcomes demonstrate they actually do engage in a similar approaches it may also be possible for stakeholders who wish to improve or evaluate their own practices in light of other stakeholders who are or have enjoyed success. For example, a stakeholder may view the behaviors and approaches that work for similar stakeholders to the ones under their educational care. Said system and method may therefore shorten the length of time needed to research and report on educationally related findings, avoid costly curricular testing, decisions and mistakes, and conserve revenue by providing stakeholders with real time data on truly effective programs, approaches, and practices. Said system and method would also allow stakeholders to receive targeted updates when EEs of curricular impact occur and allow for easier real-time monitoring of stakeholders under their educational care.

Evaluation of short and long-term outcomes from EEs may be used to further delineate differences between shorter term, and/or longitudinal outcomes by comparing patterns that are captured by pattern analysis, and subsequently analyze stakeholder outcomes in order to identify the data clusters of stakeholder outputs and data points that lead to the EEs of highest and lowest positive impact in the short-term and/or longitudinally, or that more reliably or efficiently lead to higher level EE outcomes for involved stakeholders. The results of such evaluations will be correlated, aggregated, ranked, compiled, and facilitation of their delivery to relevant stakeholders will occur in real time. The evaluation engine will seek to establish a more refined analysis of the most statistically significant short and long term practices that will lead to desirable outcomes. Identifiable stakeholder behaviors and practices both in the electronic environment, as well as within the classroom setting, will be correlated and compiled in a spectrum of approaches.

If a particular identified approach is not associated with a philosophy said system and method may then assign an identity to said approach as a compilation of the EEs that a stakeholder should strive for to attain an ideal statistical situation given current stakeholders under their care. The short and long-term analysis will then identify the specific stakeholders associated with such outcomes, typical profiles, and the types and EE sequences which have been captured and assigned to their profiles in order to facilitate the analysis of the best statistical route which is likely to lead to positive outcomes given the current EEs and the approach of a particular stakeholder. EEs that appear to have the greatest reliability or likelihood of stakeholder outcome success would be fed, displayed and/or suggested at a higher priority than other recommendations in order to facilitate the most efficient and best possible outcome for any/all stakeholders involved. Results of short and long term analysis will then be fed to any other main or sub element.

Stakeholder evaluation and data integration methods may analyze data from any/all EEs linked to stakeholder profiles for identification, or correlation between any/all EEs that may or have been logged in the stakeholder's profile, and their relationship to patterns that approximate those identified by said system. Said system and method will compare data as it is captured to currently existing data. Evaluation will consist of a comparison of stakeholder data to known outcomes, and an analysis of the patterns of highest likelihood of successful outcome or event generation/resolution as determined by a micro or macro analysis.

### Real-Time Recommendations

Derived instructional and educational practice recommendations as a result of analysis of EEs will determine which EEs are the best targets between selected educational stakeholders. Analysis would engage Educational Stakeholder clusters which have high educational proximities, and compile the EEs between each of them which seem to be the best targets to benefit one or more stakeholders within that cluster. This recommended EE list would dynamically change as new data is captured, and essentially consist of a compilation of the best practices a stakeholder is recommended to attempt to complete as demonstrated by EEs that are most relevant, or which are highly recommended to pursue given the current state of all educational stakeholders of relevant educational proximity. Said system and method will determine the theoretical statistical path most likely to lead to stakeholder success, and feed said data to a Goal Generation, Evaluation, Tracking and Monitoring engine which will assist in the generation of a passive or active plan of engagement between stakeholders.

Said system and method will be able to facilitate EE driven goal generation, evaluation, tracking, and monitoring based on data from the output of derived instructional and educational practice recommendations analysis, and subsequently generate a plan of approach for any stakeholder as related to EEs, their generation, resolution, or their avoidance. Said system and method may then present such findings to stakeholders via an interface in an effort to guide their educationally related choices, and approaches. Said system and method will constantly reevaluate the progression of identified goals in comparison to the actual pathways and outcomes captured from all educational stakeholders, and facilitate communications via an interface where said stakeholders may keep informed, log information, or communicate and interact based on analyses. Said interface could also allow goal creation and sharing between stakeholders as well as the ability to accept or modify the goals based on other variables not detected by the system. Such recommendations could be presented in their totality (i.e. at the conclusion of a quarter, school year, or institutional marker, etc.), or where appropriate, during periodic intervals determined by stakeholders or their supervisors. In addition it may be possible to exclude the generation of a goal if a stakeholder is determined by said system and method to excel in that area. For example the system may prohibit supervisory stakeholders from generating goals in categories a stakeholder under their supervision consistently generates excellent or above average EEs for. This would prevent subjective and unfair goal management and ensure fair treatment for all stakeholders.

Examples of the above scenario would include presenting recommendations to a teacher stakeholder when they are viewing information related to a student stakeholder, class, or profile which is relevant to an educational or professional goal or related EE. It is also possible that a stakeholder of authority could use such data in order to develop a progress/development report or plan and submit such a report or plan to educational stakeholders of appropriate educational proximity for review.

Acceptance or denial of goal report or plan would by default determine those EEs which are applicable to a stakeholder and of highest priority to a stakeholder or group of stakeholders. This would allow educator stakeholders for example to self-guide their own professional development by using the system as an assistant and/or stakeholders of authority to direct staff in real-time, in EE goals, and the execution of said goals in real time, while simultaneously providing real time feedback. It would then be possible to facilitate the monitoring, the attainment, or the completion of EEs related to said recommendations, as they occur in real time, and repeatedly adjust and evaluate recommendations based upon Subsequent EEs.

As a means of generating EEs related to interface and collaboration, said system may also utilize a calendar and/or “multiple calendar” system feature where a stakeholder can share and view his/her calendar and calendar items alongside or overlaid with another calendar which belongs to another stakeholder. This could allow a user to set and share calendar events, or EEs relevant to any stakeholder, log and verify collaborative efforts, establish amicable time frames for completion of EEs, planning for units, sharing and synchronizing calendars with related stakeholders. As an example, student stakeholders could engage in peer tutoring connections based on parameters like current/past performance and commonality of schedules, or the matching of a perceived strength with a perceived weakness could be another collaborative feature available to leverage the use of data related to EEs in a collaborative way. In another example, a student with perceived need/weakness may be issued suggestions by the system of peers which wish to help other stakeholders and have a perceived strength in this area. Furthermore, a college professor may potentially use perceived strength in the selection of teaching or research assistants. Peers who issue assistance may generate EEs beneficial to any measure which can ultimately be linked to leadership, service oriented tasks, or to EEs relevant to compliance with related goals.

An EE-based project management suite engine may allow the facilitation of individual, group, class, or club projects that are capable of generating EEs, while simultaneously facilitating the logging of information on task time, contribution percentage between stakeholders, persistence in project engagement as measured by login frequencies, times and frequencies of behaviors, actual behaviors, percentages of original work contributed, and other measures of stakeholder contribution to a particular task which would be vital in calculations of PP, PE, and/or PA. For example, a teacher stakeholder could assign a group paper and could receive a paper that was completed by two individuals and view said paper as it appears, or view sections of contribution from each student as well as associated data such as time spent, distribution of workload, etc. Effort data could be derived and possible PE Events generated. Private communications from project participants and associated data may be utilized to generate EEs.

### Stakeholder Reporting and Comparative Analytics Engine

The invention provides objective and balanced information on the professional or educationally related strengths and weaknesses of a stakeholder as it pertains to PP, PE and PA. This information will feed data for the continued analysis of future professional development goals, may be used in reward or incentive based or in disciplinary approaches, or in the execution of a defense of a stakeholder's educational practice. The invention alerts stakeholders of their perceived trajectories through the Stakeholder Reporting And Comparative Analytics Engine 127.

The measures of performance, effort, and ability (PP, PE, and PA) would be disclosed either privately and/or publicly, and may also integrate with third party systems to assist in analysis facilitated by the capture, aggregation, and feeding of said third party data to and from their own systems according to the specifications of an interface between third parties 111 and the Common Educational Identity Engine 120. This will allow for the communication between said systems so that data from outside parties could be received processed and EEs and other analyses could be generated, and fed back to said third party system 111 for display, analysis, and possible looped or cued processing.

Perceived Trajectory might be defined as an indication of EE and/or PP, PE, or PA outcome direction based on derived analysis of captured data points and EEs to indicate where stakeholders are currently tracking in relation to best practice given their historical performance patterns as well as the approaches currently and most probably related to stakeholders they have high proximity to, and to analyze the consistency of their approach to baseline patterns which are determined to be most related and most ideal.

Through the Stakeholder Reporting And Comparative Analytics Engine 127, a stakeholder may be able to generate a “Defense of Practice” report which aggregates and presents data in a visual and/or auditory way which is relevant to their overall performance in relation to their peers or to stakeholders of relevant educational proximity and execute a statistical analysis of any/all EEs which are relevant to the scope of an evaluation, and possibly present a case for why certain stakeholders under their care should or should not be believed if they are issuing accusations, considered in assessment of professional practice, or to provide objective data given a particularly contentious situation. Furthermore, it might be possible to indicate the purpose of the defense of practice initiation so that said system and method could customize the compiling and presentation of relevant data that is targeted to the reason for the initiated sequence. For example, a stakeholder of authority could request and/or present data relevant to why a particular educator stakeholder should not be considered during statistical evaluations of his/herself. This would be appropriate in termination discussions, as well as disciplinary proceedings, probationary agreements, etc. Additionally, by using EEs and data on PP, PE, and/or PA a stakeholder may make a statistical case as to why a student or group of student stakeholders should not be included in assessment of their performance as an educator. For example, a student being frequently absent from class, or who demonstrates abnormally low PE or PW scores may receive abnormally low scores on standardized or other evaluations and it may be unfair to assess a teacher based on a lack of participation in the educational process. The invention allows a stakeholder to present evidence and make a case for the exclusion of data pertaining to such a student in their evaluation.

Therefore the invention allows a stakeholder to present analysis of relevant stakeholder data which has higher validity in the evaluation process as well as statistics on any measure of the three main branches of stakeholder assessment or their associated sub-measures. This data driven defense of educationally-related practice may also allow the stakeholder to present relevant research or information relevant to the logic of an educationally related practice or approach which was engaged in, allow for the objection to inherently unfair policies of unreasonable supervisors, demonstrate effectiveness of teacher or administrator stakeholders despite depressed student performance and scores overall, pursue or defend against disciplinary measures, or study and track areas of statistical concern.

Analysis of stakeholder effectiveness and the presentation and display of such information can be automatically generated as a means for a stakeholder to provide relevant data during a review of his/her performance, by creating an environment whereby a stakeholder is able to present data relevant to their performance and assessment by generating a summary of their data and data relevant to stakeholders from Jigsaw or Jigsaw Ghost profiles under the educational care of that stakeholder, and/or a stakeholder of high educational proximity, such as a student.

One example of this applying to an administrative stakeholder would be the presentation of data pertaining to Events generated by their staff before and after the addition of their supervisory role. Another example would be analyzing the existence of statistical shifts in student stakeholder educational outcomes under the care and proximity of another educational stakeholder, thereby indicating their effect on institutional culture, etc.

The generation of an EE of a positive nature could serve as a gateway for progression into a next level of study for a stakeholder, allowing that stakeholder to progress at his/her own pace (i.e. differentiated instruction). Educator stakeholders could operate through an interface whereby lesson plans are created and imported along a continuous linear or multilateral path which may draw upon material generated by a current and most proximal teacher stakeholder, for example, or may draw upon the material generated by a teacher stakeholder of similar profile and whose data is reviewed in part by a current educational stakeholder. Said teacher stakeholder may then be permitted to establish EE gateways or thresholds for passing to the next lesson or the next portion of the lesson. For example, several lessons may be linked, and at the beginning or end of each lesson or task an EE threshold relating to Performance or effort might be established (e.g. setting that a stakeholder must obtain a performance level of a certain percentage of questions correct before moving to another task). Such an approach allows many student stakeholders to occupy the same physical space in a building, but to operate in drastically different academic capacities. Such an approach could be derived by analysis EEs, their resolutions, patterns of performance improvement and regression, analysis of the most and least effective EE resolutions, and their measured and derived educational outcomes.

Therefore there may be the real-time facilitation of “Data Driven Instruction” for any stakeholder on an individual basis. In one example, incorporation of summative and adaptive evaluation of current stakeholder practice, concurrent with an examination of student stakeholder effort will assist in determining the validity of an educational approach. It would also provide said system and method a means of showing a teacher stakeholder approach options and their likely success on a continuum, and provide suggestions for courses of action for that teacher which are customized and prioritized based upon the urgency of the EEs that are associated with the recommendations.

Educational approaches may not be deemed to be invalid if poor performance is a function of the effort applied by a student stakeholder. Therefore, adjustment to the measure of any stakeholder which accounts for stakeholder engagement may be feasible. It would be possible to exclude student stakeholders who do not exhibit proper effort or engagement in the educational process as relating to a particular evaluation of a particular approach or likewise to include specified target levels of engagement or effort as well where effort overall may not be the focus of said evaluation. This may be done by including measures of PP, PE, PA, and/or PAw as well as PEng to give more accurate measures of stakeholder approach.

The invention facilitates the linking of performance, effort, and ability data, profile data, EEs, and patterns of EEs with professional development goals and activities and professional practice evaluation. Development oriented analysis which tracks relevant EEs, inputs, outputs, implicit, and explicit data, may tabulate such measures. Said evaluation may occur within the scope of any measure of EEs, evaluation of overall effectiveness, competency, the attainment of goals, or possibly professional obligation benchmark achievement. Another example might include, but not be limited to, said system being able to make application not only to teacher stakeholders, but also to parents, where participating in a certain event aimed at increasing their level of parental development and/or educational stakeholder competency would positively affect their PE, PP, or if, for example, they were able to assist their child stakeholder improvement after the above described events, their Perceived Effectiveness might increase. Another example might be applied to student stakeholders, where time spent in a collaborative environment may be facilitated within or monitored by said system, and their participation in it through the analysis of real or potential EE measures, in addition to typical measures. Collaborative tools can facilitate either creation or generation of an EE related to EE data, whereby collaborative behaviors and measures between stakeholders can be captured, stored, and analyzed in order to derive and present potential professional development goals, and future EE data goals, or to provide performance feedback which is or has yet to be established for a stakeholder.

An adaptive approach could be executed to study and analyze EE occurrences, and integrate implicit and explicit data to facilitate the analysis of the effectiveness of any measure applied to an Event. For example, a statistical analysis of any and all user responses and interventions when faced with a particular EE may be conducted in order to identify the best methods for approaching, resolving, generating, or avoiding said Event. Analysis may be applied to instructive practices or Event resolution/avoidance, and any stakeholder may be provided feedback with the information and tools needed to implement “Best Educational Practice” given the results of a particular EE analysis. For example, the system and method could tell a stakeholder the best response or the best possible responses to a situation based on the experience of other users and possibly provide statistics for informational purposes. In addition, said system and method may further analyze EEs to continuously update derived evaluations of the practices employed by educational stakeholders. This may be accomplished independently of the educational philosophies they engage in either consciously or unconsciously. Data derived in this manner could be used to guide educational and collaborative decision making, and guide educational practice approaches as well as provide for analysis, defense, and evaluation of instructional delivery.

The invention may automate the suggestion of said plans of action for EEs based on statistics which prove most effective or efficient, at producing a positive response in performance, and a user may be permitted to select from a customizable menu which is then tied to stakeholder communications and interfaces. Therefore the automation of custom action plans could be recommended to resolve, generate, reverse, or avoid an event and its impact on stakeholder performance. As an example, an EE could lead a teacher to suggest two actions to an associated student stakeholder that would generate an EE which would result in a positive outcome. Future communications between stakeholders and within their profiles would display and/or issue messages detailing these suggested actions until at which point event resolution or escalation is attained.

Stakeholders may be evaluated either based on short-term or longitudinal analysis of EEs. For example, the system could analyze the difference between a lifetime rating of a stakeholder, and the current academic state of a stakeholder. This could provide for indirect measures of intrinsic or extrinsic motivation, and allow for the ability of a stakeholder to demonstrate behavioral patterns in response to current statistics in contrast to historical performance either within the context of specific coursework, or within the context of overall performance measures. Said analysis might be quantitative and/or qualitative in nature so as to be able to not only show numerical data pertaining to trends, but also to allow for summative behavioral analysis. Additional quantitative rewards could be associated with trend changes and could be standardized or limited by said system or another stakeholder.

Professional goal and progress indication may be executed through the monitoring of the professional development-related EEs of any stakeholder. In addition, an automated notification system which sends information to, and is related to other stakeholders as certain thresholds and goals are attained, could serve to act as encouragement to stakeholders who are monitoring, or need to be aware of their goals, and point out EEs or likely EEs that may be relevant to their goals. For example, if “greater collaboration” were a goal established by a stakeholder or a supervisor stakeholder for that stakeholder, the system may track the frequency and duration of contact between stakeholders of relevant proximity throughout the following school year or an agreed upon period of time. Subsequently, said system and method may report overall progress to any stakeholders either in real-time or by summative and scheduled means. Said system and method could also identify opportunities to fulfill this goal and adaptively present them to relevant stakeholders in order to assist in their successful completion. As another example, if a goal is to “increase efforts with marginal students,” relevant EE data can be tracked and compared to past data for progress indication and prompts can be sent to a stakeholder when opportunities to accomplish such goals are present. For example, the system and method might associate the next occurrence of a student stakeholder on the verge of failing a course as a viable target to assist in the satisfaction of said goal and therefore the generation of a relevant EE. Said system and method may then notify said teacher stakeholder of the opportunity and provide prompts needed to satisfy such anticipated data capture. Such items could be flagged by a stakeholder as related to said goals for manual tracking and logging of information and could be reported as they are completed to stakeholders of authority. Said flags may or may not be approved by a supervisor stakeholder depending upon the conditions set for the goal. This system and method provides a stakeholder with a means of setting goals for instructional and educational practice that are based upon EE data and statistics, and facilitate the adaptive and real time monitoring of progress in these goals, therefore providing stakeholders with key performance indicators aimed at improving overall instruction and guiding the completion of present and future educationally related goals.

Institutional Stakeholder Reporting and Further Analysis might be facilitated by the Stakeholder Reporting and Comparative Analytics Engine 127 in order to present data on entire institutions of learning and to possibly allow the public or the institutions themselves to search and research data contained within the system based on desired measures. Such information would be valuable to researchers and in the selection of residence based upon the school or school district as a factor relating to PP, PE, PA and or associated sub-measures. Said system and method facilitates and executes an EE-based Systemic analysis and protocol, which may be publicly or privately viewable and searchable, via a systemic database that accumulates data derived from the said engines, aggregates, correlates, integrates, and presents such data to users wishing to view or make comparisons of educational institution statistics. Systemic analysis and reporting based on aggregated stakeholder data will allow users to compare institutions of learning based upon the real behaviors of stakeholders within that institution and with customizable, and/or EEs-based parameters. The structure consists of an engine which collects and analyzes all data from all engines/elements and their sub-features/elements and subsequently aggregates and analyzes geographical and demographic data.

Said engine utilizes EEs to report on macro-based statistics which are implicitly and explicitly derived from stakeholder profile data, and appropriately forged into anonymous data reports connected with other main elements. This element is connected to, and derived from any educational stakeholder, aggregate group of stakeholders, institution, or group of institutions through the lifetime of a user profile. Said data may be publicly searchable or fed to 3rd party applications or Web, Client servers or composite front end applications.

Said engine may adaptively correlate and aggregate groups of stakeholders based on common elements or similarities that are present based on statistical analysis. This system and method may be able to compare institutions either globally, or by the generation of clusters of statistically similar peers. This will provide a means of statistically balanced comparisons. Statistical peers may not have geographic or other obvious relation but may share analytic traits and/or have a high correlation of statistics in common with each other. Examples may include, but not be limited to, two institutions not located in the same State but having similar stakeholder EE data when analyzed as a whole or in part. Another example might be two teacher stakeholders not sharing the same schools or discipline, but who each operate out of similar educational philosophies, EE generation patterns, or educational practice outcomes. Said Sub element will comparatively analyze stakeholders across any level of EE, demographic, philosophical/approach, general, or targeted institutionally-based comparison in order to facilitate the objective comparison of educational stakeholders on levels of similarity not previously possible.

Said system and method, therefore, may function to evaluate educational institutions as well as groups of institutions in order to provide publicly and privately available comparative analysis via the World-Wide-Web and/or computerized devices that provide an interface useful in comparisons of institutions of learning. Event outcomes as they relate to stakeholders profiles may be aggregated to represent stakeholders at the institutional level. Said element will perform higher level correlation of the data collected and quantify and qualify said data through implicit and explicit methods, in order to facilitate the global and collective analysis of EEs and their sub-measures that are associated with any/all educational stakeholders.

Said system and method might compile data based on stakeholder clusters, and form an evaluative report based on the institution in which said clusters of stakeholders are perceived to practice or participate. Such information could also include data from peripheral stakeholders such as educational business providers and/or tutors who may not always hold highly correlated geographical relation, but who may have statistical impacts on stakeholders of that particular institution. Data derived from the aggregation of all stakeholders currently and previously associated with said institution may be used to form a representative profile of said institution. For example, an institution which generates consistently high EEs overall pertaining to PP, or PE may be labeled as a “High Performance” or “High Effort” or “High Stakeholder Participation” school. Users might be able to filter schools based on such parameters. Said system and method may also function to generate longitudinal, short term, conditional, and comparative reports which can be customized by any stakeholder wishing to compare and evaluate the longitudinal and historical quality, the nature of the institutional environment, and performance of educational institutions. Said system and method allows for the direct and derived comparisons of clusters of educational stakeholders, and/or educational institutions via a lifetime data evaluation related to direct and derived data statistics. Comparisons to and between clusters of related stakeholders may include geographical parameters, and the presentation of analysis between educational institutions or groups of institutions via an interface. As an example, a public user may be able to view EE derivatives such as “Perceived Parental Support”, or “Perceived Average Institutional Effort”, for a particular neighborhood, or district or school, for example, with or without personal information related to stakeholders from which such information was derived being revealed. For example, if a stakeholder were considering buying a home, they may use said system to view the educational statistics of said home's geographical area to ensure the educational attitudes of the parents in said neighborhood match their own ideals or that the schools their children will be attending are perceived to have adequate staff support behaviors.

Said system and method may then provide an interface whereby users can view general statistics or targeted statistics either within or between educational stakeholders, or possibly institutional-level stakeholders. The Stakeholder Reporting and Comparative Analytics Engine 127 may be optimized for searches conducted either on a web-based computer, 3rd party system, application, or a Boolean search engine. Data will be appropriately private and processed for searches that are publicly viewable on the World Wide Web, yet still protect individual stakeholder information as appropriate. Data will be filtered to reveal only information that is summative in nature in order to conceal personal data or data that is inappropriate to allow for public viewing. Examples might include, but not be limited to, an individual who is searching on the world wide web may be able to view statistics on a particular institution, or possibly facilitate comparisons between institutions or their departments, or event defined geographical distributions such as a town or block, but may not be able to view personal statistics on individual stakeholders unless they establish an account, or unless they establish a proximity between user profiles.

Systemic interfaces for users or 3rd parties could be used to foster comparisons either between schools, levels or districts, counties and/or states. Such data may also have value in research and matters pertaining to the consideration of the educational system and its structures and institutions. Said system and method may also include the use of data derived from Government or Educational institution data, statistical analysis, social and educational business networking, or other 3rd party social networks to evaluate the impact stakeholders have on students indirectly and directly, provide comparative statistics for evaluation or defense of practice, and facilitate analysis of educational practice and the generation and tracking of professional development goals. Another variation of said system and method would be the use of EEs to derive data-driven individualized instructional methods, protocols, and engine. Through the analysis of EEs, and their associated resolution patterns, it would be possible to facilitate, direct, and/or automate instruction of educational stakeholders using data as it is captured. Instructional approaches, tasks, or curricular placement and decisions could operate under the governance of said system and method. Such an approach may use EE benchmarks as a way to drive instruction within the context of a particular educational approach, as well as to provide guidance for coursework, enrichment, and remedial selections. EEs indicating weakness could result in remedial action recommendations aimed at producing EEs that increase performance, and that correlate to the level of a stakeholder or occurrences of particular academic difficulties a stakeholder is experiencing.

Said system and method would facilitate the use of customizable statistical and graphical presentations of data, in order to communicate EE interpretations to stakeholders, or for the presentation of data to any educational stakeholder, and may provide for the ability of any stakeholder to identify behaviors and events which impact their ratings the most. As an example, once said system and method has captured, transformed, and translated data for a stakeholder, said system and method might then provide interpretations and guidance for a stakeholder at appropriate times and levels during the course of user interface with software or hardware related to said system.

In addition, said system and method could aggregate and correlate all relevant data to provide an engine for longitudinal studies and analysis. A user interface could be provided whereby public or private users could conduct their own research based upon parameters they select and analyze relevant data in the system database. Said system and method may also analyze institutions through the association of educational approaches and instructional structures and course offering with data on EEs and outcomes. This would facilitate the data driven facilitation of institutional structural analysis which may lead to reorganization or fine tuning to best meet the needs of their stakeholder population. Said system and method would also function in course customization through the analysis of events, aptitudes and trajectories in reference to the current and past coursework offered by an educational institution, make short short-term and long term instructional or structural recommendations, and be used in longer term decisions such as course eligibility, staff assignment, or course selection/recommendations. Examples of short-term recommendations could be guidance within the class setting of a course or the potential necessity for supplemental material. Long-term, Event-based recommendations might be related to teaming of stakeholders, structures of curriculum, and matching of stakeholders such as students with stakeholders such as teachers based on data related to performance, effort, and ability. Within education, said system and method could be used to help make specified decisions within educational contexts in special education settings, make, set, or determine internship, club, class, and grade eligibility, determine higher learning institution enrollment eligibility, student recruitment by higher education institutions based on PP, PE, and/or PA and/or allow such institutions to set requirements for participation in education related courses or activities. It may also have great value in providing real behavioral data that is consequential to diagnoses such as ADHD, etc. rather than the reliance on subjective reports.

Once sufficient data has been accumulated on a global scale, it would be possible to realign educational institutions internally to increase instructional relevancy, efficiency, performance, and accountability for all stakeholders, as well as to guide, using data, the construction of the internal mechanisms that educational institutions should employ in order to maximize positive effect for their educational stakeholders. Examples could include structures which allow stakeholders to learn at their own pace from the pre-K to college level, or the alignment of coursework with the intended career of a stakeholder in order to eliminate extraneous learning. Multi-level classrooms which are manageable by one or two teachers would be feasible if curriculum were sufficiently constructed to provide for the controlled progression of students. Additionally home schooled and/or home learning could be facilitated for students needing an alternate setting while still allowing for standardized measures of comparison and for high standards.

This method and system could be enhanced through use within the context of encouraging student focus and performance by making use of interactive informational displays on a student's mobile device in the form of oral, visual, and textual presentations that remind, encourage, or assist educational stakeholders in the generation of targeted EEs outside or within the environment established by software associated with said system and method and the world wide web. Heat maps which indicate in real-time how stakeholders are performing could assist stakeholders in controlling their own behavior or identifying stakeholders of concern.

It would be possible to make use of infrared, imaging, audio, GPS, wearable or portable hardware, and/or laser technology in order to track in-class behaviors and synchronize data that is captured with user profiles. One example would include, but not be limited to, use of a hand held or worn device within the class setting that can capture or register data by registering with a button push, screen action, connection made by three dimensional association such as two devices pointing at each other registering a hand raise (one from the hand of a student and another from the hand of a teacher). Other examples may include, but not be limited to, a teacher stakeholder using a hand held device that can be pointed, at or in the direction of, a student stakeholder, that stakeholder's identity confirmed, and an EE being transferred to that student stakeholder's profile, or logged into the device for later transfer. Additionally, vocal signatures could be generated and used for administrative tasks such as attendance, as well as audio/visual sequencing of behaviors within the classroom. Another example might include designating a homework check scan where a teacher can point a specific or mobile device at students, and when their identity is confirmed, a button pushed to confirm or deny the completion of homework and subsequently log data and generate EEs to their profile. This would speed administrative tasks within the educational setting and increase data capture accuracy. Hardware could be mounted on or in a stakeholders desk for data collection, and/or to the sides of a desk or chair or possibly the back to confirm data points detected by another piece of hardware within the setting. Hardware could also be mounted directly on a stakeholder. Confirmation certainty and strength of a detected event could be used by using multiple pieces of hardware within a classroom to confirm an event through methods similar to triangulation or concurrent registry of said data in order to eliminate mistakes and increase EE accuracy and EE assignment accuracy or to omit nonevents.

It could also be possible to use continuous or punctuated scans of a classroom or group of rooms with similar populations such as teachers on a team which share students in order to identify user baseline behaviors, and identify targeted behaviors, or behaviors whose occurrence is generalized or specific, or is outside of typical behaviors for a particular stakeholder or group of stakeholders.

As another example, displaying attendance prompts for a teacher stakeholder at the time of a scheduled class would facilitate easier collection of effort and performance data that would ultimately be used to generate Educational Events, which may lead to calculations related to attendance, time on task, behaviors, etc. Such settings could be based on the time, schedule, historical behaviors of a stakeholder, significant life event, days off for various reasons, etc. of a particular stakeholder and inclusive of any stakeholder. The invention presents a stakeholder with critical alerts relating to Educational Events, or will automatically navigate through any pathway which will safely reduce the inputs needed from a stakeholder or efforts of a stakeholder needed with respect to record keeping.

Another example of increased efficiency might be prompting an educator to take attendance based on stakeholder detection, the absence of detection, or via imaging/audio/video inputs relevant to the classroom or a course, and/or the time of beginning and ending of the class or lab, etc. Another example might be highlighting Education Events of concern and suggesting possible effective responses that will impact other stakeholders said stakeholder is connected to. Another variation of said system and method would be year to year transcription of lesson planning with inclusion of calendar days of significance and relevant Educational Event alerts. The invention is not limited to only schools and the educational industry. The invention can be incorporated into applications for mobile devices, classroom based hardware and software, and for use as data processing for 3rd party applications. In addition, business settings that are outside of the scope of education could adopt the method of data analysis and capture within the context of a business or office environment in order to properly and objectively measure the PP, PE, and PA of their employees. Connections to behaviors within the office, performance measures determined by employers, and other parameters could be established in order to facilitate the automated measurement and guidance of all employees and management. For example, if a business wished to target behaviors or data inputs and outputs they felt were adaptable to the invention, a business would be able to use the invention to guide and measure it's associates, interpret the meaning of data, and generate “Business Events” which are similar to EEs. Furthermore, they would be able to provide meaningful transcriptions and translations of data in order to provide meaningful feedback to workers on how they can improve their practice. Examples could include, but not be limited to, determining base lines for behavior for employees while on the job, for example routine behaviors or activities, capturing them as data points (for example, the number of times an employee makes a regular rotation while on the job, or the number of times they complete a particular task, or the nature, frequency, meaning etc. of the task) and then convert such measures into gauges of effort, engagement, performance, ability, etc. Such an approach could be facilitated by the invention and customized for 3rd party business oriented data exchange and could be used for evaluations of performance benchmarks of promotion, etc.

We claim:

1. A process to evaluate the performance of a first individual comprising:
collecting behavioral information relating directly to the first individual using motion sensory and audio-sensory equipment connected to a computer and converting the information into data;
compiling and analyzing the data using algorithms on at least one computer to calculate performance measures for the first individual based upon the behavioral information collected and converted into data; and
generating an output reporting the resulting performance measures.

2. The process according to claim 1, further comprising collecting numerical scoring data on the first individual, prior to compiling and analyzing the data using algorithms on at least one computer, to calculate performance measures for the first individual based upon the information collected and converted into data.

3. The process according to claim 2, wherein said performance measures comprise a Perceived Performance, a Perceived Effort, and a Perceived Ability and wherein said Perceived Ability is a ratio of said Perceived Performance and said Perceived Effort.

4. The process according to claim 3, wherein said Perceived Ability is calculated based upon a Perceived Ability Relative (PAr) relative to a Perceived Effort determined as PA=(PAr−(PE−100)).

5. The process according to claim 1, wherein the first individual is a student in a classroom.

6. The process according to claim 5, wherein the behavioral information includes at least one of a raising of the students hand, the answering of a question, and presence of the student in a seat.

7. The process according to claim 1, wherein said analysis of said data includes statistical analysis using algorithms to determine if an Education Event has occurred.

8. The process according to claim 7, wherein said Education Event is determined to have occurred if analysis of the data determines that the data exceeds predetermined thresholds.

9. The process according to claim 8, wherein said predetermined thresholds are calculated using the data and algorithms.

10. The process according to claim 8, wherein said generating an output reporting the resulting performance measures further comprises the reporting of the occurrence of an Educational Event.

11. The process according to claim 1, further comprising:
collecting behavioral information relating directly to a second individual using motion sensory and audio-sensory equipment connected to a computer and converting the information into data;
compiling and analyzing the data using algorithms on at least one computer to calculate performance measures for the second individual based upon the behavioral information collected and converted into data for the second individual and also based upon the performance measures for first individual.

12. The process according to claim 11, further comprising collecting numerical test score data on the first individual prior to compiling and analyzing the data using algorithms on at least one computer to calculate performance measures for the first individual based upon the information collected and converted into data.

13. The process according to claim 11, further comprising collecting profile information about the first individual and creating a Jigsaw Profile.

14. The process according to claim 13, further comprising creation of a Jigsaw Ghost Profile.

15. The process according to claim 11, further comprising collecting profile information about the second individual and creating a Jigsaw Profile.

16. The process according to claim 11, wherein said performance measures for the second individual comprise a Perceived Performance, a Perceived Effort, and a Perceived Ability and wherein said Perceived Ability is mathematically calculated based upon said Perceived Performance and said Perceived Effort.

17. A process to evaluate the performance of a first individual based upon the performance of a second individual comprising:
collecting behavioral information relating directly to the second individual using motion sensory equipment and audio-sensory equipment connected to a computer and converting the behavioral information into data;
collecting performance data relating directly to the second individual using a computer;
compiling and analyzing the data using algorithms on at least one computer to calculate performance measures for the second individual based upon the data;
analyzing the data using algorithms on at least one computer to calculate performance measures for the second individual based upon the data and the performance measures for the first individual;
generating an output reporting the resulting performance measures for the first individual;
wherein said performance measures comprise a Perceived Performance, a Perceived Effort, and a Perceived Ability; and
wherein said Perceived Ability is a ratio of said Perceived Performance and said Perceived effort.

18. The process according to claim 17, further comprising collecting numerical test score data on the second individual prior to compiling and analyzing the data using algorithms on at least one computer to calculate performance measures for the second individual based upon the information collected and converted into data.

19. The process according to claim 17, wherein said Perceived Ability is calculated as.

20. The process according to claim 17, wherein the second individual is a student in a classroom.

21. The process according to claim 20, wherein the first individual is a teacher of the student.

22. The process according to claim 21, wherein the behavioral information includes at least one of a raising of the students hand, the answering of a question, and presence of the student in a seat.

23. The process according to claim 22, wherein said analysis of said data includes statistical analysis using algorithms to determine if an Education Event has occurred.

24. The process according to claim 23, wherein said Education Event is determined to have occurred if analysis of the data determines that the data exceeds predetermined thresholds.

25. The process according to claim 24, wherein said predetermined thresholds are calculated using the data and algorithms.

26. The process according to claim 25, wherein said generating an output reporting the resulting performance measures further comprises the reporting of the occurrence of an Educational Event.
